(19) United States
(12) Patent Application Publication
(10) Pub. No.: US 2025/0189826 A1
(43) Pub. Date: Jun. 12, 2025

(54) OPHTHALMIC DEVICES CONTAINING PHOTOSTABLE MIMICS OF MACULAR PIGMENT AND OTHER VISIBLE LIGHT FILTERS

(71) Applicant: Johnson & Johnson Vision Care, Inc., Jacksonville, FL (US)

(72) Inventors: Michael F. Widman, Jacksonville, FL (US); Ghulam Maharvi, Jacksonville, FL (US); Michael Anthony Brady, Jacksonville Beach, FL (US); Shivkumar Mahadevan, Jacksonville, FL (US); Dola Sinha, Jacksonville, FL (US); Derek Nankivil, Jacksonville, FL (US); Leilani K. Sonoda, Atlantic Beach, FL (US)

(21) Appl. No.: 18/952,864

(22) Filed: Nov. 19, 2024

Related U.S. Application Data
(60) Provisional application No. 63/608,952, filed on Dec. 12, 2023.

(51) Int. Cl. G02C 7/10; G02C 7/04

(52) U.S. Cl. CPC G02C 7/108; G02C 7/04; G02C 7/104; G02C 7/105; G02C 2202/06

(57) ABSTRACT

Described is an ophthalmic device that contains visible light filters. The invention provides an ophthalmic device that is a free radical reaction product of a reactive mixture comprising: one or more monomers suitable for making the ophthalmic device; a first visible light filtering compound, the first visible light filtering compound having a visible light absorption maximum between 430 and 480 nm and a full width half maximum at the visible light absorption maximum of at least 35 nm and up to 150 nanometers, wherein the first visible light filtering compound is photostable, and wherein the first visible light filtering compound has a molar extinction coefficient of at least 7740 L·mol⁻¹·cm⁻¹; and a second visible light filtering compound having a visible light absorption maximum between 480 and 530 nm and a full width half maximum of at least 50 nanometers and up to 150 nanometers. The reactive monomer mixture may also contain a third visible light filtering compound. The devices may provide one or more vision benefits, including enhanced macular pigment optical density as well as improved color perception and color enhancement and diminished visual artifacts.

### RELATED APPLICATIONS

This application claims priority to U.S. Provisional Patent Application Ser. No. 63/608,952, filed Dec. 12, 2023, which is incorporated herein by reference in its entirety.

### FIELD OF THE INVENTION

The invention relates to ophthalmic devices that contain visible light filters. More particularly, the invention relates to ophthalmic devices containing visible light filtering compounds that substantially mimic the absorbance properties of macular pigment, while remaining photostable. The ophthalmic devices also contain secondary visible light filters.

### BACKGROUND OF THE INVENTION

Human ocular tissues contain the dietary carotenoids lutein (L) and zeaxanthin (Z), collectively known as macular pigment (MP). Several reports describe the benefits of MP, for instance as a short-wavelength (blue light) filter and as a powerful antioxidant, have been made. MP is also believed to play a protective role against age related macular degeneration (AMD) (Bernstein, P. S., Li, B., Vachali, P. P., Gorusupudi, A., Shyam, R., Henriksen, B. S., Nolan, J. M. Prog. Retin. Eye Res. 2016, 50, 34-66; Beatty, S., Boulton, M., Koh, H—H., Murray, I, J. Br. J. Ophthalmol 1999, 83, 867-877). Macular pigment has further been found to correlate significantly with photostress recovery times, reduced disability glare contrast thresholds, and reduced visual discomfort (Stringham, J. M., Garcia., P. V., Smith, P. A., McLin, L, N., Foutch, B. K. IOVS, 2011, 52 (10) 7406-7415).

The chemical entities associated with macular pigment are carotenoid derivatives that possess extensive unsaturation and are highly reactive toward olefin isomerization and oxidation upon photoexcitation. The antioxidant protective mechanism that carotenoids provide is essentially sacrificial, where excitation of the pi system results in the reaction of its excited state with triplet oxygen, thereby protecting/limiting the excitation and reactions of other photosensitive compounds in the ocular environment. See e.g., Ribeiro, et al., Food and Chemical Toxicology, Vol. 120, pp. 681-699 (2018); Burton, et al., Can. J. Chem., Vol. 92, pp. 305-316 (2014); Ty, ct al., Journal of Oil Palm Research Vol. II No. 1, pp. 62-78 (June 1999); Johnston, et al., Plos One, Vol. 9 (10), pp. 1-10 (2014); and Boon, et al., Critical Reviews in Food Science and Nutrition, Vol. 50, pp. 515-532 (2010).

While the incorporation of macular pigment into products for the purpose of offering ocular protection is desirable, the overall lack of stability (thermal, oxidative, and photochemical) of carotenoids creates a very high barrier to the development of such products. Thus, it would be a significant advance if new stable materials that mimic the light absorbing properties of macular pigment were developed. Materials that provide additional vision benefits would also be highly desirable.

### SUMMARY OF THE INVENTION

The invention relates to ophthalmic devices that incorporate first light filtering compounds that absorb light in the 400 to 500 nm wavelength range and possess absorption spectra that substantially mimic the absorption properties of macular pigment. Such compounds are also photostable, for instance when measured for changes/loss of absorption characteristics upon exposure to conditions analogous to those described in ICH Q1B. In addition, compounds may exhibit a high extinction coefficient at desired wavelengths in the 400 to 500 nm range and may therefore be used in low concentrations to provide their light absorbing benefits. Further, the compounds are thermally stable. Ophthalmic devices incorporating the compounds as described herein may enhance the macular pigment optical density (MPOD) of wearers. In addition, the devices may mimic other visual benefits of macular pigment, such as improving photostress recovery time and disability glare contrast threshold and reducing visual discomfort.

In addition to compounds mimicking the light absorption properties of macular pigment, ophthalmic devices described herein also contain a second light filtering compound. The second light filtering compound may filter other wavelengths in the visible spectrum, thereby providing additional visual benefits to the lens wearer.

Thus, ophthalmic devices as described herein may provide one or more benefits to wearers including, but not limited to, improved MPOD, which may help protect against age related macular degeneration; improved photostress recovery time; improved disability glare contrast threshold; reduced visual discomfort; improved color enhancement; and/or improved color perception.

Accordingly, in one aspect, the invention provides an ophthalmic device that is a free radical reaction product of a reactive mixture comprising, consisting essentially of, or consisting of: one or more monomers suitable for making the ophthalmic device; a first visible light filtering compound, the first visible light filtering compound having a visible light absorption maximum between 430 nanometers and 480 nanometers and a full width half maximum (FWHM) at the visible light absorption maximum of at least 35 nanometers and up to 150 nanometers, wherein the compound is photostable, and wherein the compound has a molar extinction coefficient of at least 7740 L·mol-1·cm⁻¹; and a second visible light filtering compound having a visible light absorption maximum between 480 nanometers and 530 nanometers and a full width half maximum of at least 50 nanometers and up to 150 nanometers. The reactive monomer mixture can also contain a third visible light filtering compound.

In a further aspect, the invention provides an apodised ophthalmic device formed by a process comprising: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a first grafting composition containing a first visible light filtering compound and a second visible light filtering compound, wherein the contacting is conducted under conditions such that the first grafting composition penetrates into the crosslinked substrate network; and (d) activating the covalently bound activatable free radical initiator at one or more selective regions of the crosslinked substrate network such that the first grafting composition polymerizes with the crosslinked substrate network at the selective regions, thereby forming an apodization profile. The first grafting composition can contain a third visible light filtering compound.

The process can further comprise: following step (b), extracting the crosslinked substrate network with a solvent and optionally hydrating the extracted crosslinked substrate network with an aqueous solution, under conditions that preserve the covalently bound activatable free radical initiators of the crosslinked substrate network.

The process can further comprise: following step (d), contacting the crosslinked substrate network with a second grafting composition containing a different mixture of first, second, and optionally third visible light filtering compounds than the first grafting composition, and activating the retained covalently bound activatable free radical initiators such that the second grafting composition polymerizes with the crosslinked substrate network outside of the selective regions and optionally partially within the selective regions.

The process can further comprise: following step (d), extracting the crosslinked substrate network with a solvent, hydrating the extracted crosslinked substrate network with an aqueous solution, and autoclaving the ophthalmic device.

In a still further aspect, the process steps (a) and (b) are performed in a mold assembly comprised of a front mold and a back mold, the front mold and a back mold defining and enclosing a cavity in the shape of the ophthalmic device therebetween, and process steps (c) and (d), including optional step of grafting a second grafting composition, are performed in the mold assembly after the back mold has been removed. The activation in steps (b) and (d) can be photochemical in nature, for instance using a source of actinic irradiation, e.g., UV/visible light irradiation, and the source of actinic irradiation in steps (b) and (d) can include light emitting diodes and a plurality of selectively controllable beams of actinic irradiation controlled by a digital micro-mirror device according to a predetermined script. The predetermined script can create an apodization profile by polymerizing the visible light filtering compounds in the selective regions in varying amounts. In this way, an apodised ophthalmic device can be formed in which the optical design is coupled with the apodization profile to provide the aforementioned vision benefits.

### BRIEF DESCRIPTION OF FIGURES

FIG. 1 shows the UV-VIS absorbance spectra of 0.1 mM methanolic solutions of Compound A and Compound B of the invention, superimposed on the literature spectrum of macular pigment.

FIG. 2 shows the UV-VIS absorption spectra of 0.2 mM methanolic solutions of Compounds C and D.

FIG. 3 show the UV-VIS absorption spectrum of 0.2 mM methanolic solution of Compound E.

FIG. 4 show the UV-VIS absorption spectrum of 0.2 mM methanolic solution of Compound F.

FIG. 5 shows the UV-VIS absorption spectrum of 0.2 mM methanolic solution of 1-cyano-2-oxo-1-(9H-thioxanthen-9-ylidene)-6,9,12-trioxa-3-azatetradecan-14-yl methacrylate.

FIG. 6 shows the UV-VIS absorption spectrum of 0.2 mM methanolic solution of Compound I.

FIG. 7 shows the UV-VIS absorption spectrum of 0.2 mM methanolic solution of Compound J.

FIG. 8 shows the UV-VIS absorption spectra of 0.2 mM methanolic solutions of Compound K and IMT Blue.

FIG. 9 shows the UV-VIS transmission spectra of contact lenses prepared from Compounds A or B.

FIG. 10 shows the UV-VIS transmission spectra of contact lenses prepared from Compound B before and after either thermal or photo-stress treatments.

FIG. 11 shows the UV-VIS absorbance spectra of contact lenses prepared from Compound B before and after either thermal or photo-stress treatments.

FIG. 12 shows the in-mold jig for digital micro-mirror device light projection.

FIG. 13 shows the digital micro-mirror device images as transmittance versus lens radius plots, used to make apodization profiles within the contact lens.

FIG. 14 shows the digital micro-mirror device images superimposed on micrographs of the resulting apodised lenses.

FIG. 15 shows the UV-VIS transmission spectrum of Example 16A lenses and a micrograph of Example 16B lenses.

FIG. 16 shows that UV-VIS transmission spectra of Example 16C-E lenses.

FIG. 17 shows the UV-VIS transmission spectrum of sterile Example 17A lenses.

FIG. 18 shows the UV-VIS transmission spectrum of Example 17C lenses.

FIG. 19 shows micrographs of Example 17C-F lenses.

FIG. 20 shows the UV-VIS transmission spectrum of Example 18 lenses.

FIG. 21 shows the UV-VIS transmission spectrum of Example 21A

FIG. 22 shows the UV-VIS transmission spectrum of Example 21C.

FIG. 23 shows the UV-VIS transmission spectrum of Example 21E.

FIG. 24 shows the micrographs of Examples 21A-21D lenses.

### DETAILED DESCRIPTION OF THE INVENTION

It is to be understood that the invention is not limited to the details of construction or process steps set forth in the following description. The invention is capable of other embodiments and of being practiced or being carried out in various ways using the teaching herein.

With respect to the terms used in this disclosure, the following definitions are provided.

Unless defined otherwise, all technical and scientific terms used herein have the same meaning as commonly understood by one of ordinary skill in the art to which the invention belongs. The polymer definitions are consistent with those disclosed in the Compendium of Polymer Terminology and Nomenclature, IUPAC Recommendations 2008, edited by: Richard G. Jones, Jaroslav Kahovec, Robert Stepto, Edward S. Wilks, Michael Hess, Tatsuki Kitayama, and W. Val Metanomski. All publications, patent applications, patents, and other references mentioned herein are incorporated by reference.

As used herein, the term “(meth)” designates optional methyl substitution. Thus, a term such as “(meth)acrylates” denotes both methacrylates and acrylates.

Wherever chemical structures are given, it should be appreciated that alternatives disclosed for the substituents on the structure may be combined in any combination. Thus, if a structure contained substituents R* and R**, each of which contained three lists of potential groups, 9 combinations are disclosed. The same applies for combinations of properties.

When a subscript, such as “n” in the generic formula [***]ₙ, is used to depict the number of repeating units in a polymer's chemical formula, the formula should be interpreted to represent the number average molecular weight of the macromolecule.

The term “individual” includes humans and vertebrates.

The term “biomedical device” refers to any article that is designed to be used while either in or on mammalian tissues or fluids, and preferably in or on human tissue or fluids. Examples of these devices include but are not limited to wound dressings, sealants, tissue fillers, drug delivery systems, coatings, adhesion prevention barriers, catheters, implants, stents, and ophthalmic devices such as intraocular lenses and contact lenses. The biomedical devices may be ophthalmic devices, particularly contact lenses, most particularly contact lenses made from silicone hydrogels or conventional hydrogels.

The term “ocular surface” includes the surface and glandular epithelia of the cornea, conjunctiva, lacrimal gland, accessory lacrimal glands, nasolacrimal duct and meibomian gland, and their apical and basal matrices, puncta and adjacent or related structures, including eyelids linked as a functional system by both continuity of epithelia, by innervation, and the endocrine and immune systems.

The term “ophthalmic device” refers to any optical device relating to the eye and includes devices which resides in or on the eye or any part of the eye, including the ocular surface. These devices can provide optical correction, cosmetic enhancement, vision enhancement, therapeutic benefit (for example as bandages) or delivery of active components such as pharmaceutical and nutraceutical components, or a combination of any of the foregoing. Examples of ophthalmic devices include but are not limited to lenses, optical and ocular inserts, including but not limited to punctal plugs, and the like. “Lenses” include spectacle lenses, sunglass lenses, soft contact lenses, hard contact lenses, hybrid contact lenses, intraocular lenses, phakic intraocular lens, and overlay lenses. The ophthalmic device may comprise a contact lens.

The term “contact lens” refers to an ophthalmic device that can be placed on the cornea of an individual's eye. The contact lens may provide corrective, cosmetic, or therapeutic benefit, including wound healing, the delivery of drugs or nutraceuticals, diagnostic evaluation or monitoring, ultraviolet light absorbing, visible light or glare reduction, or any combination thereof. A contact lens can be of any appropriate material known in the art and can be a soft lens, a hard lens, or a hybrid lens containing at least two distinct portions with different physical, mechanical, or optical properties, such as modulus, water content, light transmission, or combinations thereof.

Spectacle lenses or sunglasses may be comprised of mineral material, for example based on silicate, or made from an organic material, such as polycarbonate; polyamide; polyimide; polysulfones; polyethylene terephthalate/polycarbonate copolymers; and various other materials known in the art.

As used herein, the term “central zone” refers to the central part of a contact lens and may encompass the pupil region of the lens. The central zone may, for instance, have a diameter ranging from about 3 millimeters to about 12 millimeters, preferably from about 4 millimeters to about 11 millimeters, more preferably from about 5 millimeters to about 10 millimeters. By “peripheral zone” is meant the area of a contact lens circumferentially surrounding the central zone of the lens. The peripheral zone may extend up to the edge of the lens. The central zone may include an “optical zone” which refers to area designed (by refractive means, diffractive means, or combinations thereof) to correct the refractive errors of the contact lens wearer such as myopia, hyperopia, presbyopia, astigmatism, and the like.

The biomedical devices, ophthalmic devices, and lenses of the present invention may be comprised of silicone hydrogels or conventional hydrogels. Silicone hydrogels typically contain at least one hydrophilic monomer and at least one silicone-containing component that are covalently bound to one another in the cured device.

“Target macromolecule” means the macromolecule being synthesized from the reactive monomer mixture comprising monomers, macromers, prepolymers, cross-linkers, initiators, additives, diluents, and the like.

The term “polymerizable compound” means a compound containing one or more polymerizable groups (P_{g}). The term encompasses, for instance, monomers, macromers, oligomers, prepolymers, cross-linkers, and the like.

“Polymerizable groups” are groups that can undergo chain growth polymerization, such as free radical, anionic, or cationic polymerization, preferably free radical polymerization, for example, a carbon-carbon double bond which can polymerize when subjected to free radical polymerization initiation conditions. Non-limiting examples of polymerizable groups include (meth)acrylates, styryls, (meth)acrylamides, and vinyl groups. Preferably, the polymerizable group is selected from (meth)acrylate, (meth)acrylamide, N-vinyl lactam, N-vinylamide, vinyl carbonate, vinyl ether, vinyl carbamate, and styryl functional groups. More preferably, the polymerizable group is selected from (meth)acrylates and (meth)acrylamides. The polymerizable group may be unsubstituted or substituted. For instance, the nitrogen atom in (meth)acrylamide may be bonded to a hydrogen, or the hydrogen may be replaced with alkyl or cycloalkyl (which themselves may be further substituted).

Any type of free radical polymerization may be used including but not limited to bulk, solution, suspension, and emulsion as well as any of the controlled radical polymerization methods such as stable free radical polymerization, nitroxide-mediated living polymerization, atom transfer radical polymerization, reversible addition fragmentation chain transfer polymerization, organotellurium mediated living radical polymerization, and the like.

A “monomer” is a mono-functional molecule which can undergo chain growth polymerization, and in particular, free radical polymerization, thereby creating a repeating unit in the chemical structure of the target macromolecule. Some monomers have di-functional impurities that can act as cross-linking agents. A “hydrophilic monomer” is also a monomer which yields a clear single-phase solution when mixed with deionized water at 25° C. at a concentration of 5 weight percent. A “hydrophilic component” is a monomer, macromer, prepolymer, initiator, cross-linker, additive, or polymer which yields a clear single-phase solution when mixed with deionized water at 25° C. at a concentration of 5 weight percent. A “hydrophobic component” is a monomer, macromer, prepolymer, initiator, cross-linker, additive, or polymer which is slightly soluble or insoluble in deionized water at 25° C.

A “macromolecule” is an organic compound having a number average molecular weight of greater than 1500 grams/mole and may be reactive or non-reactive.

A “macromonomer” or “macromer” is a macromolecule that has one group that can undergo chain growth polymerization, and in particular, free radical polymerization, thereby creating a repeating unit in the chemical structure of the target macromolecule. Typically, the chemical structure of the macromer is different than the chemical structure of the target macromolecule, that is, the repeating unit of the macromer's pendent group is different than the repeating unit of the target macromolecule or its mainchain. The difference between a monomer and a macromer is merely one of chemical structure, molecular weight, and molecular weight distribution of the pendent group. As a result, and as used herein, the patent literature occasionally defines monomers as polymerizable compounds having relatively low molecular weights of about 1,500 daltons or less, which inherently includes some macromers. In particular, monomethacryloxypropyl terminated mono-n-butyl terminated polydimethylsiloxane (molecular weight=500-1500 g/mol) (mPDMS) and mono-(2-hydroxy-3-methacryloxypropyl)-propyl ether terminated mono-n-butyl terminated polydimethylsiloxane (molecular weight=500-1500 g/mol) (OH-mPDMS) may be referred to as monomers or macromers. Furthermore, the patent literature occasionally defines macromers as having one or more polymerizable groups, essentially broadening the common definition of macromer to include prepolymers. As a result, and as used herein, di-functional and multi-functional macromers, prepolymers, and crosslinkers may be used interchangeably.

A “silicone-containing component” is a monomer, macromer, prepolymer, cross-linker, initiator, additive, or polymer in the reactive mixture with at least one silicon-oxygen bond, typically in the form of siloxy groups, siloxane groups, carbosiloxane groups, and mixtures thereof.

Examples of silicone-containing components which are useful in this invention may be found in U.S. Pat. Nos. 3,808,178, 4,120,570, 4,136,250, 4,153,641, 4,740,533, 5,034,461, 5,070,215, 5,244,981, 5,314,960, 5,331,067, 5,371,147, 5,760,100, 5,849,811, 5,962,548, 5,965,631, 5,998,498, 6,367,929, 6,822,016, 6,943,203, 6,951,894, 7,052,131, 7,247,692, 7,396,890, 7,461,937, 7,468,398, 7,538,146, 7,553,880, 7,572,841, 7,666,921, 7,691,916, 7,786,185, 7,825,170, 7,915,323, 7,994,356, 8,022,158, 8,163,206, 8,273,802, 8,399,538, 8,415,404, 8,420,711, 8,450,387, 8,487,058, 8,568,626, 8,937,110, 8,937,111, 8,940,812, 8,980,972, 9,056,878, 9,125,808, 9,140,825, 9,156,934, 9,170,349, 9,217,813, 9,244,196, 9,244,197, 9,260,544, 9,297,928, 9,297,929, and European Patent No. 080539. These patents are hereby incorporated by reference in their entireties.

A “polymer” is a target macromolecule composed of the repeating units of the monomers used during polymerization.

A “homopolymer” is a polymer made from one monomer; a “copolymer” is a polymer made from two or more monomers; a “terpolymer” is a polymer made from three monomers. A “block copolymer” is composed of compositionally different blocks or segments. Diblock copolymers have two blocks. Triblock copolymers have three blocks. “Comb or graft copolymers” are made from at least one macromer.

A “repeating unit” is the smallest group of atoms in a polymer that corresponds to the polymerization of a specific monomer or macromer.

An “initiator” is a molecule that can decompose into radicals which can subsequently react with a monomer to initiate a free radical polymerization reaction. A thermal initiator decomposes at a certain rate depending on the temperature; typical examples are azo compounds such as 1,1′-azobisisobutyronitrile and 4,4′-azobis(4-cyanovaleric acid), peroxides such as benzoyl peroxide, tert-butyl peroxide, tert-butyl hydroperoxide, tert-butyl peroxybenzoate, dicumyl peroxide, and lauroyl peroxide, peracids such as peracetic acid and potassium persulfate as well as various redox systems. A photo-initiator decomposes by a photochemical process; typical examples are derivatives of benzil, benzoin, acetophenone, benzophenone, camphorquinone, and mixtures thereof as well as various monoacyl and bisacyl phosphine oxides and combinations thereof.

A “cross-linking agent” is a di-functional or multi-functional monomer or macromer which can undergo free radical polymerization at two or more locations on the molecule, thereby creating branch points and a polymeric network. Common examples are ethylene glycol dimethacrylate, tetraethylene glycol dimethacrylate, trimethylolpropane trimethacrylate, methylene bisacrylamide, triallyl cyanurate, and the like.

A “prepolymer” is a reaction product of monomers which contains remaining polymerizable groups capable of undergoing further reaction to form a polymer.

A “polymeric network” is a cross-linked macromolecule that may swell but cannot dissolve in solvents. “Hydrogels” are polymeric networks that swell in water or aqueous solutions, typically absorbing at least 10 weight percent water. “Silicone hydrogels” are hydrogels that are made from at least one silicone-containing component with at least one hydrophilic component. Hydrophilic components may also include non-reactive polymers.

“Conventional hydrogels” refer to polymeric networks made from components without any siloxy, siloxane or carbosiloxane groups. Conventional hydrogels are prepared from reactive mixtures comprising hydrophilic monomers. Examples include 2-hydroxyethyl methacrylate (“HEMA”), N-vinyl pyrrolidone (“NVP”), N, N-dimethylacrylamide (“DMA”) or vinyl acetate. U.S. Pat. Nos. 4,436,887, 4,495,313, 4,889,664, 5,006,622, 5,039459, 5,236,969, 5,270,418, 5,298,533, 5,824,719, 6,420,453, 6,423,761, 6,767,979, 7,934,830, 8,138,290, and 8,389,597 disclose the formation of conventional hydrogels. Commercially available conventional hydrogels include, but are not limited to, etafilcon, genfilcon, hilafilcon, lenefilcon, nesofilcon, omafilcon, polymacon, and vifilcon, including all of their variants.

“Silicone hydrogels” refer to polymeric networks made from at least one hydrophilic component and at least one silicone-containing component. Examples of suitable families of hydrophilic components that may be present in the reactive mixture include (meth)acrylates, styrenes, vinyl ethers, (meth)acrylamides, N-vinyl lactams, N-vinyl amides, N-vinyl imides, N-vinyl ureas, O-vinyl carbamates, O-vinyl carbonates, other hydrophilic vinyl compounds, and mixtures thereof. Silicone-containing components are well known and have been extensively described in the patent literature. For instance, the silicone-containing component may comprise at least one polymerizable group (e.g., a (meth)acrylate, a styryl, a vinyl ether, a (meth)acrylamide, an N-vinyl lactam, an N-vinylamide, an O-vinylcarbamate, an O-vinylcarbonate, a vinyl group, or mixtures of the foregoing), at least one siloxane group, and one or more linking groups (which may be a bond) connecting the polymerizable group(s) to the siloxane group(s). The silicone-containing components may, for instance, contain from 1 to 220 siloxane repeat units. The silicone-containing component may also contain at least one fluorine atom. Silicone hydrogel lenses may contain a coating, and the coating may be the same or different material from the substrate.

Examples of silicone hydrogels include acquafilcon, asmofilcon, balafilcon, comfilcon, delefilcon, lehfilcon, serafilcon, enfilcon, fanfilcon, formofilcon, galyfilcon, lotrafilcon, narafilcon, riofilcon, samfilcon, senofilcon, somofilcon, and stenfilcon, including all of their variants, as well as silicone hydrogels as prepared in U.S. Pat. Nos. 4,659,782, 4,659,783, 5,244,981, 5,314,960, 5,331,067, 5,371,147, 5,998,498, 6,087,415, 5,760,100, 5,776,999, 5,789,461, 5,849,811, 5,965,631, 6,367,929, 6,822,016, 6,867,245, 6,943,203, 7,247,692, 7,249,848, 7,553,880, 7,666,921, 7,786,185, 7,956,131, 8,022,158, 8,273,802, 8,399,538, 8,470,906, 8,450,387, 8,487,058, 8,507,577, 8,637,621, 8,703,891, 8,937,110, 8,937,111, 8,940,812, 9,056,878, 9,057,821, 9,125,808, 9,140,825, 9,156,934, 9,170,349, 9,244,196, 9,244,197, 9,260,544, 9,297,928, 9,297,929 as well as WO 03/22321, WO 2008/061992, and US 2010/0048847. These patents are hereby incorporated by reference in their entireties.

An “interpenetrating polymeric network” comprises two or more networks which are at least partially interlaced on the molecular scale but not covalently bonded to each other and which cannot be separated without braking chemical bonds. A “semi-interpenetrating polymeric network” comprises one or more networks and one or more polymers characterized by some mixing on the molecular level between at least one network and at least one polymer. A mixture of different polymers is a “polymer blend.” A semi-interpenetrating network is technically a polymer blend, but in some cases, the polymers are so entangled that they cannot be readily removed.

“Reactive components” are the polymerizable compounds (such as monomers, macromers, oligomers, prepolymers, and cross-linkers) in the reactive mixture (defined below), as well as any other components in the reactive mixture which are intended to substantially remain in the resultant polymeric network after polymerization and all work-up steps (such as extraction steps) and packaging steps have been completed. Reactive components may be retained in the polymeric network by covalent bonding, hydrogen bonding, electrostatic interactions, the formation of interpenetrating polymeric networks, or any other means. Components that are intended to release from the polymeric network once it is in use are still considered “reactive components.” For example, pharmaceutical or nutraceutical components in a contact lens which are intended to be released during wear are considered “reactive components.” Components that are intended to be removed from the polymeric network during the manufacturing process (e.g., by extraction), such as diluents, are not “reactive components.”

The terms “reactive mixture” and “reactive monomer mixture” refer to the mixture of components which are mixed together and, when subjected to polymerization conditions, result in formation of a polymeric network (such as conventional or silicone hydrogels) as well as biomedical devices, ophthalmic devices, and contact lenses made therefrom. The reactive mixture may comprise reactive components such as monomers, macromers, prepolymers, cross-linkers, and initiators, additives such as wetting agents, polymers, dyes, light absorbing compounds such as UV absorbers, pigments, photochromic compounds, pharmaceutical compounds, and/or nutraceutical compounds, any of which may be polymerizable or non-polymerizable but are capable of being retained within the resulting biomedical device (e.g., contact lens). The reactive mixture may also contain other components which are intended to be removed from the device prior to its use, such as diluents. It will be appreciated that a wide range of additives may be added based upon the contact lens which is made and its intended use. Concentrations of components of the reactive mixture are expressed as weight percentages of all reactive components in the reactive mixture, therefore excluding diluents. When diluents are used, their concentrations are expressed as weight percentages based upon the amount of all components in the reactive mixture (including the diluent).

The term “residue” as used in connection with a compound or monomer means the moiety from such compound or monomer that has been incorporated into at least a portion of a polymeric network following polymerization of the reactive monomer mixture.

The term “silicone hydrogel contact lens” refers to a hydrogel contact lens that is made from at least one silicone-containing compound. Silicone hydrogel contact lenses generally have increased oxygen permeability compared to conventional hydrogels. Silicone hydrogel contact lenses use both their water and polymer content to transmit oxygen to the eye.

The term “multi-functional” refers to a component having two or more polymerizable groups. The term “mono-functional” refers to a component having one polymerizable group.

The terms “halogen” or “halo” indicate fluorine, chlorine, bromine, and iodine.

“Alkyl” refers to an optionally substituted linear or branched alkyl group containing the indicated number of carbon atoms. If no number is indicated, then alkyl (including any optional substituents on alkyl) may contain 1 to 16 carbon atoms. Preferably, the alkyl group contains 1 to 10 carbon atoms, alternatively 1 to 8 carbon atoms, alternatively 1 to 6 carbon atoms, or alternatively 1 to 4 carbon atoms. Examples of alkyl include methyl, ethyl, propyl, isopropyl, butyl, iso-, sec- and tert-butyl, pentyl, hexyl, heptyl, 3-ethylbutyl, and the like. Examples of substituents on alkyl include 1, 2, or 3 groups independently selected from hydroxy, amino, amido, oxa, carboxy, alkyl carboxy, carbonyl, alkoxy, thioalkyl, carbamate, carbonate, halogen, phenyl, benzyl, and combinations thereof. “Alkylene” means a divalent alkyl group, such as —CH₂—, —CH₂CH₂—, —CH₂CH₂CH₂—, —CH₂CH(CH₃) CH₂—, and —CH₂CH₂CH₂CH₂—.

“Haloalkyl” refers to an alkyl group as defined above substituted with one or more halogen atoms, where each halogen is independently F, Cl, Br or I. A preferred halogen is F. Preferred haloalkyl groups contain 1-6 carbons, more preferably 1-4 carbons, and still more preferably 1-2 carbons. “Haloalkyl” includes perhaloalkyl groups, such as —CF₃— or —CF₂CF₃—. “Haloalkylene” means a divalent haloalkyl group, such as —CH₂CF₂—.

“Cycloalkyl” refers to an optionally substituted cyclic hydrocarbon containing the indicated number of ring carbon atoms. If no number is indicated, then cycloalkyl may contain 3 to 12 ring carbon atoms. Preferred are C₃-C₈ cycloalkyl groups, C₃-C₇ cycloalkyl, more preferably C₄-C₇ cycloalkyl, and still more preferably C₅-C₆ cycloalkyl. Examples of cycloalkyl include cyclopropyl, cyclobutyl, cyclopentyl, cyclohexyl, cycloheptyl and cyclooctyl. Examples of substituents on cycloalkyl include 1, 2, or 3 groups independently selected from alkyl, hydroxy, amino, amido, oxa, carbonyl, alkoxy, thioalkyl, amido, carbamate, carbonate, halo, phenyl, benzyl, and combinations thereof. “Cycloalkylene” means a divalent cycloalkyl group, such as 1,2-cyclohexylene, 1,3-cyclohexylene, or 1,4-cyclohexylene.

“Heterocycloalkyl” refers to a cycloalkyl ring or ring system as defined above in which at least one ring carbon has been replaced with a heteroatom selected from nitrogen, oxygen, and sulfur. The heterocycloalkyl ring is optionally fused to or otherwise attached to other heterocycloalkyl rings and/or non-aromatic hydrocarbon rings and/or phenyl rings. Preferred heterocycloalkyl groups have from 5 to 7 members. More preferred heterocycloalkyl groups have 5 or 6 members. Heterocycloalkylene means a divalent heterocycloalkyl group.

“Aryl” refers to an optionally substituted aromatic hydrocarbon ring system containing at least one aromatic ring. The aryl group contains the indicated number of ring carbon atoms. If no number is indicated, then aryl may contain 6 to 14 ring carbon atoms. The aromatic ring may optionally be fused or otherwise attached to other aromatic hydrocarbon rings or non-aromatic hydrocarbon rings. Examples of aryl groups include phenyl, naphthyl, and biphenyl. Preferred examples of aryl groups include phenyl. Examples of substituents on aryl include 1, 2, or 3 groups independently selected from alkyl, hydroxy, amino, amido, oxa, carboxy, alkyl carboxy, carbonyl, alkoxy, thioalkyl, carbamate, carbonate, halo, phenyl, benzyl, and combinations thereof. “Arylene” means a divalent aryl group, for example 1,2-phenylene, 1,3-phenylene, or 1,4-phenylene.

“Heteroaryl” refers to an aryl ring or ring system, as defined above, in which at least one ring carbon atom has been replaced with a heteroatom selected from nitrogen, oxygen, and sulfur. The heteroaryl ring may be fused or otherwise attached to one or more heteroaryl rings, aromatic or nonaromatic hydrocarbon rings or heterocycloalkyl rings. Examples of heteroaryl groups include pyridyl, furyl, and thienyl. “Heteroarylene” means a divalent heteroaryl group.

“Alkoxy” refers to an alkyl group attached to the parent molecular moiety through an oxygen bridge. Examples of alkoxy groups include, for instance, methoxy, ethoxy, propoxy and isopropoxy. “Thioalkyl” means an alkyl group attached to the parent molecule through a sulfur bridge. Examples of thioalkyl groups include, for instance, methylthio, ethylthio, n-propylthio and iso-propylthio. “Aryloxy” refers to an aryl group attached to a parent molecular moiety through an oxygen bridge. Examples include phenoxy. “Cyclic alkoxy” means a cycloalkyl group attached to the parent moiety through an oxygen bridge.

“Alkylamine” refers to an alkyl group attached to the parent molecular moiety through an —NH bridge. Alkyleneamine means a divalent alkylamine group, such as —CH₂CH₂NH—.

“Siloxanyl” refers to a structure having at least one Si—O—Si bond. Thus, for example, siloxanyl group means a group having at least one Si—O—Si group (i.e. a siloxane group), and siloxanyl compound means a compound having at least one Si—O—Si group. “Siloxanyl” encompasses monomeric (e.g., Si—O—Si) as well as oligomeric/polymeric structures (e.g., —[Si—O]ₙ—, where n is 2 or more). Each silicon atom in the siloxanyl group is substituted with independently selected RA groups (where RA is as defined in Formula A options (b)-(i)) to complete their valence.

“Silyl” refers to a structure of formula R₃Si− and “siloxy” refers to a structure of formula R₃Si—O—, where each R in silyl or siloxy is independently selected from trimethylsiloxy, C₁-C₈alkyl (preferably C₁-C₃ alkyl, more preferably ethyl or methyl), and C₃-C₈ cycloalkyl.

“Alkylencoxy” refers to groups of the general formula-(alkylene-O)ₚ- or —(O-alkylene)ₚ-, wherein alkylene is as defined above, and p is from 1 to 200, or from 1 to 100, or from 1 to 50, or from 1 to 25, or from 1 to 20, or from 1 to 10, wherein each alkylene is independently optionally substituted with one or more groups independently selected from hydroxyl, halo (e.g., fluoro), amino, amido, ether, carbonyl, carboxyl, and combinations thereof. If p is greater than 1, then each alkylene may be the same or different and the alkyleneoxy may be in block or random configuration. When alkyleneoxy forms a terminal group in a molecule, the terminal end of the alkyleneoxy may, for instance, be a hydroxy or alkoxy (e.g., HO—[CH₂CH₂O]ₚ— or CH₃O—[CH₂CH₂O]ₚ—). Examples of alkyleneoxy include polyethyleneoxy, polypropyleneoxy, polybutyleneoxy, and poly(ethyleneoxy-co-propylencoxy).

“Oxaalkylene” refers to an alkylene group as defined above where one or more non-adjacent CH₂ groups have been substituted with an oxygen atom, such as —CH₂CH₂OCH(CH₃) CH₂—. “Thiaalkylene” refers to an alkylene group as defined above where one or more non-adjacent CH₂ groups have been substituted with a sulfur atom, such as —CH₂CH₂SCH(CH₃) CH₂—.

The term “linking group” refers to a moiety that links a polymerizable group to the parent molecule. The linking group may be any moiety that is compatible with the compound of which it is a part, and that does not undesirably interfere with the polymerization of the compound, is stable under the polymerization conditions as well as the conditions for the processing and storage of the final product. For instance, the linking group may be a bond, or it may comprise one or more alkylene, haloalkylene, amide, amine, alkyleneamine, carbamate, ester (—CO₂—), arylene, heteroarylene, cycloalkylene, heterocycloalkylene, alkyleneoxy, oxaalkylene, thiaalkylene, haloalkyleneoxy (alkyleneoxy substituted with one or more halo groups, e.g., —OCF₂—, —OCF₂CF₂—, —OCF₂CH₂—), siloxanyl, alkylenesiloxanyl, or combinations thereof. The linking group may optionally be substituted with 1 or more substituent groups. Suitable substituent groups may include those independently selected from alkyl, halo (e.g., fluoro), hydroxyl, HO-alkylencoxy, McO-alkyleneoxy, siloxanyl, siloxy, siloxy-alkyleneoxy-, siloxy-alkylene-alkylencoxy-(where more than one alkyleneoxy groups may be present and wherein each methylene in alkylene and alkyleneoxy is independently optionally substituted with hydroxyl), ether, amine, carbonyl, carbamate, and combinations thereof. The linking group may also be substituted with a polymerizable group, such as (meth)acrylate (in addition to the polymerizable group to which the linking group is linked).

Preferred linking groups include C₁-C₈ alkylene (preferably C₂-C₆ alkylene), C₁-C₈ oxaalkylene (preferably C₂-C₆ oxaalkylene), ethyleneoxy (preferably (CH₂CH₂O)ₚ wherein p=1-6), C₁-C₈ thiaalkylene, C₁-C₈ alkylene-carboxylate-C₁-C₈alkylene, C₁-C₈ alkylene-amide-C₁-C₈ alkylene, and C₁-C₈ alkylene-amine-C₁-C₈alkylene, each of which is optionally substituted with 1 or 2 groups independently selected from hydroxyl and siloxy.

When the linking group is comprised of combinations of moieties as described above (e.g., alkylene and cycloalkylene), the moieties may be present in any order. For instance, if in Formula A below, L is indicated as being-alkylene-cycloalkylene-, then P_{g}-L may be either P_{g}-alkylene-cycloalkylene-, or P_{g}-cycloalkylene-alkylene-. Notwithstanding this, the listing order represents the preferred order in which the moieties appear in the compound starting from the terminal polymerizable group (P_{g}) to which the linking group is attached. For example, if in Formula A, L is indicated as being alkylene-cycloalkylene, then P_{g}-L is preferably P_{g}-alkylene-cycloalkylene-.

The term “electron withdrawing group” (EWG) refers to a chemical group which withdraws electron density from the atom or group of atoms to which the electron withdrawing group is attached. Examples of EWGs include, but are not limited to, cyano, amide, ester, keto, or aldehyde. A preferred EWG is cyano (CN).

The term “visible light absorbing compound” refers to a chemical material that absorbs light within the visible spectrum (e.g., in the 380 to 760 nm range). A “high energy radiation absorber,” “UV/HEV absorber,” or “high energy light absorbing compound” is a chemical material that absorbs various wavelengths of ultraviolet light, high energy visible light, or both. A material's ability to absorb certain wavelengths of light can be determined by measuring its UV/Vis transmission or absorbance spectrum.

As used herein, if the amount of a device or material's light transmittance is indicated as a percentage across a particular wavelength range, it is to be understood that the device or material exhibits the percent transmittance at all wavelengths across that range.

When the compounds described herein contain olefinic double bonds or other centers of geometric asymmetry, and unless otherwise specified, it is intended that the compounds include the cis, trans, Z- and E-configurations. Likewise, all tautomeric and salt forms are also intended to be included.

The term “optional substituent” means that a hydrogen atom in the underlying moiety is optionally replaced by a substituent. Any substituent may be used that is sterically practical at the substitution site and is synthetically feasible. Identification of a suitable optional substituent is well within the capabilities of an ordinarily skilled artisan. Examples of an “optional substituent” include, without limitation, C₁-C₆ alkyl, C₁-C₆ alkoxy, C₁-C₆ thioalkyl, C₃-C₇ cycloalkyl, aryl, halo, hydroxy, amino, NR⁴R⁵, benzyl, SO₃H, SO₃Na, or —Y—P_{g}, wherein R⁴ and R₅ are independently H or C₁-C₆ alkyl, Y is a linking group; and P_{g} is a polymerizable group. The foregoing substituents may be optionally substituted by an optional substituent (which, unless otherwise indicated, is preferably not further substituted). For instance, alkyl may be substituted by halo (resulting, for instance, in CF₃).

“Visible light absorption maxima” refers to the one or more wavelengths within the visible light range (380 to 760 nanometers) at which there is a light absorbance peak. A material may exhibit multiple absorbance peaks within the visible light range, in which case the material has multiple visible light absorption maxima. For materials that exhibit multiple visible light absorption maxima, the peak showing the maximum absorbance among the multiple absorption maxima within the visible light range is referred to as the “visible light absorption maximum.” The definitions encompass materials that exhibit an overall absorption maximum outside of the visible light range, such as within the UV region.

The terms “photostable,” “photostability,” or similar expressions mean that the compound (which may, when measured, be optionally embedded in an ophthalmic device, such as a hydrogel contact lens, and optionally measured either within or outside of a blister pack or a vial) exhibits a loss of absorbance at the visible light absorption maximum of no more than 20 percent after exposure to light under conditions such as those of the International Conference on Harmonisation (ICH) of Technical Requirements for Registration of Pharmaceuticals for Human Use guideline, Q1B Photostability Testing of New Drug Substances and Products, published on November 1996. Preferably, the exposure is conducted under the ICH Photostability Guideline using an Option 2 light source with an estimated illuminance exposure of 1.5192×10⁶ Lux hours (168.8 hours exposure time) and an estimated ultraviolet irradiation exposure of 259.4 Watt hours/m² (16.2 hours exposure time), preferably in a photostability chamber that is controlled at 25° C./Amb RH. After exposure, the UV/Vis spectrum of the sample is collected and compared to a sample's spectrum prior to exposure. Changes are calculated relative to the visible light absorption maximum of the lens as observed prior to exposure. By way of example, if the absorbance at the visible light absorption maximum before exposure is 4 absorbance units, and is 2 absorbance units after exposure, then the loss of absorbance is 50 percent. In the invention, the loss of absorbance after photo exposure is preferably no more than 15 percent, or no more than 10 percent, or no more than 7 percent, or no more than 5 percent, or no more than 4 percent, or no more than 3 percent, or no more than 2 percent, or no more than 1 percent, or no more than 0.5 percent, or no more than 0.1 percent.

The term “more photostable than macular pigment” or similar expression means that the compound (which may, when tested, be optionally embedded in an ophthalmic device, such as a hydrogel contact lens, and optionally measured either within or outside of a blister pack) exhibits less loss of absorbance at the visible light absorption maximum than observed with macular pigment, following exposure to light, for instance under the ICH Photostability Guideline as described above.

The term full width half maximum (FWHM) means the width of the absorbance peak at half its maximum intensity in nanometers.

The terms “thermally stable,” “thermal stability,” or similar expressions mean that the compound (which may, when measured, be optionally embedded in an ophthalmic device, such as a hydrogel contact lens, and optionally measured either within or outside of a blister pack or a vial) exhibits a loss of absorbance at the visible light absorption maximum of no more than 20 percent after exposure in a stability chamber at 89° C. for one month as described in the examples below. After exposure, the UV/Vis spectrum of the sample is collected and compared to a sample's spectrum prior to exposure. Changes are calculated relative to the visible light absorption maximum of the lens as observed prior to exposure. By way of example, if the absorbance at the visible light absorption maximum before exposure is 4 absorbance units, and is 2 absorbance units after exposure, then the loss of absorbance is 50 percent. In the invention, the loss of absorbance after thermal exposure is preferably no more than 20 percent, or no more than 15 percent, or no more than 12 percent, or no more than 10 percent, or no more than 5 percent, or no more than 4 percent, or no more than 3 percent, or no more than 2 percent, or no more than 1 percent, or no more than 0.5 percent, or no more than 0.1 percent.

The term “more thermally stable than macular pigment” or similar expression means that the compound (which may, when tested, be optionally embedded in an ophthalmic device, such as a hydrogel contact lens, and optionally measured either within or outside of a blister pack) exhibits less loss of absorbance at the visible light absorption maximum than observed with macular pigment, following thermal exposure as described above.

Unless otherwise indicated, ratios, percentages, parts, and the like are by weight.

Unless otherwise indicated, numeric ranges, for instance as in “from 2 to 10” or”

### Ophthalmic Devices

In one aspect, the invention provides an ophthalmic device that is a free radical reaction product of a reactive mixture comprising, consisting essentially of, or consisting of: one or more monomers suitable for making the ophthalmic device; a first visible light filtering compound, the first visible light filtering compound having a visible light absorption maximum between 430 nanometers and 480 nanometers and a full width half maximum at the visible light absorption maximum of at least 35 nanometers and up to 150 nanometers, wherein the compound is photostable, and wherein the compound has a molar extinction coefficient of at least 7740 L·mol⁻¹·cm⁻¹; and a second visible light filtering compound having a visible light absorption maximum between 480 nanometers and 530 nanometers and a full width half maximum of at least 50 nanometers and up to 150 nanometers. The reactive monomer mixture can also contain a third visible light filtering compound.

As noted above, in one aspect, the invention provides an ophthalmic device that is a free radical reaction product of a reactive mixture that contains a first visible light filtering compound and a second visible light filtering compound. First visible light filtering compounds for use in the invention substantially mimic the visible light absorption properties of macular pigment. First visible light filtering compounds are, however, more photostable than macular pigment and therefore, unlike macular pigment, are capable of being used in the manufacture of the ophthalmic device. First visible light filtering compounds may also be more thermally stable than macular pigment.

Thus, a first visible light filtering compound of the invention may have a visible light absorption maximum that is between 430 and 480 nanometers and a full width half maximum (FWHM) at the visible light absorption maximum of at least 35 nanometers and up to 150 nanometers (nm). The compound may be photostable (e.g., when measured according to ICH guideline Q1B). The compound may be more photostable than macular pigment.

The first visible light filtering compound may have a visible light absorption maximum that is between 430 nm and 480 nm, or between 440 nm and 470 nm, or between 450 nm and 470 nm, or between 460 nm and 470 nm.

The first visible light filtering compound may exhibit a FWHM at the visible light absorption maximum of at least 35 nm, or at least 40 nm, or at least 45 nm, or at least 55 nm, or at least 60 nm. The first visible light filtering compound may exhibit a FWHM at the visible light absorption maximum of up to 150 nm, or up to 125 nm, or up to 100 nm, or up to 95 nm, or up to 90 nm, or up to 85 nm, or up to 80 nm, or up to 75 nm, or up to 70 nm. The FWHM of the first visible light filtering compound, at the visible light absorption maximum, may be in the range of 35 nm to 150 nm, or 35 nm to 100 nm, or 40 nm to 95 nm, or 45 nm to 90 nm, or 55 nm to 80 nm, or 60 nm to 75 nm, or 60 nm to 70 nm, or 62 to 67 nm.

The first visible light filtering compound of the invention may exhibit a molar extinction coefficient at the visible light absorption maximum of at least 5000, or at least 5500, or at least 6000, or at least 6500, or at least 7000, or at least 7500, or at least 7740, or at least 7800, or at least 8000, or at least 9000, or at least 10,000, or at least 11,000, or at least 12,000, or at least 12,500. Molar extinction coefficient is an intrinsic property of a material and may be calculated from absorbance data using the Beer-Lambert law. The molar extinction coefficient is typically expressed in units of L·mol-1·cm⁻¹.

The first visible light filtering compound of the invention may be a compound of Formula I:

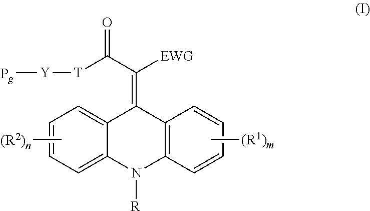

wherein m and n are independently 0, 1, 2, 3, or 4; T is a bond, O, or NR⁶, wherein R⁶ is H, C₁-C₆ alkyl, cycloalkyl, heterocycloalkyl, aryl, heteroaryl, or Y—P_{g}; R is H, C₁-C₈ alkyl, cycloalkyl, heterocycloalkyl, aryl, or heteroaryl; Y is a linking group; P_{g} is a polymerizable group; R₁ and R₂, when present, are independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R⁴, benzyl, SO₃H, or SO₃M (M is a monovalent cation, such as sodium or potassium), wherein R³ and R₄ are independently H or C₁-C₆ alkyl, or two adjacent R₁ or R₂ groups, together with the carbon atoms to which they are attached, combine to form a cycloalkyl or aryl ring; and EWG is an electron withdrawing group.

Compounds of formula I preferably contain one or two Y—P_{g} groups. More preferably, the compounds contain one Y—P_{g} group.

Compounds of formula I may include compounds of formula I-1, which are compounds of formula I wherein m and n are independently 0 or 1, or alternatively both are 0.

Compounds of formulae I and I-1 may include compounds of formula I-2, which are compounds of formula I or I-1 wherein n is 0 and m is 1.

Compounds of formulae I, I-1, and I-2 may include compounds of formula I-3, which are compounds of formula I, I-1, or I-2 wherein n is 0, m is 1, and R¹ is C₁-C₆ alkyl or C₁-C₆ alkoxy.

Compounds of formulae I, I-1, I-2, and I-3 may include compounds of formula I-4, which are compounds of formula I, I-1, I-2, or 1-3 wherein R is H, or C₁-C₈alkyl. Preferably, R is C₁-C₆ alkyl.

Compounds of formulae I, I-1, I-2, I-3 and I-4 may include compounds of formula I-5, which are compounds of formula I, I-1, I-2, I-3, or I-4 wherein Tis NR⁶, and R⁶ is H or C₁-C₆ alkyl. Preferably, R⁶ is H.

Compounds of formulae I, I-1, I-2, I-3, I-4, and I-5 may include compounds of formula 1-6, which are compounds of formula I, I-1, I-2, I-3, I-4, or I-5 wherein P_{g} (a polymerizable group) at each occurrence is independently styryl, vinyl carbonate, vinyl ether, vinyl carbamate, N-vinyl lactam, N-vinylamide, (meth)acrylate, or (meth)acrylamide. The polymerizable group allows the compounds of the invention to form covalent bonds when reacted with monomers, crosslinking agents, and other components generally used in making polymeric devices. The compatibility of the compounds with the reactive mixture can be controlled via the selection of the polymerizable group (and the linking group). Preferred polymerizable groups include (meth)acrylate or (meth)acrylamide. A more preferred polymerizable group is methacrylate.

Compounds of formulae I, I-1, I-2, I-3, I-4, I-5, and I-6 may include compounds of formula I-7, which are compounds of formula I, I-1, I-2, I-3, I-4, I-5, and I-6 wherein Y (a linking group) is alkylene, cycloalkylene, heterocycloalkylene, arylene (e.g., phenylene), heteroarylene, oxaalkylene, alkylene-amide-alkylene, alkylene-amine-alkylene, or combinations of any of the foregoing groups. Preferred linking groups include C₁-C₈ alkylene (e.g., ethylene or propylene), C₁-C₈ oxaalkylene, C₁-C₈ alkylene-amide-C₁-C₈ alkylene, and C₁-C₈ alkylene-amine-C₁-C₈ alkylene. Particularly preferred is C₁-C₈ alkylene, especially ethylene (—CH₂CH₂—). When T in the compound of formula I is O, it is preferred that the carbon atom of the linking group to which the O is attached be hindered. For instance, if T is O and Y is alkylene, a preferred alkylene is —C(RH) 2 (CH₂)ₓ—, where RH is independently C₁-C₆ alkyl (preferably independently methyl or ethyl) and x is from 1 to 5.

Compounds of formulae I, I-1, I-2, I-3, I-4, I-5, I-6, and I-7 may include compounds of formula I-8, which are compounds of formula I, I-1, I-2, I-3, I-4, I-5, 1-6, or I-7 wherein T is a bond or is NR⁶ (preferably NH).

Compounds of formulae I, I-1, I-2, I-3, I-4, I-5, I-6, I-7, and I-8 may include compounds of formula I-9, which are compounds of formula I, I-1, I-2, I-3, I-4, I-5, I-6, I-7, or I-8, wherein EWG is cyano, amide, ester, keto, or aldehyde. Preferably, EWG is cyano.

First visible light filtering compounds of the invention may be of formula I-A:

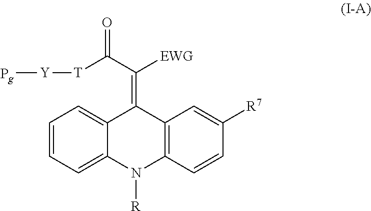

wherein:
T is a bond, O, or NR⁶, wherein R⁶ is H, C₁-C₆ alkyl, cycloalkyl, heterocycloalkyl, aryl, or heteroaryl;
R is H, C₁-C₈alkyl, cycloalkyl, heterocycloalkyl, aryl, or heteroaryl;
Y is a linking group;
P_{g} is a polymerizable group; R₇ is H, C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R₄, benzyl, SO₃H, or SO₃M (M is a monovalent cation, such as sodium or potassium), wherein R³ and R₄ are independently H or C₁-C₆ alkyl; and
EWG is an electron withdrawing group.

Compounds of formula I-A may include compounds of formula I-A-1, which are compounds of formula I-A wherein R₇ is H.

Compounds of formulae I-A may include compounds of formula I-A-2, which are compounds of formula I-A wherein R₇ is C₁-C₆ alkyl, C₁-C₆ alkoxy, or C₁-C₆ thioalkyl.

Compounds of formulae I-A and I-A-2 may include compounds of formula I-A-3, which are compounds of formula I-A or I-A-2 wherein R₇ is C₁-C₆ alkoxy, such as ethoxy or methoxy, preferably methoxy.

Compounds of formulae I-A, I-A-1, I-A-2, and I-A-3 may include compounds of formula I-A-4, which are compounds of formula I-A, I-A-1, I-A-2, or I-A-3 wherein R is H, or C₁-C₈ alkyl. Preferably, R is C₁-C₆ alkyl, such as methyl, ethyl, n-propyl, iso-propyl, n-butyl, t-butyl, or sec-butyl. Preferably, R is n-propyl or n-butyl.

Compounds of formulae I-A, I-A-1, I-A-2, I-A-3 and I-A-4 may include compounds of formula I-A-5, which are compounds of formula I-A, I-A-1, I-A-2, I-A-3, or I-A-4 wherein T is NR⁶, and R⁶ is H, or C₁-C₆ alkyl. Preferably, R⁶ is H.

Compounds of formulae I-A, I-A-1, I-A-2, I-A-3, I-A-4, and I-A-5 may include compounds of formula I-A-6, which are compounds of formula I-A, I-A-1, I-A-2, I-A-3, I-A-4, or I-A-5 wherein P_{g} (a polymerizable group) at each occurrence independently comprises styryl, vinyl carbonate, vinyl ether, vinyl carbamate, N-vinyl lactam, N-vinylamide, (meth)acrylate, or (meth)acrylamide. Preferred polymerizable groups include (meth)acrylate or (meth)acrylamide. A more preferred polymerizable group is methacrylate.

Compounds of formulae I-A, I-A-1, I-A-2, I-A-3, I-A-4, I-A-5, and I-A-6 may include compounds of formula I-A-7, which are compounds of formula I-A, I-A-1, I-A-2, I-A-3, I-A-4, I-A-5, and I-A-6 wherein Y (a linking group) is alkylene, cycloalkylene, heterocycloalkylene, arylene (e.g., phenylene), heteroarylene, oxaalkylene, alkylene-amide-alkylene, alkylene-amine-alkylene, or combinations of any of the foregoing groups. Preferred linking groups include C₁-C₈alkylene (e.g., ethylene or propylene), C₁-C₈ oxaalkylene, C₁-C₈ alkylene-amide-C₁-C₈ alkylene, and C₁-C₈ alkylene-amine-C₁-C₈ alkylene. Particularly preferred is C₁-C₈alkylene, especially ethylene (—CH₂CH₂—). When T in the compound of formula I-A is O, it is preferred that the carbon atom of the linking group to which the O is attached be hindered. For instance, if T is O and Y is alkylene, a preferred alkylene is —C(RH) 2 (CH₂)ₓ—, where RH is independently C₁-C₆ alkyl (preferably independently methyl or ethyl) and x is from 1 to 5.

Compounds of formulae I-A, I-A-1, I-A-2, I-A-3, I-A-4, I-A-5, I-A-6, and I-A-7 may include compounds of formula I-A-8, which are compounds of formula I-A, I-A-1, I-A-2, I-A-3, I-A-4, I-A-5, I-A-6, or I-A-7 wherein T is a bond or is NR⁶ (preferably NH).

Compounds of formulae I-A, I-A-1, I-A-2, I-A-3, I-A-4, I-A-5, I-A-6, I-A-7, and I-A-8 may include compounds of formula I-A-9, which are compounds of formula I-A, I-A-1, I-A-2, I-A-3, I-A-4, I-A-5, I-A-6, I-A-7, or I-A-8, wherein EWG is cyano, amide, ester, keto, or aldehyde. Preferably, EWG is cyano.

Specific examples of first visible light filtering compounds of the invention are shown in Table A.

TABLE A

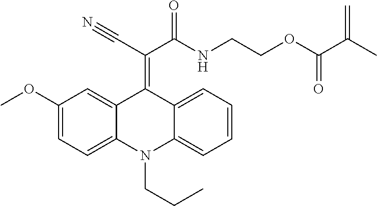 [SMILES: C=C(C)C(=O)OCCNC(=O)/C(C#N)=C1\c2ccccc2N(CCC)c2ccc(OC)cc21]

2-(2-cyano-2-(2-methoxy-10-propylacridin-9(10H)-ylidene)acetamido)ethyl methacrylate

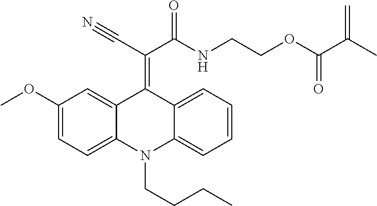 [SMILES: C=C(C)C(=O)OCCNC(=O)/C(C#N)=C1\c2ccccc2N(CCCC)c2ccc(OC)cc21]

2-(2-cyano-2-(2-methoxy-10-butylacridin-9(10H)-ylidene)acetamido)ethyl methacrylate

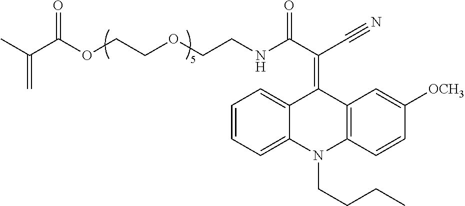

1-(10-butyl-2-methoxyacridin-9(10H)-ylidene)-1-cyano-2-oxo-6,9,12,15,18-pentaoxa-3-
azaicosan-20-yl methacrylate

Compounds of formula I may be prepared as described in pre-grant publication US20220194944A1. For instance, the compounds may be prepared from N-substituted acridones by utilizing triphenylphosphine dibromide. Triphenylphosphine dibromide maybe generated “in-situ” by the addition of bromine to triphenylphosphine in an appropriate solvent. Addition of an N-substituted acridone after the complete consumption of bromine avoids potential oxidation of the former and forms the desired product in high yields with significantly reduced byproduct formation. An exemplary synthesis for compounds of formula I is shown in Scheme A.

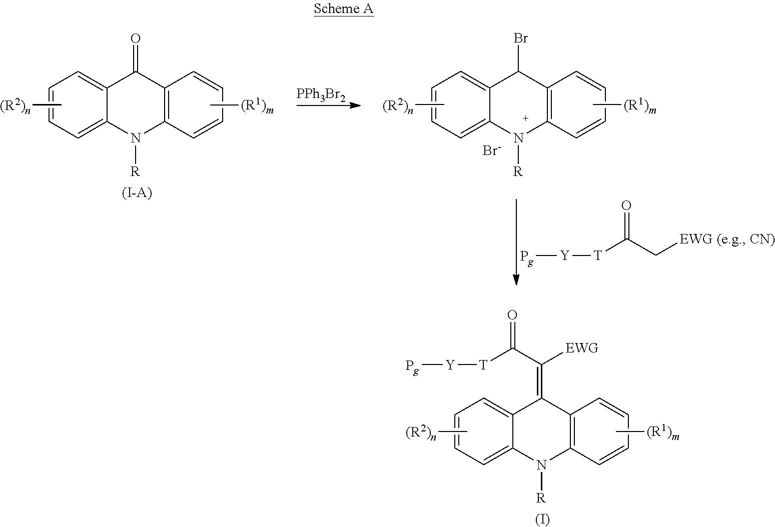

The reactive mixture from which the ophthalmic devices of the invention are prepared contains, in addition to a first visible light filtering compound, a second visible light filtering compound having a visible light absorption maximum between 480 nanometers and 530 nanometers, or between 490 nanometers and 520 nanometers, and a full width half maximum of at least 50 nanometers and up to 150 nanometers, or at least 70 nanometers and up to 130 nanometers, or at least 80 nanometers and up to 120 nanometers.

The second visible light filtering compound of the invention may be a compound of Formula II:

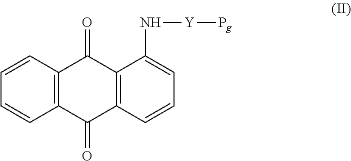

wherein Y is a linking group, and P_{g} is a polymerizable group.

Preferred linking groups in the second visible light filtering compound of formula II include alkylene, oxaalkylene, alkyleneoxy, or combinations thereof. More preferred linking groups are alkylenes and oxaalkylenes having between five and ten carbon atoms and ethyleneoxy segment (CH₂CH₂O)ₚ wherein p is between three and six. These preferred linking groups provide good solubility of second visible light filtering compounds of formula II in reactive monomer mixtures and acceptable photochemical, thermal and hydrolytic stability for ophthalmic devices. Preferred polymerizable groups in the second visible light filtering compound of formula II include styryl, vinyl carbonate, vinyl ether, vinyl carbamate, N-vinyl lactam, N-vinylamide, (meth)acrylate, or (meth)acrylamide. More preferred P_{g} are (meth)acrylates and (meth)acrylamides. Most preferred P_{g} are (meth)acrylates.

Specific examples of second visible light filtering compounds of the invention are shown in Table B. A preferred second visible light filtering compound is 2-(2-(2-((9,10-dioxo-9,10-dihydroanthracen-1-yl)amino) ethoxy) ethoxy)ethyl methacrylate.

TABLE B

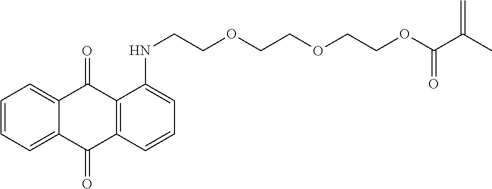 [SMILES: C=C(C)C(=O)OCCOCCOCCNc1cccc2c1C(=O)c1ccccc1C2=O]

2-(2-(2-((9,10-dioxo-9,10-dihydroanthracen-1-yl)amino)ethoxy)ethoxy)ethyl methacrylate

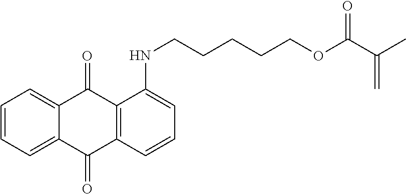 [SMILES: C=C(C)C(=O)OCCCCCNc1cccc2c1C(=O)c1ccccc1C2=O]

5-((9,10-dioxo-9,10-dihydroanthracen-1-yl)amino)pentyl methacrylate

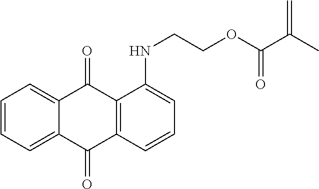 [SMILES: C=C(C)C(=O)OCCNc1cccc2c1C(=O)c1ccccc1C2=O]

2-((9,10-dioxo-9,10-dihydroanthracen-1-yl)amino)ethyl methacrylate

The reactive mixture from which the ophthalmic devices of the invention are prepared may contain, in addition to a first visible light filtering compound and a second visible light filtering compound, a third visible light filtering compound, having one or more visible light absorption maxima between 550 nanometers and 660 nanometers. The third visible light filtering compound may be added to modify the ultraviolet-visible light absorbance or transmission spectrum of the ophthalmic device.

The third visible light filtering compound may be a compound of Formula III:

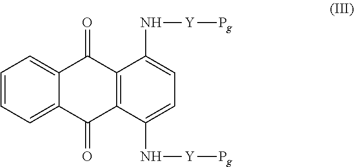

wherein Y at each occurrence is independently a linking group and P_{g} at each occurrence is independently a polymerizable group.

Compounds of formula III may include compounds of formula III-1, which are compounds of formula III wherein Y at each occurrence is independently alkylene, cycloalkylene, heterocycloalkylene, arylene, heteroarylene, oxaalkylene, alkylene-amide-alkylene, alkylene-amine-alkylene, or combinations thereof.

Compounds of formulae III and III-1 may include compounds of formula III-2, which are compounds of formula III or III-1 wherein P_{g} at each occurrence independently comprises styryl, vinyl carbonate, vinyl ether, vinyl carbamate, N-vinyl lactam, N-vinylamide, (meth)acrylate, or (meth)acrylamide. Preferably, P_{g} at each occurrence comprises (meth)acrylate, more preferably methacrylate.

The third visible light filtering compound of formula III may comprise 1,4-bis [2-methacryloxyethylamino]-9,10-anthraquinone or ((9,10-dioxo-9,10-dihydroanthracene-1,4-diyl)bis(azanediyl))bis(ethane-2,1-diyl)bis(2-methylacrylate) (RB247), (((9,10-dioxo-9,10-dihydroanthracene-1,4-diyl)bis(azanediyl)) bis(4,1-phenylene))bis(ethane-2,1-diyl)bis(2-methylacrylate) (RB246), (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate), or N,N′-(((((((9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl))diacrylamide. Some third visible light filtering compounds of formula III are commercially available and/or they may be readily prepared by those skilled in the art, for instance, as described in U.S. Pat. No. 4,997,897, which is incorporated herein by reference in its entirety.

The third visible light filtering compound may alternatively be a compound having the chemical structure of Formula IV:

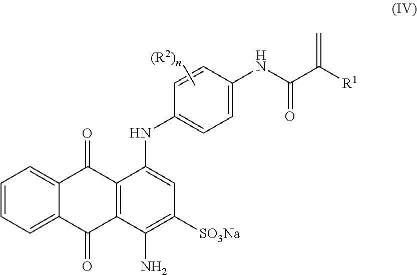

wherein R¹ is H, methyl, or Br and R₂ is independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), benzyl, halo, hydroxy, amino, NR³R₄, SO₃H, or SO₃M (M is a monovalent cation, such as sodium or potassium), wherein R³ and R₄ are independently H or C₁-C₆ alkyl, or two adjacent R₂ groups, together with the carbon atoms to which they are attached, combine to form a cycloalkyl or aryl ring.

The third visible light filtering compound of formula IV may comprise sodium 1-amino-4-((4-(2-bromoacrylamido)-2-sulfonatophenyl)amino)-9,10-dioxo-9,10-dihydroanthracene-2-sulfonate (IMT Blue), sodium 4-((4-acrylamidophenyl)amino)-1-amino-9,10-dioxo-9,10-dihydroanthracene-2-sulfonate, sodium 1-amino-4-((4-methacrylamidophenyl)amino)-9,10-dioxo-9,10-dihydroanthracene-2-sulfonate, or combinations thereof. A preferred third visible light filtering compound is sodium 1-amino-4-((4-(2-bromoacrylamido)-2-sulfonatophenyl)amino)-9,10-dioxo-9,10-dihydroanthracene-2-sulfonate having the chemical structure:

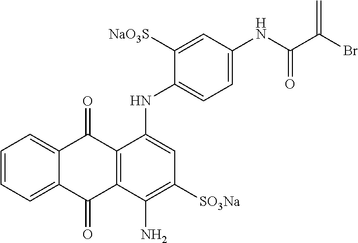

The third visible light filtering compound may alternatively (or in addition) comprise a high energy visible light filter that limits the transmittance of the device across a wavelength range of 400 to 409 nm to between 0 percent and 70 percent, or between 0.2 and 70 percent, or between 0.5 and 70 percent, or between 1 and 70 percent. The high energy visible light filter may limit the transmittance of the device across the 400 to 409 nm wavelength range to 0 percent, or at least 0.2 percent, or at least 0.5 percent, or at least 1 percent, or at least 2 percent, or at least 3 percent, or at least 4 percent and up to 60 percent, or up to 50 percent, or up to 40 percent, or up to 30 percent, or up 20 percent, or up to 15 percent or up to 10 percent. The high energy visible light filter may limit the transmittance of the device across the 400 to 409 nm wavelength range to between 0 percent and 40 percent, or between 0.2 percent and 35 percent, or between 2 percent and 30 percent, or between 4 percent and 25 percent, or between 5 percent and 20 percent, or between 0.2 percent and 20 percent.

The high energy visible light filter may contain at least one polymerizable group.

The high energy visible light filter may be a compound of Formula V:

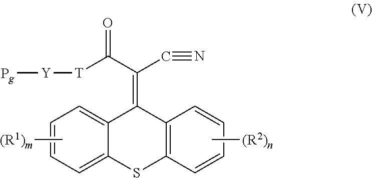

wherein:
m and n are independently 0, 1, 2, 3, or 4;
T is a bond, O, or NR;
Y is a linking group;
P_{g} is a polymerizable group;
R at each occurrence is independently H, C₁-C₆ alkyl, cycloalkyl, heterocycloalkyl, aryl, heteroaryl, or Y—P_{g}; and
R₁ and R₂, when present, are independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R₄, or benzyl, wherein R³ and R₄ are independently H or C₁-C₆ alkyl, or two adjacent R₁ or R₂ groups, together with the carbon atoms to which they are attached, combine to form a cycloalkyl or aryl ring. Compounds of formula V preferably contain one or two Y—P_{g} groups. More preferably, the compounds contain one Y—P_{g} group.

Compounds of formula V may include compounds of formula V-1, which are compounds of formula V wherein m and n are independently 0 or 1, or alternatively both are 0.

Compounds of formulae V and V-1 may include compounds of formula V-2, which are compounds of formula V, or V-1 wherein m is 1 and R₁ is C₁-C₆ alkyl, preferably ethyl or methyl.

Compounds of formulae V, V-1, and V-2 may include compounds of formula V-3, which are compounds of formula V, V-1, or V-2 wherein n is 1 and R₂ is C₁-C₆ alkyl, preferably ethyl or methyl.

Compounds of formulae V, V-1, V-2, and V-3 may include compounds of formula V-4, which are compounds of formula V, V-1, V-2, or V-3 wherein R is H, or C₁-C₆ alkyl. Preferably, R in the group T is H.

Compounds of formulae V, V-1, V-2, V-3, and V-4 may include compounds of formula V-5, which are compounds of formula V, V-1, V-2, V-3, or V-4 wherein P_{g} (a polymerizable group) at each occurrence independently comprises styryl, vinyl carbonate, vinyl ether, vinyl carbamate, N-vinyl lactam, N-vinylamide, (meth)acrylate, or (meth)acrylamide. The polymerizable group allows the compounds of the invention to form covalent bonds when reacted with monomers, crosslinking agents, and other components generally used in making contact lenses. The compatibility of the compounds with the reactive mixture can be controlled via the selection of the polymerizable group (and the linking group). Preferred polymerizable groups include (meth)acrylate or (meth)acrylamide. A more preferred polymerizable group is methacrylate.

Compounds of formulae V, V-1, V-2, V-3, V-4, and V-5 may include compounds of formula V-6, which are compounds of formula V, V-1, V-2, V-3, V-4, or V-5 wherein Y (a linking group) is alkylene, cycloalkylene, heterocycloalkylene, arylene (e.g., phenylene), heteroarylene, oxaalkylene, alkylene-amide-alkylene, alkylene-amine-alkylene, or combinations of any of the foregoing groups. Preferred linking groups include C₁-C₈ alkylene (e.g., ethylene or propylene), C₁-C₈ oxaalkylene, C₁-C₈ alkylene-amide-C₁-C₈ alkylene, and C₁-C₈ alkylene-amine-C₁-C₈ alkylene. Particularly preferred is C₁-C₈ alkylene, especially ethylene (—CH₂CH₂—). When T in the compound of formula V is O, it is preferred that the carbon atom of the linking group to which the O is attached be hindered. For instance, if Tis O and Y is alkylene, a preferred alkylene is —C(RH) 2 (CH₂)ₓ—, where RH is independently C₁-C₆ alkyl (preferably independently methyl or ethyl) and x is from 1 to 5.

Compounds of formulae V, V-1, V-2, V-3, V-4, V-5, and V-6 may include compounds of formula V-7, which are compounds of formula V, V-1, V-2, V-3, V-4, V-5, or V-6 wherein T is a bond or is NR (preferably NH).

Compounds of formula V may include compounds of formula V-A:

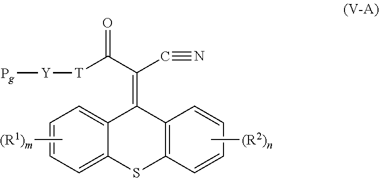

wherein:
m and n are independently 0, 1, 2, 3, or 4;
Y is a linking group;
P_{g} is a polymerizable group;
R at each occurrence is independently H, C₁-C₆ alkyl, cycloalkyl, heterocycloalkyl, aryl, heteroaryl, or Y—P_{g}; and
R₁ and R₂, when present, are independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R₄, or benzyl, wherein R³ and R₄ are independently H or C₁-C₆ alkyl, or two adjacent R₁ or R₂ groups, together with the carbon atoms to which they are attached, combine to form a cycloalkyl or aryl ring. Compounds of formula V-A preferably contain one or two Y—P_{g} groups. More preferably, the compounds contain one Y—P_{g} group.

Compounds of formulae V-A may include compounds of formula V-A-1, which are compounds of formula V-A wherein m and n are independently 0 or 1, or alternatively both are 0.

Compounds of formulae V-A, and V-A-1 may include compounds of formula V-A-2, which are compounds of formula V-A, or V-A-1 wherein m is 1 and R₁ is C₁-C₆ alkyl, preferably ethyl or methyl.

Compounds of formulae V-A, V-A-1, and V-A-2 may include compounds of formula V-A-3, which are compounds of formula V-A, V-A-1, or V-A-2 wherein n is 1 and R₂ is C₁-C₆ alkyl, preferably ethyl or methyl.

Compounds of formulae V-A, V-A-1, V-A-2, and V-A-3 may include compounds of formula V-A-4, which are compounds of formula V-A, V-A-1, V-A-2, or V-A-3 wherein R at each occurrence is independently H, or C₁-C₆ alkyl. Preferably, R at each occurrence is H. Preferably R in the group T is H.

Compounds of formulae V-A, V-A-1, V-A-2, V-A-3, and V-A-4 may include compounds of formula V-A-5, which are compounds of formula V-A, V-A-1, V-A-2, V-A-3, or V-A-4 wherein P_{g} (a polymerizable group) at each occurrence independently comprises styryl, vinyl carbonate, vinyl ether, vinyl carbamate, N-vinyl lactam, N-vinylamide, (meth)acrylate, or (meth)acrylamide. The polymerizable group allows the compounds of the invention to form covalent bonds when reacted with monomers, crosslinking agents, and other components generally used in making polymeric devices. The compatibility of the compounds with the reactive mixture can be controlled via the selection of the polymerizable group (and the linking group). Preferred polymerizable groups include (meth)acrylate or (meth)acrylamide. A more preferred polymerizable group is methacrylate.

Compounds of formulae V-A, V-A-1, V-A-2, V-A-3, V-A-4, and V-A-5 may include compounds of formula V-A-6, which are compounds of formula V-A, V-A-1, V-A-2, V-A-3, V-A-4, or V-A-5 wherein Y (a linking group) is alkylene, cycloalkylene, heterocycloalkylene, arylene (e.g., phenylene), heteroarylene, oxaalkylene, alkylene-amide-alkylene, alkylene-amine-alkylene, or combinations of any of the foregoing groups. Preferred linking groups include C₁-C₈ alkylene (e.g., ethylene or propylene), C₁-C₈ oxaalkylene, C₁-C₈ alkylene-amide-C₁-C₈ alkylene, and C₁-C₈ alkylene-amine-C₁-C₈ alkylene. Particularly preferred is C₁-C₈ alkylene, especially ethylene (—CH₂CH₂—).

Specific examples of compounds of formula V include, but are not limited to, the compounds shown in Table B.

TABLE B

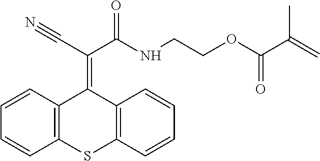 [SMILES: C=C(C)C(=O)OCCNC(=O)C(C#N)=C1c2ccccc2Sc2ccccc21]

2-(2-cyano-2-(9H-thioxanthen-9-ylidene)acetamido)
ethyl methacrylate

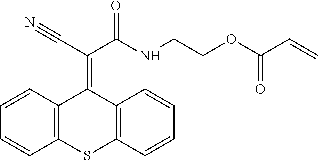 [SMILES: C=CC(=O)OCCNC(=O)C(C#N)=C1c2ccccc2Sc2ccccc21]

2-(2-cyano-2-(9H-thioxanthen-9-ylidene)acetamido)
ethyl acrylate

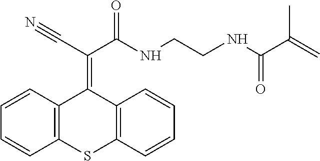 [SMILES: C=C(C)C(=O)NCCNC(=O)C(C#N)=C1c2ccccc2Sc2ccccc21]

N-(2-(2-cyano-2-(9H-thioxanthen-9-ylidene)acetamido)
ethyl)methacrylamide

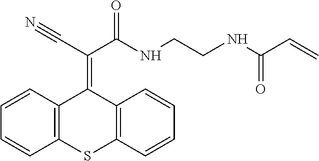 [SMILES: C=CC(=O)NCCNC(=O)C(C#N)=C1c2ccccc2Sc2ccccc21]

N-(2-(2-cyano-2-(9H-thioxanthen-9-ylidene)acetamido)
ethyl)acrylamide

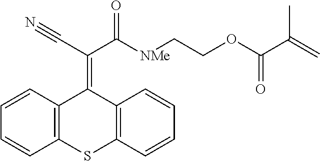 [SMILES: C=C(C)C(=O)OCCN(C)C(=O)C(C#N)=C1c2ccccc2Sc2ccccc21]

2-(2-cyano-N-methyl-2-(9H-thioxanthen-9-ylidene)acetamido)
ethyl methacrylate

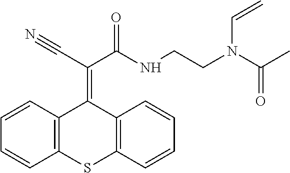 [SMILES: C=CN(CCNC(=O)C(C#N)=C1c2ccccc2Sc2ccccc21)C(C)=O]

2-cyano-2-(9H-thioxanthen-9-ylidene)-N-(2-(N-vinylacetamido)
ethyl)acetamide

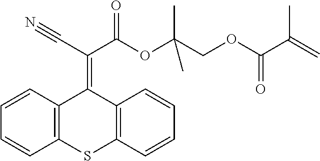 [SMILES: C=C(C)C(=O)OCC(C)(C)OC(=O)C(C#N)=C1c2ccccc2Sc2ccccc21]

2-(2-cyano-2-(9H-thioxanthen-9-ylidene)acetamido)-
2-methylpropyl methacrylate

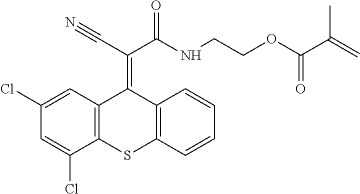 [SMILES: C=C(C)C(=O)OCCNC(=O)/C(C#N)=C1\c2ccccc2Sc2c(Cl)cc(Cl)cc21]

2-(2-cyano-2-(2,4-dichloro-9H-thioxanthen-9-ylidene)
acetamido)ethyl methacrylate

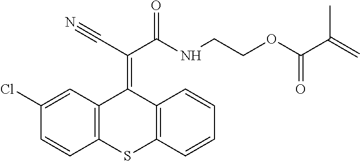 [SMILES: C=C(C)C(=O)OCCNC(=O)/C(C#N)=C1\c2ccccc2Sc2ccc(Cl)cc21]

2-(2-(2-chloro-9H-thioxanthen-9-ylidene)-2-cyanoacetamido)
ethyl methacrylate

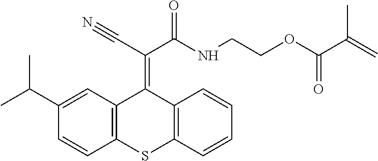 [SMILES: C=C(C)C(=O)OCCNC(=O)/C(C#N)=C1\c2ccccc2Sc2ccc(C(C)C)cc21]

2-(2-cyano-2-(2-isopropyl-9H-thioxanthen-9-ylidene)acetamido)
ethyl methacrylate

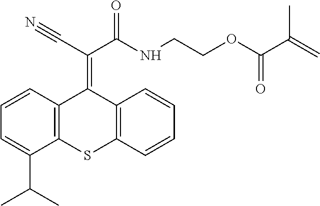 [SMILES: C=C(C)C(=O)OCCNC(=O)/C(C#N)=C1\c2ccccc2Sc2c1cccc2C(C)C]

2-(2-cyano-2-(4-isopropyl-9H-thioxanthen-9-ylidene)acetamido)
ethyl methacrylate

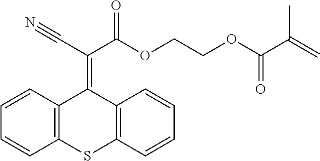 [SMILES: C=C(C)C(=O)OCCOC(=O)C(C#N)=C1c2ccccc2Sc2ccccc21]

2-(2-cyano-2-(9H-thioxanthen-9-ylidene)acetoxy)
ethyl methacrylate

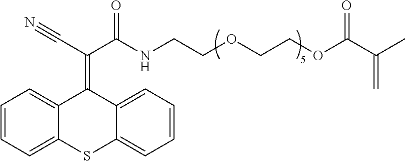

1-cyano-2-oxo-1-(9H-thioxanthen-9-ylidene)-6,9,12,15,18-pentaoxa-3-
azaicosan-20-yl methacrylate

Compounds of formula V may be readily prepared by those skilled in the art, for instance as described in US20210061934, which is incorporated by reference herein in its entirety.

The third visible light filtering compound may be a high energy visible light filter having a chemical structure according to Formula VI:

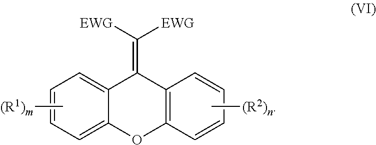

wherein m and n are independently 0, 1, 2, 3, or 4; R₁ and R₂ are independently at each occurrence H, an optional substituent, or —Y—P_{g}, or two adjacent R₁ or R₂ groups, together with the atoms to which they are attached, combine to form a cycloalkyl or aryl ring optionally substituted with —Y—P_{g}; and EWG at each occurrence is independently an electron withdrawing group; P_{g} at each occurrence is independently a polymerizable group; Y at each occurrence is independently a linking group; wherein the compound of formula VI contains at least one P_{g} group.

Compounds of formula VI may include compounds of formula VI-1 which are compounds of formula VI wherein m and n are independently 0 or 1, or alternatively one is 0 and the other is 1.

Compounds of formulae VI and VI-1 may include compounds of formula VI-2, which are compounds of formula VI or VI-1 wherein R¹ is H, C₁-C₆ alkyl, C₁-C₆ alkoxy, C₁-C₆ thioalkyl, C₃-C₇ cycloalkyl, aryl, halo, hydroxy, amino, NR⁴R₅, benzyl, SO₃H, or SO₃Na, wherein R₄ and R⁵ are independently H or C₁-C₆ alkyl.

Compounds of formulae VI, VI-1, and VI-2 may include compounds of formula VI-3, which are compounds of formula VI, VI-1, or VI-2 wherein R₂ is —Y—P_{g}.

Compounds of formulae VI, VI-1, VI-2, and VI-3 may include compounds of formula VI-4, which are compounds of formula VI, VI-1, VI-2, or VI-3 wherein P_{g} (a polymerizable group) at each occurrence independently comprises styryl, vinyl carbonate, vinyl ether, vinyl carbamate, N-vinyl lactam, N-vinylamide, (meth)acrylate, or (meth)acrylamide. The polymerizable group allows the compounds of the invention to form covalent bonds when reacted with monomers, crosslinking agents, and other components which may be used in making polymeric devices. The compatibility of the compounds with the reactive mixture can be controlled via the selection of the polymerizable group (and the linking group). Preferred polymerizable groups include (meth)acrylate or (meth)acrylamide. A more preferred polymerizable group is methacrylate.

Compounds of formulae VI, VI-1, VI-2, VI-3, and VI-4 may include compounds of formula VI-5, which are compounds of formula VI, VI-1, VI-2, VI-3, or VI-4 wherein Y (a linking group) is alkylene, cycloalkylene, heterocycloalkylene, arylene (e.g., phenylene), heteroarylene, oxaalkylene, alkylene-amide-alkylene, alkylene-amine-alkylene, or combinations of any of the foregoing groups. Preferred linking groups include C₁-C₈ alkylene (e.g., ethylene or propylene), C₁-C₈ oxaalkylene, C₁-C₈ alkylene-amide-C₁-C₈alkylene, and C₁-C₈ alkylene-amine-C₁-C₈ alkylene. Particularly preferred is oxa-C₁-C₈ alkylene, especially oxa-propylene (—O—CH₂CH₂CH₂—).

Compounds of formulae VI, VI-1, VI-2, VI-3, VI-4, and VI-5 may include compounds of formula VI-6, which are compounds of formula VI, VI-1, VI-2, VI-3, VI-4, or VI-5 wherein EWG at each occurrence is independently cyano, amide, ester, keto, or aldehyde. Preferably EWG at each occurrence is cyano.

Compounds of formulae VI, VI-1, VI-2, VI-3, VI-4, VI-5, and VI-6 may include compounds of formula VI-7, which are compounds of formula VI, VI-1, VI-2, VI-3, VI-4, VI-5, or VI-6 wherein the compound contains one Y—P_{g} group.

Compounds of formulae VI, VI-1, VI-2, VI-3, VI-4, VI-5, VI-6, and VI-7 may include compounds of formula VI-8, which are compounds of formula VI, VI-1, VI-2, VI-3, VI-4, VI-5, VI-6, VI-7 wherein m is 0 and R₂ is —Y—P_{g}.

Specific examples of compounds of formula VI include, but are not limited to, are listed in Table C:

TABLE C

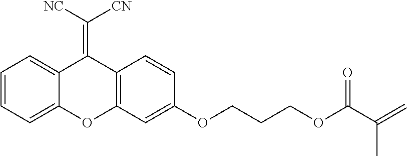 [SMILES: C=C(C)C(=O)OCCCOc1ccc2c(c1)Oc1ccccc1C2=C(C#N)C#N]

3-((9-(dicyanomethylene)-9H-xanthen-3-yl)oxy)propyl methacrylate;

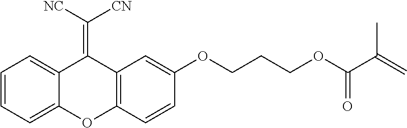 [SMILES: C=C(C)C(=O)OCCCOc1ccc2c(c1)C(=C(C#N)C#N)c1ccccc1O2]

3-((9-(dicyanomethylene)-9H-xanthen-2-yl)oxy)propyl methacrylate;

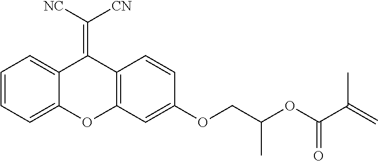 [SMILES: C=C(C)C(=O)OC(C)COc1ccc2c(c1)Oc1ccccc1C2=C(C#N)C#N]

1-((9-(dicyanomethylene)-9H-xanthen-3-yl)oxy)propan-2-yl
methacrylate;

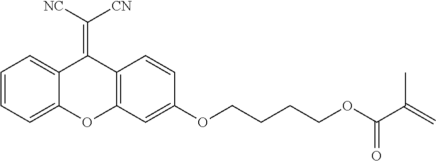 [SMILES: C=C(C)C(=O)OCCCCOc1ccc2c(c1)Oc1ccccc1C2=C(C#N)C#N]

4-((9-(dicyanomethylene)-9H-xanthen-3-yl)oxy)butyl methacrylate;

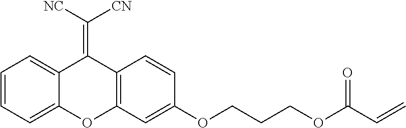 [SMILES: C=CC(=O)OCCCOc1ccc2c(c1)Oc1ccccc1C2=C(C#N)C#N]

3-((9-(dicyanomethylene)-9H-xanthen-3-yl)oxy)propyl acrylate;

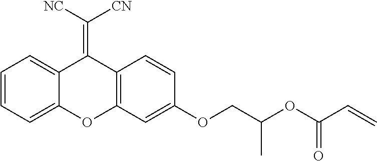 [SMILES: C=CC(=O)OC(C)COc1ccc2c(c1)Oc1ccccc1C2=C(C#N)C#N]

1-((9-(dicyanomethylene)-9H-xanthen-3-yl)oxy)propan-2-yl acrylate;

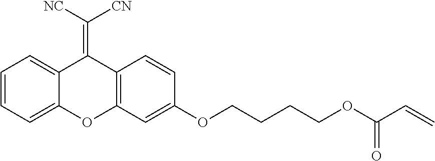 [SMILES: C=CC(=O)OCCCCOc1ccc2c(c1)Oc1ccccc1C2=C(C#N)C#N]

4-((9-(dicyanomethylene)-9H-xanthen-3-yl)oxy)butyl acrylate;

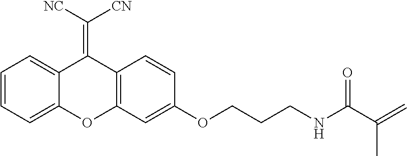 [SMILES: C=C(C)C(=O)NCCCOc1ccc2c(c1)Oc1ccccc1C2=C(C#N)C#N]

N-(3-((9-(dicyanomethylene)-9H-xanthen-3-yl)oxy)propyl)
methacrylamide;

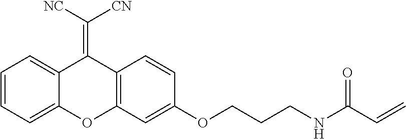 [SMILES: C=CC(=O)NCCCOc1ccc2c(c1)Oc1ccccc1C2=C(C#N)C#N]

N-(3-((9-(dicyanomethylene)-9H-xanthen-3-yl)oxy)propyl)
acrylamide; or

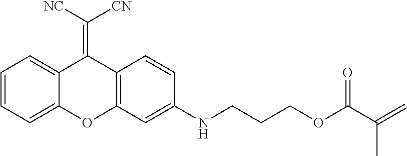 [SMILES: C=C(C)C(=O)OCCCNc1ccc2c(c1)Oc1ccccc1C2=C(C#N)C#N]

3-((9-(dicyanomethylene)-9H-xanthen-3-yl)amino)propyl methacrylate.

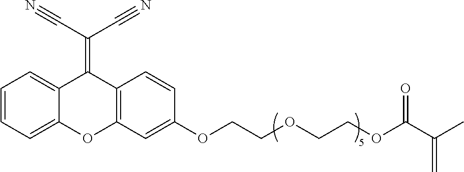

17-((9-(dicyanomethylene)-9H-xanthen-3-yl)oxy)-3,6,9,12,15-
pentaoxaheptadecyl methacrylate

Compounds of formula VI may exhibit a molar extinction coefficient at the visible light absorption maximum of at least 5000, or at least 7500, or at least 10,000, or at least 12,500, or at least 15,000, or at least 17,500, or at least 19,000. Molar extinction coefficient is an intrinsic property of a material and may be calculated from absorbance data using the Beer-Lambert law. The units of molar extinction coefficients are typically L·mol-1·cm⁻¹.

Compounds of formula VI may be readily prepared by those skilled in the art, for instance as described in US20200407324 and in U.S. provisional patent application No. 63/265,706, filed Dec. 20, 2021, each of which is incorporated herein by reference in its entirety.

High energy visible (HEV) light absorbing filters for use in the invention, including those of formula V and formula VI, are preferably photostable. Thus, devices of the invention, such as contact lenses, which contain a high energy visible light filter as the third visible light filtering compound preferably exhibit 20% or less, alternatively 15% or less, alternatively 10% or less, alternatively 7% or less, alternatively 5% or less, or alternatively 2% or less of change in their average transmission over a wavelength range of 380 to 450 nm, following exposure under ICH Q1B conditions.

As noted above, the reactive mixture from which the ophthalmic devices of the invention are prepared may contain, in addition to a first visible light filtering compound and a second visible light filtering compound, a third visible light filtering compound. The third light filtering compound may comprise a mixture of a visible light filters, such as those represented by Formulae III and IV, and high energy visible light filters, such as those represented by Formulac V and VI, as described above.

Other light absorbing compounds may be included in the reactive mixture from which the ophthalmic devices of the invention are prepared in order to provide additional desirable absorption characteristics. For example, preferred reactive mixtures may comprise a first visible light filtering compound, a second visible light filtering compound, and a third visible light filtering compound as described above together with a UV absorbing compound. Suitable UV absorbing compounds are known in the art and fall into several classes which include, but are not limited to, benzophenones, benzotriazoles, triazines, substituted acrylonitriles, salicyclic acid derivatives, benzoic acid derivatives, cinnamic acid derivatives, chalcone derivatives, dypnone derivatives, crotonic acid derivatives, or any mixtures thereof. A preferred class of UV absorbing compound is benzotriazoles, such as (2-(2′-hydroxy-5-methacrylyloxyethylphenyl)-2H-benzotriazole) which is known as Norbloc.

An ophthalmic device of the invention is preferably photostable. For instance, the device, such as a contact lens, preferably exhibits 20% or less, alternatively 15% or less, alternatively 10% or less, alternatively 7% or less, alternatively 5% or less, or alternatively 2% or less of change in average transmission over a wavelength range of 400 to 660 nm, following exposure under ICH Q1B conditions.

A variety of ophthalmic devices may be prepared, including spectacles, sunglasses, hard contact lenses, soft contact lenses, corneal onlays, corneal inlays, intraocular lenses, phakic intraocular lens, or overlay lenses. Preferably, the ophthalmic device is an intraocular lens or a soft contact lens. The soft contact lens may be made from a conventional (non-silicone) hydrogel or from a silicone hydrogel.

The reactive monomer mixture of the invention may comprise between 0.01 weight percent to 10 weight percent of the first visible light filtering compound of Formula I, preferably between 0.01 weight percent to 5 weight percent or between 0.01 weight percent to 3 weight percent, most preferably between 0.01 to 1 weight percent, based on the weight percentages of all components in the reactive mixture, excluding diluent. The reactive monomer mixture of the invention may comprise between 0.01 weight percent to 10 weight percent of the second visible light filtering compound of Formula II, preferably between 0.01 weight percent to 5 weight percent or between 0.01 weight percent to 3 weight percent, most preferably between 0.01 to 2 weight percent, based on the weight percentages of all components in the reactive mixture, excluding diluent. The reactive monomer mixture of the invention may comprise between 0.01 weight percent to 10 weight percent of the third visible light filtering compound of Formulae III-VI, preferably between 0.01 weight percent to 7 weight percent or between 0.01 weight percent to 5 weight percent, most preferably between 0.01 to 3 weight percent or between 0.01 to 1 weight percent, based on the weight percentages of all components in the reactive mixture, excluding diluent. Depending on the concentrations of the first, second, and third visible light filtering compounds in the ophthalmic device and the thickness of the ophthalmic device, the absorbance or transmission spectrum of the said device can be modified. Typical thicknesses of ophthalmic devices are from 60 to 300 microns, or from 70 to 250 microns, or from 80 to 200 microns, or from 90 to 110 microns.

For instance, the ophthalmic device of the invention may have a transmittance profile of (a) between 1 percent and 50 percent across a wavelength range of 480 nanometers to 660 nanometers and (b) between 20 percent and 70 percent across a wavelength range of 375 nanometers and 425 nanometers or alternatively (a) between 10 percent and 40 percent across a wavelength range of 480 nanometers to 660 nanometers and (b) between 30 percent and 60 percent across a wavelength range of 375 nanometers and 425 nanometers. In some aspects, the transmittance between 480 nanometers to 660 nanometers varies from an average transmittance by 15 percent or less, by 10 percent or less, by 7.5 percent or less, or by 5 percent or less, wherein the average transmittance is between 20 percent and 40 percent.

Ophthalmic devices of the invention may comprise a free radical reaction product of a reactive mixture containing one or more monomers suitable for making the desired ophthalmic device (also referred to herein as device forming monomers or hydrogel forming monomers), and optional components. When polymerized, the reactive mixture results in formation of a polymeric network of which the ophthalmic device may be comprised. The polymeric network may, for instance, be a hydrogel (e.g., a conventional hydrogel or a silicone hydrogel).

A visible light filtering compound of the invention may be copolymerized with the other components in the reactive mixture, in which case the reactive mixture may, in addition to one or more monomers suitable for making the desired ophthalmic device (and any optional components), also contain one or more of the visible light filtering compounds.

Non-limiting examples of polymeric networks in which the visible light filtering compounds may be incorporated (for instance, as a monomer) are described above and include, for instance, etafilcon, genfilcon, hilafilcon, lenefilcon, nesofilcon, omafilcon, polymacon, vifilcon, acquafilcon, asmofilcon, balafilcon, comfilcon, delefilcon, lehfilcon, serafilcon, enfilcon, fanfilcon, formofilcon, galyfilcon, lotrafilcon, narafilcon, riofilcon, samfilcon, senofilcon, somofilcon, and stenfilcon, including all of their variants.

By way of further example, a polymeric network may be made from a reactive mixture comprising one or more of: hydrophilic components, hydrophobic components, silicone-containing components, wetting agents such as polyamides, crosslinking agents, and further components such as diluents and initiators. As discussed above, the reactive mixture also contains one or more first and second visible light filtering compounds.

### Hydrophilic Components

Examples of suitable families of hydrophilic monomers that may be present in the reactive mixture include (meth)acrylates, styrenes, vinyl ethers, (meth)acrylamides, N-vinyl lactams, N-vinyl amides, N-vinyl imides, N-vinyl ureas, O-vinyl carbamates, O-vinyl carbonates, other hydrophilic vinyl compounds, and mixtures thereof.

Non-limiting examples of hydrophilic (meth)acrylate and (meth)acrylamide monomers include: acrylamide, N-isopropyl acrylamide, N,N-dimethylaminopropyl (meth)acrylamide, N,N-dimethyl acrylamide (DMA), 2-hydroxyethyl methacrylate (HEMA), 2-hydroxypropyl (meth)acrylate, 3-hydroxypropyl (meth)acrylate, 2,3-dihydroxypropyl (meth)acrylate, 2-hydroxybutyl (meth)acrylate, 3-hydroxybutyl (meth)acrylate, 4-hydroxybutyl (meth)acrylate, N-(2-hydroxyethyl) (meth)acrylamide, N,N-bis(2-hydroxyethyl) (meth)acrylamide, N-(2-hydroxypropyl) (meth)acrylamide, N,N-bis(2-hydroxypropyl) (meth)acrylamide, N-(3-hydroxypropyl) (meth)acrylamide, N-(2-hydroxybutyl) (meth)acrylamide, N-(3-hydroxybutyl) (meth)acrylamide, N-(4-hydroxybutyl) (meth)acrylamide, 2-aminocthyl (meth)acrylate, 3-aminopropyl (meth)acrylate, 2-aminopropyl (meth)acrylate, N-2-aminoethyl (meth)acrylamides), N-3-aminopropyl (meth)acrylamide, N-2-aminopropyl (meth)acrylamide, N,N-bis-2-aminoethyl (meth)acrylamides, N,N-bis-3-aminopropyl (meth)acrylamide), N,N-bis-2-aminopropyl (meth)acrylamide, glycerol methacrylate, polyethyleneglycol monomethacrylate, (meth)acrylic acid, vinyl acetate, acrylonitrile, and mixtures thereof.

Hydrophilic monomers may also be ionic, including anionic, cationic, zwitterions, betaines, and mixtures thereof. Non-limiting examples of such charged monomers include (meth)acrylic acid, N-[(ethenyloxy) carbonyl]-β-alanine (VINAL), 3-acrylamidopropanoic acid (ACA1), 5-acrylamidopentanoic acid (ACA2), 3-acrylamido-3-methylbutanoic acid (AMBA), 2-(methacryloyloxy)ethyl trimethylammonium chloride (Q Salt or METAC), 2-acrylamido-2-methylpropane sulfonic acid (AMPS), 1-propanaminium, N-(2-carboxyethyl)-N,N-dimethyl-3-[(1-oxo-2-propen-1-yl)amino]-, inner salt (CBT), 1-propanaminium, N,N-dimethyl-N-[3-[(1-oxo-2-propen-1-yl)amino]propyl]-3-sulfo-, inner salt (SBT), 3,5-Dioxa-8-aza-4-phosphaundec-10-en-1-aminium, 4-hydroxy-N,N,N-trimethyl-9-oxo-, inner salt, 4-oxide (9CI) (PBT), 2-methacryloyloxyethyl phosphorylcholine, 3-(dimethyl (4-vinylbenzyl) ammonio) propane-1-sulfonate (DMVBAPS), 3-((3-acrylamidopropyl)dimethylammonio) propane-1-sulfonate (AMPDAPS), 3-((3-methacrylamidopropyl)dimethylammonio) propane-1-sulfonate (MAMPDAPS), 3-((3-(acryloyloxy) propyl)dimethylammonio) propane-1-sulfonate (APDAPS), and methacryloyloxy) propyl)dimethylammonio) propane-1-sulfonate (MAPDAPS).

Non-limiting examples of hydrophilic N-vinyl lactam and N-vinyl amide monomers include: N-vinyl pyrrolidone (NVP), N-vinyl-2-piperidone, N-vinyl-2-caprolactam, N-vinyl-3-methyl-2-caprolactam, N-vinyl-3-methyl-2-piperidone, N-vinyl-4-methyl-2-piperidone, N-vinyl-4-methyl-2-caprolactam, N-vinyl-3-ethyl-2-pyrrolidone, N-vinyl-4,5-dimethyl-2-pyrrolidone, N-vinyl acetamide (NVA), N-vinyl-N-methylacetamide (VMA), N-vinyl-N-ethyl acetamide, N-vinyl-N-ethyl formamide, N-vinyl formamide, N-vinyl-N-methylpropionamide, N-vinyl-N-methyl-2-methylpropionamide, N-vinyl-2-methylpropionamide, N-vinyl-N,N′-dimethylurea, 1-methyl-3-methylene-2-pyrrolidone, 1-methyl-5-methylene-2-pyrrolidone, 5-methyl-3-methylene-2-pyrrolidone; 1-ethyl-5-methylene-2-pyrrolidone, N-methyl-3-methylene-2-pyrrolidone, 5-ethyl-3-methylene-2-pyrrolidone, 1-N-propyl-3-methylene-2-pyrrolidone, 1-N-propyl-5-methylene-2-pyrrolidone, 1-isopropyl-3-methylene-2-pyrrolidone, 1-isopropyl-5-methylene-2-pyrrolidone, N-vinyl-N-ethyl acetamide, N-vinyl-N-ethyl formamide, N-vinyl formamide, N-vinyl isopropylamide, N-vinyl caprolactam, N-vinylimidazole, and mixtures thereof

Non-limiting examples of hydrophilic O-vinyl carbamates and O-vinyl carbonates monomers include N-2-hydroxyethyl vinyl carbamate and N-carboxy-β-alanine N-vinyl ester. Further examples of hydrophilic vinyl carbonate or vinyl carbamate monomers are disclosed in U.S. Pat. No. 5,070,215. Hydrophilic oxazolone monomers are disclosed in U.S. Pat. No. 4,910,277.

Other hydrophilic vinyl compounds include ethylene glycol vinyl ether (EGVE), di(ethylene glycol) vinyl ether (DEGVE), allyl alcohol, and 2-ethyl oxazoline.

The hydrophilic monomers may also be macromers or prepolymers of linear or branched poly(ethylene glycol), poly(propylene glycol), or statistically random or block copolymers of ethylene oxide and propylene oxide, having polymerizable moieties such as (meth)acrylates, styrenes, vinyl ethers, (meth)acrylamides, N-vinylamides, and the like. The macromers of these polyethers have one polymerizable group; the prepolymers may have two or more polymerizable groups.

The preferred hydrophilic monomers of the present invention are DMA, NVP, HEMA, VMA, NVA, and mixtures thereof. Preferred hydrophilic monomers include mixtures of DMA and HEMA. Other suitable hydrophilic monomers will be apparent to one skilled in the art.

Generally, there are no particular restrictions with respect to the amount of the hydrophilic monomer present in the reactive monomer mixture. The amount of the hydrophilic monomers may be selected based upon the desired characteristics of the resulting hydrogel, including water content, clarity, wettability, protein uptake, and the like. Wettability may be measured by contact angle, and desirable contact angles are less than about 100°, less than about 80°, and less than about 60°. The hydrophilic monomer may be present in an amount in the range of, for instance, about 0.1 to about 100 weight percent, alternatively in the range of about 1 to about 80 weight percent, alternatively about 5 to about 65 weight percent, alternatively in the range of about 40 to about 60 weight percent, or alternatively about 55 to about 60 weight percent, based on the total weight of the reactive components in the reactive monomer mixture.

### Silicone-Containing Components

Silicone-containing components suitable for use in the invention comprise one or more polymerizable compounds, where each compound independently comprises at least one polymerizable group, at least one siloxane group, and one or more linking groups connecting the polymerizable group(s) to the siloxane group(s). The silicone-containing components may, for instance, contain from 1 to 220 siloxane repeat units, such as the groups defined below. The silicone-containing component may also contain at least one fluorine atom.

The silicone-containing component may comprise: one or more polymerizable groups as defined above; one or more optionally repeating siloxane units; and one or more linking groups connecting the polymerizable groups to the siloxane units. The silicone-containing component may comprise: one or more polymerizable groups that are independently a (meth)acrylate, a styryl, a vinyl ether, a (meth)acrylamide, an N-vinyl lactam, an N-vinylamide, an O-vinylcarbamate, an O-vinylcarbonate, a vinyl group, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, an N-vinyl lactam, an N-vinylamide, a styryl, or mixtures of the foregoing; one or more optionally repeating siloxane units; and one or more linking groups connecting the polymerizable groups to the siloxane units.

The silicone-containing component may comprise: one or more polymerizable groups that are independently a (meth)acrylate, a (meth)acrylamide, or mixtures of the foregoing; one or more optionally repeating siloxane units; and one or more linking groups connecting the polymerizable groups to the siloxane units.

The silicone-containing component may comprise one or more polymerizable compounds of Formula A:

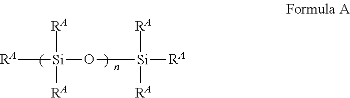

wherein: at least one RA is a group of formula P_{g}-L- wherein P_{g} is a polymerizable group and Lis a linking group, and the remaining RA are each independently: P_{g}-L-, C₁-C₁₆ alkyl optionally substituted with one or more hydroxy, amino, amido, oxa, carboxy, alkyl carboxy, carbonyl, alkoxy, amido, carbamate, carbonate, halo, phenyl, benzyl, or combinations thereof, C₃-C₁₂ cycloalkyl optionally substituted with one or more alkyl, hydroxy, amino, amido, oxa, carbonyl, alkoxy, amido, carbamate, carbonate, halo, phenyl, benzyl, or combinations thereof, a C₆-C₁₄ aryl group optionally substituted with one or more alkyl, hydroxy, amino, amido, oxa, carboxy, alkyl carboxy, carbonyl, alkoxy, amido, carbamate, carbonate, halo, phenyl, benzyl, or combinations thereof, halo, alkoxy, cyclic alkoxy, or aryloxy, siloxy, alkyleneoxy-alkyl or alkoxy-alkyleneoxy-alkyl, such as polyethyleneoxyalkyl, polypropyleneoxyalkyl, or poly(ethyleneoxy-co-propyleneoxyalkyl), or a monovalent siloxane chain comprising from 1 to 100 siloxane repeat units optionally substituted with alkyl, alkoxy, hydroxy, amino, oxa, carboxy, alkyl carboxy, alkoxy, amido, carbamate, halo or combinations thereof; and n is from 0 to 500 or from 0 to 200, or from 0 to 100, or from 0 to 20, where it is understood that when n is other than 0, n is a distribution having a mode equal to a stated value. When n is 2 or more, the SiO units may carry the same or different RA substituents and if different RA substituents are present, the n groups may be in random or block configuration.

In Formula A, three RA may each comprise a polymerizable group, alternatively two RA may each comprise a polymerizable group, or alternatively one RA may comprise a polymerizable group.

Examples of silicone-containing components suitable for use in the invention include, but are not limited to, compounds listed in Table D. Where the compounds in Table D contain polysiloxane groups, the number of SiO repeat units in such compounds, unless otherwise indicated, is preferably from 3 to 100, more preferably from 3 to 40, or still more preferably from 3 to 20.

TABLE D

| | |
|---|---|
| 1 | mono-methacryloxypropyl terminated mono-n-butyl terminated polydimethylsiloxanes |
| | (mPDMS) (preferably containing from 3 to 15 SiO repeating units) |
| 2 | mono-acryloxypropyl terminated mono-n-butyl terminated polydimethylsiloxane |
| 3 | mono(meth)acryloxypropyl terminated mono-n-methyl terminated polydimethylsiloxane |
| 4 | mono(meth)acryloxypropyl terminated mono-n-butyl terminated polydiethylsiloxane |
| 5 | mono(meth)acryloxypropyl terminated mono-n-methyl terminated polydiethylsiloxane |
| 6 | mono(meth)acrylamidoalkylpolydialkylsiloxanes |
| 7 | mono(meth)acryloxyalkyl terminated mono-alkyl polydiarylsiloxanes |
| 8 | 3-methacryloxypropyltris(trimethylsiloxy)silane (TRIS) |
| 9 | 3-methacryloxypropylbis(trimethylsiloxy)methylsilane |
| 10 | 3-methacryloxypropylpentamethyl disiloxane |
| 11 | mono(meth)acrylamidoalkylpolydialkylsiloxanes |
| 12 | mono(meth)acrylamidoalkyl polydimethylsiloxanes |
| 13 | N-(2,3-dihydroxypropane)-N′-(propyl tetra(dimethylsiloxy) |
| | dimethylbutylsilane)acrylamide |
| 14 | N-[3-tris(trimethylsiloxy)silyl]-propyl acrylamide (TRIS-Am) |
| 15 | 2-hydroxy-3-[3-methyl-3,3-di(trimethylsiloxy)silylpropoxy]-propyl methacrylate |
| | (SiMAA) |
| 16 | 2-hydroxy-3-methacryloxypropyloxypropyl-tris(trimethylsiloxy)silane |
| 17 | 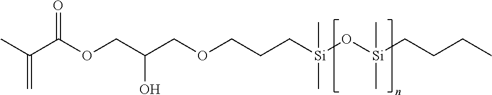 |
| | mono-(2-hydroxy-3-methacryloxypropyloxy)-propyl terminated mono-n-butyl |
| | terminated polydimethylsiloxanes (OH—mPDMS) (containing from 4 to 30, or from 4 to |
| | 20, or from 4 to 15 SiO repeat units) |
| 18 | 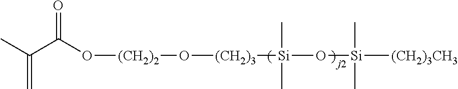 |
| 19 | 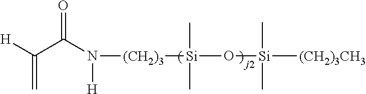 |
| 20 | 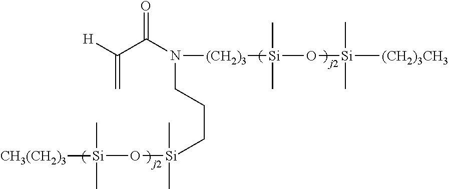 |
| 21 | 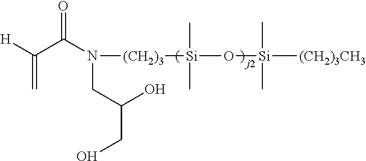 |
| 22 | 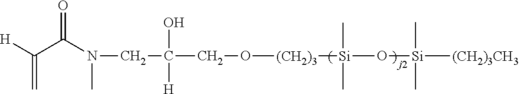 |
| 23 | 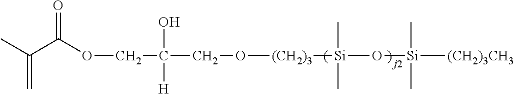 |
| 24 | 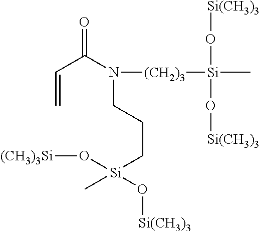 |

Additional non-limiting examples of suitable silicone-containing components are listed in Table E. Unless otherwise indicated, j2 where applicable is preferably from 1 to 100, more preferably from 3 to 40, or still more preferably from 3 to 15. In compounds containing j1 and j2, the sum of j1 and j2 is preferably from 2 to 100, more preferably from 3 to 40, or still more preferably from 3 to 15.

TABLE E

| | |
|---|---|
| 25 | 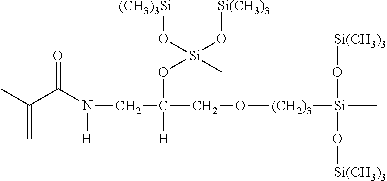 |
| 26 | 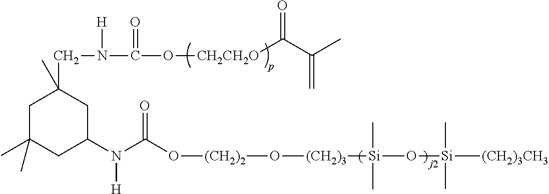 |
| | p is 1 to 10 |
| 27 | 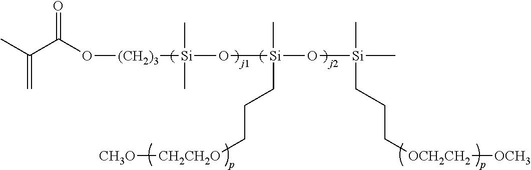 |
| | p is 5-10 |
| 28 | 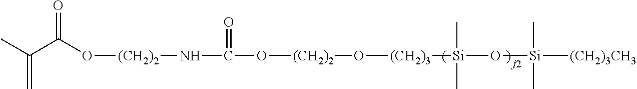 |
| 29 | 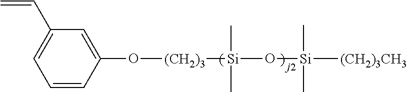 |
| 30 | 1,3-bis[4-(vinyloxycarbonyloxy)but-1-yl]tetramethyl-disiloxane |
| 31 | 3-(vinyloxycarbonylthio) propyl-[tris (trimethylsiloxy)silane] |
| 32 | 3-[tris(trimethylsiloxy)silyl] propyl allyl carbamate |
| 33 | 3-[tris(trimethylsiloxy)silyl] propyl vinyl carbamate |
| 34 | tris(trimethylsiloxy)silylstyrene (Styryl-TRIS) |
| 35 | 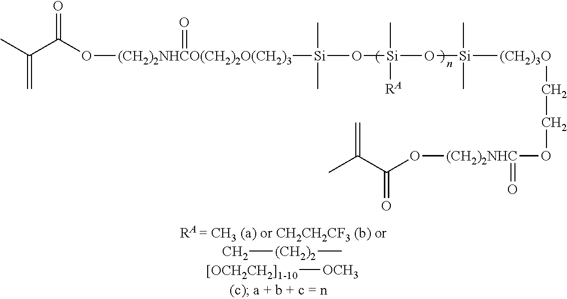 |
| 36 | 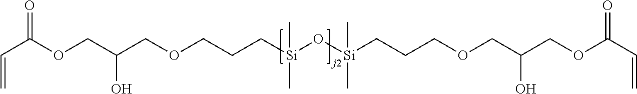 |
| 37 | 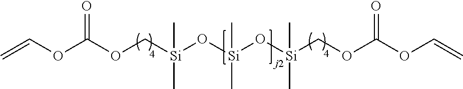 |
| 38 | 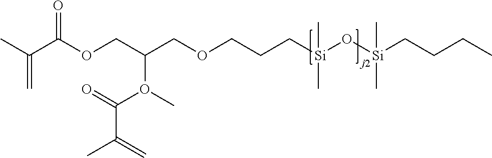 |
| 39 | 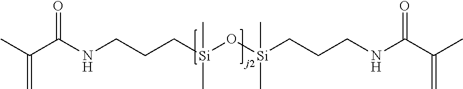 |
| 40 | 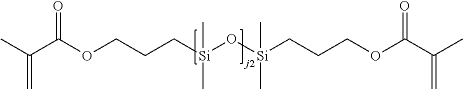 |
| 41 | 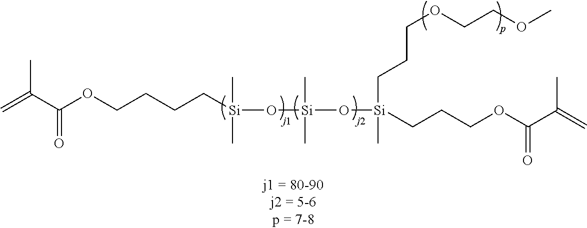 |
| 42 | 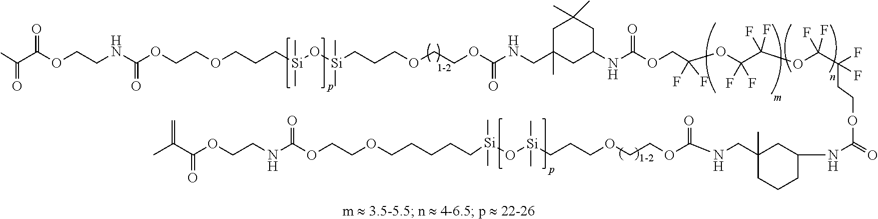 |
| 43 | 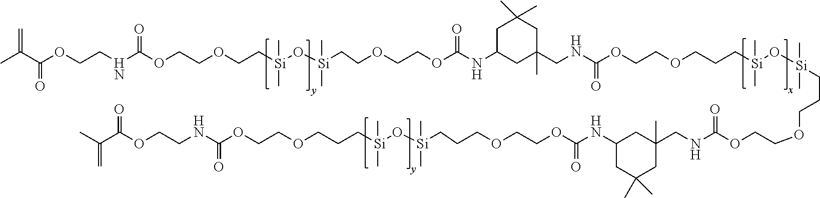 |
| | IEM-PDMS(Mn ≈ 3000)-IPDI-PDMS(Mn ≈ 2000)-IPDI-PDMS(Mn ≈ 3000)-IEM (see WO2016100457) |

Mixtures of silicone-containing components may be used. By way of example, suitable mixtures may include, but are not limited to: a mixture of mono-(2-hydroxy-3-methacryloxypropyloxy)-propyl terminated mono-n-butyl terminated polydimethylsiloxane (OH-mPDMS) having different molecular weights, such as a mixture of OH-mPDMS containing 4 and 15 SiO repeat units; a mixture of OH-mPDMS with different molecular weights (e.g., containing 4 and 15 repeat SiO repeat units) together with a silicone based crosslinker, such as bis-3-acryloxy-2-hydroxypropyloxypropyl polydimethylsiloxane (ac-PDMS); a mixture of 2-hydroxy-3-[3-methyl-3,3-di(trimethylsiloxy) silylpropoxy]-propyl methacrylate (SiMAA) and mono-methacryloxypropyl terminated mono-n-butyl terminated polydimethylsiloxane (mPDMS), such as mPDMS 1000.

Silicone-containing components for use in the invention may have an average molecular weight of from about 400 to about 4000 daltons.

The silicone containing component(s) may be present in amounts up to about 95 weight percent, or from about 10 to about 80 weight percent, or from about 20 to about 70 weight percent, based upon all reactive components of the reactive mixture (excluding diluents).

### Polyamides

The reactive mixture may include at least one polyamide. As used herein, the term “polyamide” refers to polymers and copolymers comprising repeating units containing amide groups. The polyamide may comprise cyclic amide groups, acyclic amide groups and combinations thereof and may be any polyamide known to those of skill in the art. Acyclic polyamides comprise pendant acyclic amide groups and are capable of association with hydroxyl groups. Cyclic polyamides comprise cyclic amide groups and are capable of association with hydroxyl groups.

Examples of suitable acyclic polyamides include polymers and copolymers comprising repeating units of Formulae B1 and B2:

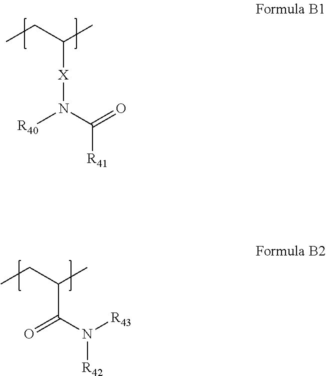

wherein X is a direct bond, —(CO)—, or —(CONHR₄₄)—, wherein R₄₄ is a C₁ to C₃ alkyl group; R₄₀ is selected from H, straight or branched, substituted or unsubstituted C₁ to C₄ alkyl groups; R₄₁ is selected from H, straight or branched, substituted or unsubstituted C₁ to C₄ alkyl groups, amino groups having up to two carbon atoms, amide groups having up to four carbon atoms, and alkoxy groups having up to two carbon groups; R₄₂ is selected from H, straight or branched, substituted or unsubstituted C₁ to C₄ alkyl groups; or methyl, ethoxy, hydroxyethyl, and hydroxymethyl; R₄₃ is selected from H, straight or branched, substituted or unsubstituted C₁ to C₄ alkyl groups; or methyl, ethoxy, hydroxyethyl, and hydroxymethyl; wherein the number of carbon atoms in R₄₀ and R₄₁ taken together is 8 or less, including 7, 6, 5, 4, 3, or less; and wherein the number of carbon atoms in R₄₂ and R₄₃ taken together is 8 or less, including 7, 6, 5, 4, 3, or less. The number of carbon atoms in R₄₀ and R₄₁ taken together may be 6 or less or 4 or less. The number of carbon atoms in R₄₂ and R₄₃ taken together may be 6 or less. As used herein substituted alkyl groups include alkyl groups substituted with an amine, amide, ether, hydroxyl, carbonyl or carboxy groups or combinations thereof.

R₄₀ and R₄₁ may be independently selected from H, substituted or unsubstituted C₁ to C₂ alkyl groups. X may be a direct bond, and R₄₀ and R₄₁ may be independently selected from H, substituted or unsubstituted C₁ to C₂ alkyl groups. R₄₂ and R₄₃ can be independently selected from H, substituted or unsubstituted C₁ to C₂ alkyl groups, methyl, ethoxy, hydroxyethyl, and hydroxymethyl.

The acyclic polyamides of the present invention may comprise a majority of the repeating units of formulae B1 or B2, or the acyclic polyamides can comprise at least 50 mole percent of the repeating unit of formulae B1 or B2, including at least 70 mole percent, and at least 80 mole percent. Specific examples of repeating units of formulae B1 and B2 include repeating units derived from the following monomers: N-vinyl-N-methylacetamide, N-vinylacetamide, N-vinyl-N-methylpropionamide, N-vinyl-N-methyl-2-methylpropionamide, N-vinyl-2-methyl-propionamide, N-vinyl-N,N′-dimethylurea, N, N-dimethylacrylamide, and methacrylamide as well as the acyclic amide monomers of Formulae B3 and B4:

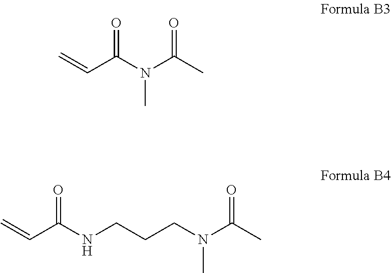

Examples of suitable cyclic amides that can be used to form the cyclic polyamides of include α-lactam, β-lactam, γ-lactam, δ-lactam, and ε-lactam. Examples of suitable cyclic polyamides include polymers and copolymers comprising repeating units of Formula B5:

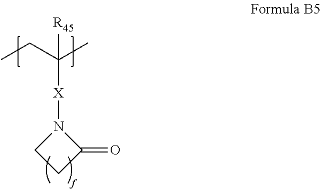

wherein R₄₅ is a hydrogen atom or methyl group; wherein f is a number from 1 to 10; wherein X is a direct bond, —(CO)—, or —(CONHR₄₆)—, wherein R₄₆ is a C₁ to C₃ alkyl group. In Formula LIX, f may be 8 or less, including 7, 6, 5, 4, 3, 2, or 1. In Formula G4, f may be 6 or less, including 5, 4, 3, 2, or 1. In Formula G4, f may be from 2 to 8, including 2, 3, 4, 5, 6, 7, or 8. In Formula LIX, f may be 2 or 3. When X is a direct bond, f may be 2. In such instances, the cyclic polyamide may be polyvinylpyrrolidone (PVP).

The cyclic polyamides of the present invention may comprise 50 mole percent or more of the repeating unit of Formula B5, or the cyclic polyamides can comprise at least 50 mole percent of the repeating unit of Formula B5, including at least 70 mole percent, and at least 80 mole percent.

The polyamides may also be copolymers comprising repeating units of both cyclic and acyclic amides. Additional repeating units may be formed from monomers selected from hydroxyalkyl (meth)acrylates, alkyl (meth)acrylates, other hydrophilic monomers and siloxane substituted (meth)acrylates. Any of the monomers listed as suitable hydrophilic monomers may be used as co-monomers to form the additional repeating units. Specific examples of additional monomers which may be used to form polyamides include 2-hydroxyethyl (meth)acrylate, vinyl acetate, acrylonitrile, hydroxypropyl (meth)acrylate, methyl (meth)acrylate and hydroxybutyl (meth)acrylate, dihydroxypropyl (meth)acrylate, polyethylene glycol mono(meth)acrylate, and the like and mixtures thereof. Ionic monomers may also be included. Examples of ionic monomers include (meth)acrylic acid, N-[(ethenyloxy) carbonyl]-β-alanine (VINAL, CAS #148969-96-4), 3-acrylamidopropanoic acid (ACA1), 5-acrylamidopentanoic acid (ACA2), 3-acrylamido-3-methylbutanoic acid (AMBA), 2-(methacryloyloxy)ethyl trimethylammonium chloride (Q Salt or METAC), 2-acrylamido-2-methylpropane sulfonic acid (AMPS), 1-propanaminium, N-(2-carboxyethyl)-N,N-dimethyl-3-[(1-oxo-2-propen-1-yl)amino]-, inner salt (CBT, carboxybetaine; CAS 79704-35-1), 1-propanaminium, N,N-dimethyl-N-[3-[(1-oxo-2-propen-1-yl)amino]propyl]-3-sulfo-, inner salt (SBT, sulfobetaine, CAS 80293-60-3), 3,5-Dioxa-8-aza-4-phosphaundec-10-en-1-aminium, 4-hydroxy-N,N,N-trimethyl-9-oxo-, inner salt, 4-oxide (9CI) (PBT, phosphobetaine, CAS 163674-35-9,2-methacryloyloxyethyl phosphorylcholine, 3-(dimethyl (4-vinylbenzyl) ammonio) propane-1-sulfonate (DMVBAPS), 3-((3-acrylamidopropyl)dimethylammonio) propane-1-sulfonate (AMPDAPS), 3-((3-methacrylamidopropyl)dimethylammonio) propane-1-sulfonate (MAMPDAPS), 3-((3-(acryloyloxy) propyl)dimethylammonio) propane-1-sulfonate (APDAPS), methacryloyloxy) propyl)dimethylammonio) propane-1-sulfonate (MAPDAPS).

The reactive monomer mixture may comprise both an acyclic polyamide and a cyclic polyamide or copolymers thereof. The acyclic polyamide can be any of those acyclic polyamides described herein or copolymers thereof, and the cyclic polyamide can be any of those cyclic polyamides described herein or copolymers thereof. The polyamide may be selected from the group polyvinylpyrrolidone (PVP), polyvinylmethyacetamide (PVMA), polydimethylacrylamide (PDMA), polyvinylacetamide (PNVA), poly(hydroxyethyl (meth)acrylamide), polyacrylamide, and copolymers and mixtures thereof. The polyamide may be a mixture of PVP (e.g., PVP K90) and PVMA (e.g., having a Mw of about 570 kDa).

The total amount of all polyamides in the reactive mixture may be in the range of between 1 weight percent and about 35 weight percent, including in the range of about 1 weight percent to about 15 weight percent, and in the range of about 5 weight percent to about 15 weight percent, in all cases, based on the total weight of the reactive components of the reactive monomer mixture, excluding diluents.

Without intending to be bound by theory, when used with a silicone hydrogel, the polyamide functions as an internal wetting agent. The polyamides of the present invention may be non-polymerizable, and in this case, are incorporated into the silicone hydrogels as semi-interpenetrating networks. The polyamides are entrapped or physically retained within the silicone hydrogels. Alternatively, the polyamides of the present invention may be polymerizable, for example as polyamide macromers or prepolymers, and in this case, are covalently incorporated into the silicone hydrogels. Mixtures of polymerizable and non-polymerizable polyamides may also be used.

When the polyamides are incorporated into the reactive monomer mixture, they may have a weight average molecular weight of at least 100,000 daltons; greater than about 150,000; between about 150,000 to about 2,000,000 daltons; between about 300,000 to about 1,800,000 daltons. Higher molecular weight polyamides may be used if they are compatible with the reactive monomer mixture.

### Cross-Linking Agents (Crosslinkers)

It is generally desirable to add one or more cross-linking agents, also referred to as cross-linking monomers, multi-functional macromers, and prepolymers, to the reactive mixture. The cross-linking agents may be selected from bifunctional crosslinkers, trifunctional crosslinkers, tetrafunctional crosslinkers, and mixtures thereof, including silicone-containing and non-silicone containing cross-linking agents. Non-silicone-containing cross-linking agents include ethylene glycol dimethacrylate (EGDMA), tetraethylene glycol dimethacrylate (TEGDMA), trimethylolpropane trimethacrylate (TMPTMA), triallyl cyanurate (TAC), glycerol trimethacrylate, methacryloxyethyl vinylcarbonate (HEMAVc), allylmethacrylate, methylene bisacrylamide (MBA), and polyethylene glycol dimethacrylate wherein the polyethylene glycol has a molecular weight up to about 5000 Daltons. The cross-linking agents are used in the usual amounts, e.g., from about 0.000415 to about 0.0156 mole per 100 grams of reactive Formulas in the reactive mixture. Alternatively, if the hydrophilic monomers and/or the silicone-containing components are multifunctional by molecular design or because of impurities, the addition of a cross-linking agent to the reactive mixture is optional. Examples of hydrophilic monomers and macromers which can act as the cross-linking agents and when present do not require the addition of an additional cross-linking agent to the reactive mixture include (meth)acrylate and (meth)acrylamide endcapped polyethers. Other cross-linking agents will be known to one skilled in the art and may be used to make the silicone hydrogel of the present invention.

It may be desirable to select crosslinking agents with similar reactivity to one or more of the other reactive components in the formulation. In some cases, it may be desirable to select a mixture of crosslinking agents with different reactivity in order to control some physical, mechanical or biological property of the resulting silicone hydrogel. The structure and morphology of the silicone hydrogel may also be influenced by the diluent(s) and cure conditions used.

Multifunctional silicone-containing components, including macromers, cross-linking agents, and prepolymers, may also be included to further increase the modulus and retain tensile strength. The silicone containing cross-linking agents may be used alone or in combination with other cross-linking agents. An example of a silicone containing component which can act as a cross-linking agent and, when present, does not require the addition of a crosslinking monomer to the reactive mixture includes a, w-bismethacryloxypropyl polydimethylsiloxane. Another example is bis-3-acryloxy-2-hydroxypropyloxypropyl polydimethylsiloxane (ac-PDMS).

Cross-linking agents that have rigid chemical structures and polymerizable groups that undergo free radical polymerization may also be used. Non-limiting examples of suitable rigid structures include cross-linking agents comprising phenyl and benzyl ring, such are 1,4-phenylene diacrylate, 1,4-phenylene dimethacrylate, 2,2-bis(4-methacryloxyphenyl)-propane, 2,2-bis [4-(2-acryloxyethoxy)phenyl]propanc, 2,2-bis [4-(2-hydroxy-3-methacryloxypropoxy)-phenyl]propane, and 4-vinylbenzyl methacrylate, and combinations thereof. Rigid crosslinking agents may be included in amounts between about 0.5 and about 15, or 2-10, 3-7 based upon the total weight of all of the reactive components. The physical and mechanical properties of the silicone hydrogels of the present invention may be optimized for a particular use by adjusting the components in the reactive mixture.

Non-limiting examples of silicone cross-linking agents also include the multi-functional silicone-containing components listed in Table C.

### Further Constituents

The reactive mixture may contain additional components such as, but not limited to, diluents, initiators, UV absorbers, visible light absorbers, photochromic compounds, pharmaceuticals, nutraceuticals, antimicrobial substances, tints, pigments, co-polymerizable dyes, nonpolymerizable dyes, release agents, visibility tints, and combinations thereof.

Classes of suitable diluents for silicone hydrogel reactive mixtures include alcohols having 2 to 20 carbon atoms, amides having 10 to 20 carbon atoms derived from primary amines and carboxylic acids having 8 to 20 carbon atoms. The diluents may be primary, secondary, and tertiary alcohols.

Generally, the reactive components are mixed in a diluent to form a reactive mixture. Suitable diluents are known in the art. For silicone hydrogels, suitable diluents are disclosed in WO 03/022321 and U.S. Pat. No. 6,020,445, the disclosure of which is incorporated herein by reference.

Classes of suitable diluents for silicone hydrogel reactive mixtures include alcohols having 2 to 20 carbons, amides having 10 to 20 carbon atoms derived from primary amines, and carboxylic acids having 8 to 20 carbon atoms. Primary and tertiary alcohols may be used. Preferred classes include alcohols having 5 to 20 carbons and carboxylic acids having 10 to 20 carbon atoms.

Specific diluents which may be used include 1-ethoxy-2-propanol, diisopropylaminocthanol, isopropanol, 3,7-dimethyl-3-octanol, 1-decanol, 1-dodecanol, 1-octanol, 1-pentanol, 2-pentanol, 1-hexanol, 2-hexanol, 2-octanol, 3-methyl-3-pentanol, tert-amyl alcohol, tert-butanol, 2-butanol, 1-butanol, 2-methyl-2-pentanol, 2-propanol, 1-propanol, ethanol, 2-ethyl-1-butanol, (3-acetoxy-2-hydroxypropyloxy)-propylbis(trimethylsiloxy)methylsilane, 1-tert-butoxy-2-propanol, 3,3-dimethyl-2-butanol, t 2-octyl-1-dodecanol, decanoic acid, octanoic acid, dodecanoic acid, 2-(diisopropylamino) ethanol mixtures thereof and the like. Examples of amide diluents include N,N-dimethyl propionamide and dimethyl acetamide.

Preferred diluents include 3,7-dimethyl-3-octanol, 1-dodecanol, 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, 2-octyl-1-dodecanol, decanoic acid, octanoic acid, dodecanoic acid, mixtures thereof and the like.

More preferred diluents include 3,7-dimethyl-3-octanol, 1-dodecanol, 1-decanol, 1-octanol, 1-pentanol, 1-hexanol, 2-hexanol, 2-octanol, 1-dodecanol, 3-methyl-3-pentanol, 1-pentanol, 2-pentanol, t-amyl alcohol, tert-butanol, 2-butanol, 1-butanol, 2-methyl-2-pentanol, 2-ethyl-1-butanol, 3,3-dimethyl-2-butanol, 2-octyl-1-dodecanol, mixtures thereof and the like.

If a diluent is present, generally there are no particular restrictions with respect to the amount of diluent present. When diluent is used, the diluent may be present in an amount in the range of about 2 to about 70 weight percent, including in the range of about 5 to about 50 weight percent, and in the range of about 15 to about 40 weight percent, based on the total weight of the reactive mixtures (including reactive and nonreactive Formulas). Mixtures of diluents may be used.

A polymerization initiator may be used in the reactive mixture. The polymerization initiator may include, for instance, at least one of lauroyl peroxide, benzoyl peroxide, iso-propyl percarbonate, azobisisobutyronitrile, and the like, that generate free radicals at moderately elevated temperatures, and photoinitiator systems such as aromatic alpha-hydroxy ketones, alkoxyoxybenzoins, acetophenones, acylphosphine oxides, bisacylphosphine oxides, and a tertiary amine plus a diketone, mixtures thereof and the like. Illustrative examples of photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenyl phosphine oxide (Irgacure 819), 2,4,6-trimethylbenzyldiphenyl phos-phine oxide and 2,4,6-trimethylbenzoyl diphenylphosphine oxide, benzoin methyl ester and a combination of cam-phorquinone and ethyl 4-(N,N-dimethylamino)benzoate.

Commercially available (from IGM Resins B.V., The Netherlands) visible light initiator systems include Irgacure® 819, Irgacure® 1700, Irgacure® 1800, Irgacure® 819, Irgacure® 1850 and Lucrin® TPO initiator. Commercially available (from IGM Resins B.V.) UV photoinitiators include Darocur® 1173 and Darocur® 2959. These and other photoinitiators which may be used are disclosed in Volume III, Photoinitiators for Free Radical Cationic & Anionic Photopolymerization, 2nd Edition by J. V. Crivello & K. Dietliker; edited by G. Bradley; John Wiley and Sons; New York; 1998. The initiator is used in the reactive mixture in effective amounts to initiate photopolymerization of the reactive mixture, e.g., from about 0.1 to about 2 parts by weight per 100 parts of reactive monomer mixture. Polymerization of the reactive mixture can be initiated using the appropriate choice of heat or visible or ultraviolet light or other means depending on the polymerization initiator used. Alternatively, initiation can be conducted using e-beam without a photoinitiator. However, when a photoinitiator is used, the preferred initiators are bisacylphosphine oxides, such as bis(2,4,6-tri-methylbenzoyl)-phenyl phosphine oxide (Irgacure® 819) or a combination of 1-hydroxycyclohexyl phenyl ketone and bis(2,6-dimethoxybenzoyl)-2,4-4-trimethylpentyl phosphine oxide (DMBAPO). Thermally initiated polymerization may be carried out, for instance, as described in US20200399429, which is incorporated herein by reference in its entirety. A combination of photocuring and thermal curing may be used.

The reactive mixture for making the ophthalmic devices of the invention may comprise, in addition to first, second, and optional third visible light filtering compounds, any of the polymerizable compounds and optional components described above.

The reactive mixture may comprise: first, second, and optional third visible light filtering compounds, and a hydrophilic component.

The reactive mixture may comprise: first, second, and optional visible light filtering compounds, and a hydrophilic component selected from DMA, NVP, HEMA, VMA, NVA, methacrylic acid, and mixtures thereof. Preferred are mixtures of HEMA and methacrylic acid.

The reactive mixture may comprise: first, second, and optional third visible light filtering compounds, a hydrophilic component, and a silicone-containing component.

The reactive mixture may comprise: first, second, and optional third visible light filtering compounds, a hydrophilic component selected from DMA, HEMA and mixtures thereof; a silicone-containing component selected from 2-hydroxy-3-[3-methyl-3,3-di(trimethylsiloxy) silylpropoxy]-propyl methacrylate (SiMAA), mono-methacryloxypropyl terminated mono-n-butyl terminated polydimethylsiloxane (mPDMS), mono-(2-hydroxy-3-methacryloxypropyl)-propyl ether terminated mono-n-butyl terminated polydimethylsiloxane (OH-mPDMS), and mixtures thereof; and a wetting agent (preferably PVP or PVMA). For the hydrophilic component, mixtures of DMA and HEMA are preferred. For the silicone containing component, mixtures of SiMAA and mPDMS are preferred.

The reactive mixture may comprise: first, second, and optional third visible light filtering compounds, a hydrophilic component comprising a mixture of DMA and HEMA; a silicone-containing component comprising a mixture of OH-mPDMS having from 2 to 20 repeat units (preferably a mixture of 4 and 15 repeat units). Preferably, the reactive mixture further comprises a silicone-containing crosslinker, such as ac-PDMS. Also preferably, the reactive mixture contains a wetting agent (preferably DMA, PVP, PVMA or mixtures thereof).

The reactive mixture may comprise: first, second, and optional third visible light filtering compounds; between about 1 and about 15 weight percent of at least one polyamide (e.g., an acyclic polyamide, a cyclic polyamide, or mixtures thereof); at least one first mono-functional, hydroxyl substituted poly(disubstituted siloxane) having 4 to 8 siloxane repeating units (e.g., OH-mPDMS where n is 4 to 8, preferably n is 4); at least one second hydroxyl substituted poly(disubstituted siloxane) that is a mono-functional hydroxyl substituted poly(disubstituted siloxane) s having 10 to 200 or 10-100 or 10-50 or 10-20 siloxane repeating units (e.g., OH-mPDMS where n is 10 to 200 or 10-100 or 10-50 or 10-20, preferably n is 15); about 5 to about 35 wt % of at least one hydrophilic monomer; and optionally a multifunctional hydroxyl substituted poly(disubstituted siloxane) s having 10 to 200, or 10 to 100 siloxane repeating units (e.g., ac-PDMS). Preferably, the first mono-functional, hydroxyl substituted poly(disubstituted siloxane) and the second hydroxyl substituted poly(disubstituted siloxane) are present in concentrations to provide a ratio of weight percent of the first mono-functional, hydroxyl substituted poly(disubstituted siloxane) to weight percent of the second hydroxyl substituted poly(disubstituted siloxane) of 0.4-1.3, or 0.4-1.0.

The foregoing reactive mixtures may contain optional ingredients such as, but not limited to, one or more initiators, internal wetting agents, crosslinkers, other UV or HEV absorbers, and diluents.

### Curing of Hydrogels and Manufacture of Lens

The reactive mixtures may be formed by any of the methods known in the art, such as shaking or stirring, and used to form polymeric articles or devices by known methods. The reactive components are mixed together either with or without a diluent to form the reactive mixture.

For example, ophthalmic devices may be prepared by mixing reactive components, and, optionally, diluent(s), with a polymerization initiator and curing by appropriate conditions to form a product that can be subsequently formed into the appropriate shape by lathing, cutting, and the like. Alternatively, the reactive mixture may be placed in a mold and subsequently cured into the appropriate article.

A method of making a molded ophthalmic device, such as a silicone hydrogel contact lens, may comprise: preparing a reactive monomer mixture; transferring the reactive monomer mixture onto a first mold; placing a second mold on top the first mold filled with the reactive monomer mixture; and curing the reactive monomer mixture by free radical copolymerization to form the silicone hydrogel in the shape of a contact lens.

The reactive mixture may be cured via any known process for molding the reactive mixture in the production of contact lenses, including spin casting and static casting. Spin casting methods are disclosed in U.S. Pat. Nos. 3,408,429 and 3,660,545, and static casting methods are disclosed in U.S. Pat. Nos. 4,113,224 and 4,197,266. The contact lenses of this invention may be formed by the direct molding of the hydrogels, which is economical, and enables precise control over the final shape of the hydrated lens. For this method, the reactive mixture is placed in a mold having the shape of the final desired hydrogel and the reactive mixture is subjected to conditions whereby the monomers polymerize, thereby producing a polymer in the approximate shape of the final desired product.

After curing, the lens may be subjected to extraction to remove unreacted components and release the lens from the lens mold. The extraction may be done using conventional extraction fluids, such organic solvents, such as alcohols or may be extracted using aqueous solutions.

Aqueous solutions are solutions which comprise water. The aqueous solutions of the present invention may comprise at least about 20 weight percent water, or at least about 50 weight percent water, or at least about 70 weight percent water, or at least about 95 weight percent water. Aqueous solutions may also include additional water-soluble components such as inorganic salts or release agents, wetting agents, slip agents, pharmaceutical and nutraceutical Formulas, combinations thereof and the like. Release agents are compounds or mixtures of compounds which, when combined with water, decrease the time required to release a contact lens from a mold, as compared to the time required to release such a lens using an aqueous solution that does not comprise the release agent. The aqueous solutions may not require special handling, such as purification, recycling or special disposal procedures.

Extraction may be accomplished, for example, via immersion of the lens in an aqueous solution or exposing the lens to a flow of an aqueous solution. Extraction may also include, for example, one or more of: heating the aqueous solution; stirring the aqueous solution; increasing the level of release aid in the aqueous solution to a level sufficient to cause release of the lens; mechanical or ultrasonic agitation of the lens; and incorporating at least one leaching or extraction aid in the aqueous solution to a level sufficient to facilitate adequate removal of unreacted components from the lens. The foregoing may be conducted in batch or continuous processes, with or without the addition of heat, agitation or both.

Application of physical agitation may be desired to facilitate leach and release. For example, the lens mold part to which a lens is adhered can be vibrated or caused to move back and forth within an aqueous solution. Other methods may include ultrasonic waves through the aqueous solution.

The lenses may be sterilized by known means such as, but not limited to, autoclaving.

As indicated above, preferred ophthalmic devices are contact lenses, more preferably soft hydrogel contact lenses. The transmission wavelengths and percentages described herein may be measured on various thicknesses of lenses using, for instance, the methodologies described in the Examples. By way of example, a preferred center thickness for measuring transmission spectra in a soft contact lens may be from 80 to 100 microns, or from 80 to 95 microns or from 85 to 95 microns. Typically, the measurement may be made at the center of the lens using, for instance, a 4 nm instrument slit width on an UV-VIS spectrophotometer.

Where the ophthalmic device of the invention is a silicone hydrogel contact lens, the lens preferably exhibits the following properties. All values are prefaced by “about,” and the lens may have any combination of the listed properties. The properties may be determined by methods known to those skilled in the art, for instance as described in United States pre-grant publication US20180037690, which is incorporated herein by reference.
Water Content (weight percent): at least 20 weight percent, or at least 25 weight percent and up to 80 weight percent or up to 70 weight percent
Haze: 30% or less, or 10% or less
Advancing dynamic contact angle (Wilhelmy plate method, degrees) or Sessile Drop: 100° or less, or 80° or less; or 50° or less
Tensile Modulus (psi): 120 or less, or 80 to 120
Edge corrected oxygen permeability (EC Dₖ, barrers): at least 50, or at least 60, or at least 80, or at least 100, or at least 120
Elongation to Break: at least 100 percent.
For ionic silicon hydrogels, the following properties may also be preferred (in addition to those recited above):
Lysozyme uptake (μg/lens): at least 100, or at least 150, or at least 500, or at least 700
Polyquaternium 1 (PQ1) uptake (%): 15 or less, or 10 or less, or 5 or less

The visible light filtering compounds as described herein may be used with other products, in addition to ophthalmic devices. For instance, the compounds may be used in windows (e.g., vehicle or building windows), or optical equipment, such as binoculars and cameras, and the like. In such use, the compounds may, for instance, be coated on the surface of the device. To facilitate coating, the compound may be dissolved in a solvent.

The first, second, and optional third visible light filtering compounds in the final ophthalmic device may be homogenously distributed, for instance, in an edge-to-edge colored contact lens, or independently distributed in the central zone and in the peripheral zone of a contact lens, such that the central and peripheral zones have different visible light absorption characteristics, or more concentrated in the central zone than in the peripheral zone of the lens (or vice versa). One preferred configuration is the colored or apodised central zone only contact lens, sometimes referred to a pupil only or optical zone only contact lens. However, such configurations are useful for other ophthalmic devices, especially intraocular lenses. Since these visible light filtering compounds absorb visible light, making the lenses have color, the concentration differences in the ophthalmic devices may be self-evident depending on their concentration. Alternatively, UV-VIS spectroscopy may be used whereby greater absorbance for any particular visible light filtering compound or mixture is generally indicative of a greater concentration, based on Beer's law.

There are fabrication methods that may be used for creating ophthalmic devices in which the first, second, and optional third visible light filtering compounds are concentrated in the central zone of the lens and include, for instance, the process described in U.S. Pat. No. 8,697,770, which is incorporated herein by reference in its entirety. This curing technique uses multiple doses of reactive monomer mixtures into the lens mold, where a first, higher viscosity mixture containing the first, second, and optional third visible light filtering compounds is dosed over the central zone of the mold, and a lower viscosity reactive mixture that is free of the first, second, and optional third visible light filtering compounds is dosed over or around the first dose. The mold halves are then brought together, and the reactive monomer mixtures subsequently cured. In this way, the visible light filtering formulation is concentrated in the central zone of the lens. Alternatively, the lower viscosity reactive mixture may also just have different amounts of the first, second, and optional third visible light filtering compounds than the higher viscosity reactive mixture.

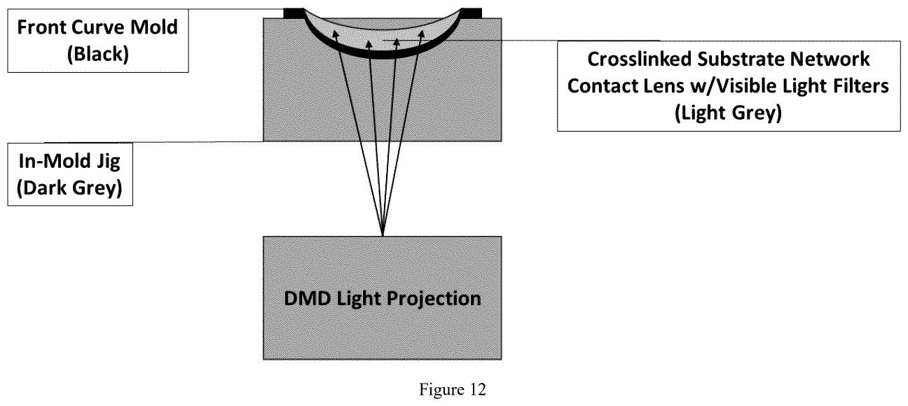

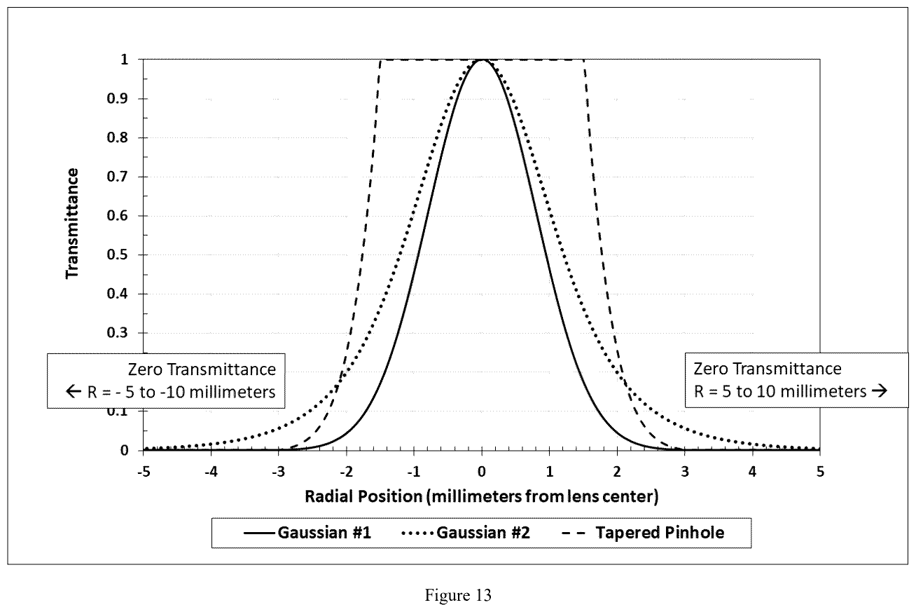

Still other techniques may be used for making such apodised ophthalmic devices, such as contact lenses, for example, the processes described in U.S. Pat. Nos. 11,034,789, 11,780,953, and U.S. application Ser. No. 18/457,455, which are incorporated herein by reference in their entireties and which involve the selective grafting of the first, second, and optional third visible light filtering compounds into an ophthalmic device using a computer controlled, digital micro-mirror device to project light rays to specific regions within a preformed device or lens, whereupon the selective grafting takes place, in which the molar concentrations of the first, second, and optional third visible light filtering compounds may be independently distributed in the central zone and in the peripheral zone, or in which the molar concentrations of the first, second, and optional third visible light filtering compounds may be independently greater in the central zone than in the peripheral zone (or vice versa), or in which the molar concentrations of the first, second, and optional third visible light filtering compounds may be independently distributed in the central zone only, or in which the molar concentrations of the first, second, and optional third visible light filtering compounds may independently vary spatially to form an apodization profile in the contact lenses, or in which the molar concentrations of the first, second, and optional third visible light filtering compounds may independently vary radially, circumferentially, or combinations thereof to form the apodization profile. The apodization profile may vary according to a mathematical function such as linear, polynomial, Gaussian, Lorentzian, logarithmic, exponential, numeric equations, or combinations thereof. The apodization profile may further comprise a transparent region in the center of the contact lens of any shape or size. In some applications, the transparent region is circular in shape having a diameter between 0.1 millimeters and 5 millimeters or between 1 millimeter and 4 millimeters. Examples of such apodization profiles are shown in FIGS. 12 and 13. Finally, the contact lens of the invention may comprise a central zone having an optical zone therewithin for the correction of refractive errors selected from the group consisting of myopia, hyperopia, presbyopia, and astigmatism.

In another aspect, the invention provides an apodised ophthalmic device, such as a contact lens, formed by the process: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a first grafting composition containing a first visible light filtering compound and a second visible light filtering compound, wherein the contacting is conducted under conditions such that the first grafting composition penetrates into the crosslinked substrate network; and (d) activating the covalently bound activatable free radical initiator at one or more selective regions of the crosslinked substrate network such that the first grafting composition polymerizes with the crosslinked substrate network at the selective regions, thereby forming an apodization profile.

The first reactive composition may comprise one or more ethylenically unsaturated compounds having one or more polymerizable groups independently selected from the group consisting of (meth)acrylate, (meth)acrylamide, styryl, vinyl, N-vinyl lactam, N-vinylamide, O-vinylether, O-vinylcarbonate, O-vinylcarbamate, C₂-12 alkenyl, C₂-12alkenylphenyl, C₂-12 alkenylnaphthyl, and C₂-6 alkenylphenyl-C₁-6 alkyl. Preferred polymerizable groups are (meth)acrylate and (meth)acrylamide. The first reactive composition may comprise a hydrophilic reactive component, a silicone-containing component, or combinations thereof. The first reactive composition comprises a polymerization initatior selected from the group consisting of bisacylphosphine oxide, a bisacylphosphane oxide, a di-azo compound, a di-peroxide compound, an azo-bis(monoacylphosphine oxide), an azo-bis(monoacylphosphane oxide), a peroxy-bis(monoacylphosphine oxide), a peroxy-bis(monoacylphosphane oxide), an azo-bis(alpha-hydroxy ketone), a peroxy-bis(alpha-hydroxy ketonc), an azo-bis(1,2-diketone), a peroxy-bis(1,2-diketone), a germanium based compound, tert-butyl 7-methyl-7-(tert-butylazo) peroxyoctanoate, or combinations thereof. Preferred initiators are bisacylphosphine oxides, which generate monoacylphosphine oxides as the covalently bound activatable free radical initiators in the crosslinked substrate networks. In that case, the preferred first activation is irradiation using a wavelength between 400 nanometers and 450 nanometers, or between 420 nanometers and 450 nanometers, and the preferred second activation is irradiation using a wavelength between 365 nanometers and 420 nanometers.

The first grafting composition may comprise a hydrophilic reactive component, a silicone-containing component, or combinations thereof crosslinker or a third visible light filtering compound. The first grafting composition comprises a first visible light filtering compound having the chemical structure of Formula (I) and a second visible light filtering compound having the chemical structure of Formula (II). The first grafting composition may also comprise a third visible light filtering compound having the chemical structures of Formula (III), Formula (IV), Formula (V), Formula (VI) or combinations thereof. The first grafting composition may be dissolved in a suitable diluent that swells that crosslinked substrate network and thereby impregnates the first, second, and optional third visible light filtering compounds into said crosslinked substrate network. Diluents may be used to control the swell time to incorporate the visible light filtering compounds into ophthalmic devices made of crosslinked substrate networks before grafting. Any organic solvent, aqueous organic solvents, and aqueous solutions may be used as the diluent, such as but not limited to, dimethylformamide, acetonitrile, dimethyl sulfoxide, and aliphatic alcohols. Preferred diluents are primary, secondary, and tertiary alcohols and their aqueous solutions (see the aforementioned list). More preferred diluents are aqueous solutions of 1-propanol, 2-propanol, or mixtures thereof.

The process may incorporate some additional steps, including but not limited to, following step (b), extracting the crosslinked substrate network with a solvent and optionally hydrating the extracted crosslinked substrate network with an aqueous solution, under conditions that preserve the covalently bound activatable free radical initiators of the crosslinked substrate network; and/or following step (d), contacting the crosslinked substrate network with a second grafting composition containing a different mixture of first, second, and optionally third visible light filtering compounds than the first grafting composition, and activating the retained covalently bound activatable free radical initiators such that the second grafting composition polymerizes with the crosslinked substrate network outside of the selective regions and optionally partially within the selective regions; and/or following step (d) extracting the crosslinked substrate network with a solvent, hydrating the extracted crosslinked substrate network with an aqueous solution, and autoclaving the ophthalmic device.

In addition, the process steps (a) and (b) may be performed in a mold assembly comprised of a front mold and a back mold, the front mold and a back mold defining and enclosing a cavity in the shape of the ophthalmic device, such as a contact lens, therebetween, and process steps (c) and (d) are performed in the mold assembly after the back mold has been removed. The activation of steps (b) and (d) may be via a source of actinic irradiation, such as UV/visible light irradiation, utilizing a plurality of selectively controllable beams of the actinic irradiation controlled by a digital micro-mirror device according to a predetermined script. The predetermined script directs the selectively controllable beams of actinic irradiation to one or more surfaces or locations within the cavity and thereby determines the amount of irradiation that any location or volume element within the mold cavity is exposed to. In that way, in step (d), the amount of grafting of the first, second, and optional third visible light filtering compounds can be controlled. Step (b) is typically performed using light emitting diode lamps of a specific wavelength. A preferred digital micro-mirror device includes an illumination source containing at least one light emitting diode as well.

As previously mentioned, the preferred initiators are bisacylphosphine oxides, which generate monoacylphosphine oxides (MAPO) as the covalently bound activatable free radical initiators in the crosslinked substrate networks. The amount of grafting of the visible light filtering compounds in any location within the MAPO substrate lens is controlled by varying the exposure time using light of fixed intensity and wavelength for irradiation, or by varying the intensity or wavelength of actinic irradiation using a fixed exposure time, or by adjusting the concentration of the visible light filtering compounds in the first or second grafting composition, and/or changing the diluent which can affect the swelling and permeation (without affecting the adherence to the FC mold) into the MAPO substrate lens, including the addition of a monomer that facilitates the copolymerization of the first, second, and optional third visible light filtering compounds.

The process may be used to make ophthalmic devices such as contact lenses, intraocular lenses, phakic intraocular lens, punctal plugs, ocular inserts and the like. These ophthalmic devices may be made of hydrogels or silicone hydrogels. These ophthalmic devices may also have a central zone and a peripheral zone, wherein the apodization profile varies across the central zone, or varies across the peripheral zone, or varies across the central zone and the peripheral zone. The apodization profile may vary according to a mathematical function, for example, the mathematical function is linear, polynomial, Gaussian, Lorentzian, logarithmic, exponential, numeric, or combinations thereof. The apodization profile may further comprise a transparent region in the center of the ophthalmic device, wherein the transparent region is circular in shape having a diameter between 0.1 millimeters and 5 millimeters or between 1 millimeter and 4 millimeters. The central zone may also comprise an optical zone for the correction of refractive errors selected from the group consisting of myopia, hyperopia, presbyopia, and astigmatism.

More generally, the invention also provides an ophthalmic device, such as a contact lens, that comprises one or more visible light absorbing compounds concentrated in the lens's central zone. Such ophthalmic devices may be formed by a process comprising: (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker; (b) subjecting the first reactive composition to a first activation step such that the first reactive composition polymerizes therein to form a crosslinked substrate network containing a covalently bound activatable free radical initiator; (c) contacting the crosslinked substrate network with a first grafting composition containing one or more polymerizable visible light absorbing compounds, wherein the contacting is conducted under conditions such that the first grafting composition penetrates into the crosslinked substrate network; and (d) activating the covalently bound activatable free radical initiator at a selective region of the crosslinked substrate network, the selective region corresponding to the ophthalmic device's central zone, such that the first grafting composition polymerizes with the crosslinked substrate network at the selective region, thereby forming an ophthalmic device having one or more light absorbing compounds concentrated in its central zone, wherein process steps (a) and (b) are performed in a mold assembly comprised of a front mold and a back mold, the front mold and the back mold defining and enclosing a cavity in the shape of the ophthalmic device, such as a contact lens, therebetween, wherein process steps (c) and (d) are performed in the mold assembly after the back mold has been removed, wherein the activation of steps (b) and (d) is via a source of actinic irradiation and includes a plurality of selectively controllable beams of the actinic irradiation controlled by a digital micro-mirror device according to a predetermined script, the predetermined script directing the selectively controllable beams of actinic irradiation to the selective region of the crosslinked substrate network within the cavity. In that way, in step (d), the amount of grafting of the one or more visible light absorbing compounds can be controlled. Step (b) may be performed using light emitting diode lamps of a specific wavelength. A preferred digital micro-mirror device includes an illumination source containing at least one light emitting diode as well.

In a further aspect, the invention provides 1-(10-butyl-2-methoxyacridin-9 (10H)-ylidene)-1-cyano-2-oxo-6,9,12,15,18-pentaoxa-3-azaicosan-20-yl methacrylate.

The invention also provides 2-(2-(2-((9,10-dioxo-9,10-dihydroanthracen-1-yl)amino) ethoxy) ethoxy)ethyl methacrylate.

The invention also provides 5-((9,10-dioxo-9,10-dihydroanthracen-1-yl)amino) pentyl methacrylate.

The invention also provides 17-((9-(dicyanomethylene)-9H-xanthen-3-yl)oxy)-3,6,9,12,15-pentaoxaheptadecyl methacrylate.

### CLAUSES

The following clauses list non-limiting embodiments of the disclosure:
Clause 1. An ophthalmic device that is a free radical reaction product of a reactive monomer mixture comprising:
   (a) one or more monomers suitable for making the ophthalmic device;
   (b) a first visible light filtering compound, the first visible light filtering compound having a visible light absorption maximum between 430 nanometers and 480 nanometers and a full width half maximum at the visible light absorption maximum of at least 35 nanometers and up to 150 nanometers, wherein the first visible light filtering compound is photostable, and wherein the first visible light filtering compound has a molar extinction coefficient of at least 7740 L·mol-1·cm⁻¹; and
   (c) a second visible light filtering compound having a visible light absorption maximum between 480 nanometers and 530 nanometers and a full width half maximum of at least 50 nanometers and up to 150 nanometers.
Clause 2. The ophthalmic device of clause 1 wherein the visible light absorption maximum of the first visible light filtering compound is between 440 nanometers and 470 nanometers.
Clause 3. The ophthalmic device of clause 1 wherein the visible light absorption maximum of the second visible light filtering compound is between 490 nanometers and 520 nanometers.
Clause 4. The ophthalmic device of any preceding clause wherein the full width half maximum at the visible light absorption maximum of the first visible light filtering compound is at least 40 nanometers and up to 95 nanometers.
Clause 5. The ophthalmic device of any preceding clause wherein the full width half maximum at the visible light absorption maximum of the second visible light filtering compound is at least 70 nanometers and up to 130 nanometers.
Clause 6. The ophthalmic device of any preceding clause wherein photostability comprises a loss of absorbance at the visible light absorption maximum of no more than 20 percent.
Clause 7. The ophthalmic device of any preceding clause wherein photostability comprises being more photostable than macular pigment.
Clause 8. The ophthalmic device of any preceding clause wherein the first visible light filtering compound is thermally stable.
Clause 9. The ophthalmic device of any preceding clause wherein the first visible light filtering compound is more thermally stable than macular pigment.
Clause 10. The ophthalmic device of any preceding clause wherein the first and second visible light filtering compounds independently comprise at least one polymerizable group.
Clause 11. The ophthalmic device of any one of clauses 1 to 10, wherein the first visible light filtering compound is of Formula I:

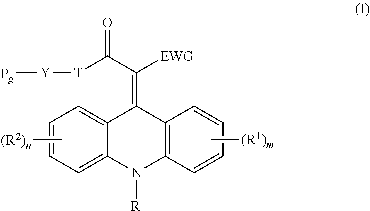

wherein m and n are independently 0, 1, 2, 3, or 4; T is a bond, O, or NR⁶, wherein R⁶ is H, C₁-C₆ alkyl, cycloalkyl, heterocycloalkyl, aryl, heteroaryl, or Y—P_{g}; R is H, C₁-C₈ alkyl, cycloalkyl, heterocycloalkyl, aryl, or heteroaryl; Y is a linking group; P_{g} is a polymerizable group; R₁ and R₂, when present, are independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R₄, benzyl, SO₃H, or SO₃M (M is a monovalent cation, such as sodium or potassium), wherein R³ and R₄ are independently H or C₁-C₆ alkyl, or two adjacent R₁ or R₂ groups, together with the carbon atoms to which they are attached, combine to form a cycloalkyl or aryl ring; and EWG is an electron withdrawing group.
Clause 12. The ophthalmic device of clause 11 wherein m and n are each independently 0 or 1.
Clause 13. The ophthalmic device of any one of clauses 11 to 12 wherein Y at each occurrence is independently alkylene, cycloalkylene, heterocycloalkylene, arylene, heteroarylene, oxaalkylene, alkylene-amide-alkylene, alkylene-amine-alkylene, or combinations thereof.
Clause 14. The ophthalmic device of any one of clauses 11 to 13 wherein Pe comprises styryl, vinyl carbonate, vinyl ether, vinyl carbamate, N-vinyl lactam, N-vinylamide, (meth)acrylate, or (meth)acrylamide.
Clause 15. The ophthalmic device of any one of clauses 11 to 14 wherein EWG is cyano, amide, ester, keto, or aldehyde.
Clause 16. The ophthalmic device of clause 15 wherein EWG is cyano.
Clause 17. The ophthalmic device of clause 11 wherein the first visible light filtering compound comprises: 2-(2-cyano-2-(2-methoxy-10-propylacridin-9 (10H)-ylidene) acetamido)ethyl methacrylate, 2-(2-cyano-2-(2-methoxy-10-butylacridin-9 (10H)-ylidene) acetamido)ethyl methacrylate, 1-(10-butyl-2-methoxyacridin-9 (10H)-ylidene)-1-cyano-2-oxo-6,9,12,15,18-pentaoxa-3-azaicosan-20-yl methacrylate, or a mixture thereof.
Clause 18. The ophthalmic device of clause 17, wherein the first visible light filtering compound is 2-(2-cyano-2-(2-methoxy-10-butylacridin-9 (10H)-ylidene) acetamido)ethyl methacrylate having the chemical structure:

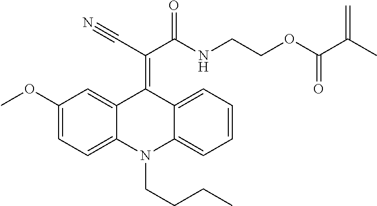 [SMILES: C=C(C)C(=O)OCCNC(=O)/C(C#N)=C1\c2ccccc2N(CCCC)c2ccc(OC)cc21]

Clause 19. The ophthalmic device of any one of clauses 1-18 wherein the second visible light filtering compound comprises a visible light filter of Formula II:

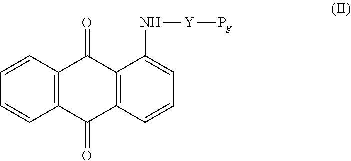

wherein Y is a linking group, and P_{g} is a polymerizable group.
Clause 20. The ophthalmic device of clause 19 wherein Y is alkylene, oxaalkylene, alkyleneoxy, or combinations thereof.
Clause 21. The ophthalmic device of any one of clauses 19 to 20 wherein P_{g} comprises styryl, vinyl carbonate, vinyl ether, vinyl carbamate, N-vinyl lactam, N-vinylamide, (meth)acrylate, or (meth)acrylamide.
Clause 22. The ophthalmic device of clause 21 wherein the second visible light filtering compound comprises 2-(2-(2-((9,10-dioxo-9,10-dihydroanthracen-1-yl)amino) ethoxy) ethoxy)ethyl methacrylate, 5-((9,10-dioxo-9,10-dihydroanthracen-1-yl)amino) pentyl methacrylate, 2-((9,10-dioxo-9,10-dihydroanthracen-1-yl)amino) ethyl methacrylate, and combinations thereof.
Clause 23. The ophthalmic device of clause 22 wherein the second visible light filtering compound is 2-(2-(2-((9,10-dioxo-9,10-dihydroanthracen-1-yl)amino) ethoxy) ethoxy)ethyl methacrylate having the chemical structure:

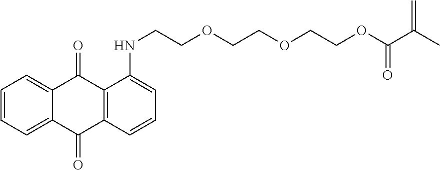 [SMILES: C=C(C)C(=O)OCCOCCOCCNc1cccc2c1C(=O)c1ccccc1C2=O]

Clause 24. The ophthalmic device of any of clauses 1 to 23 wherein the ophthalmic device further comprises a third light filtering compound.
Clause 25. The ophthalmic device of clause 24 wherein the third visible light filtering compound exhibits one or more visible light absorption maxima between 550 nanometers and 660 nanometers.
Clause 26. The ophthalmic device of any one of clauses 24 to 25 wherein the third visible light filtering compound comprises a visible light filter of Formula III:

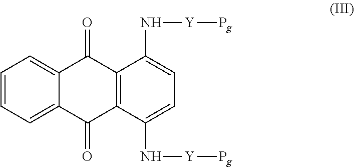

wherein Y at each occurrence is independently a linking group and P_{g} at each occurrence is independently a polymerizable group.
Clause 27. The ophthalmic device of clause 26 wherein Y at each occurrence is independently alkylene, oxaalkylene, alkyleneoxy, cycloalkylene, heterocycloalkylene, arylene, heteroarylene, alkylene-amide-alkylene, alkylene-amine-alkylene, or combinations thereof.
Clause 28. The ophthalmic device of any one of clauses 26 to 27 wherein P_{g} at each occurrence independently comprises styryl, vinyl carbonate, vinyl ether, vinyl carbamate, N-vinyl lactam, N-vinylamide, (meth)acrylate, or (meth)acrylamide.
Clause 29. The ophthalmic device of clause 28 wherein the third visible light filtering compound comprises 1,4-bis [2-methacryloxyethylamino]-9,10-anthraquinone, (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate), or N,N′-(((((((9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl))diacrylamide.
Clause 30. The ophthalmic device of clause 29 wherein the third visible light filtering compound is (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate) having the chemical structure:

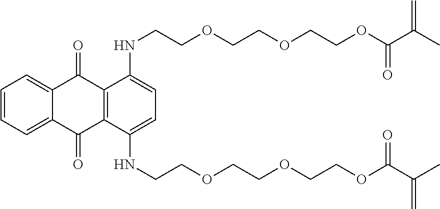 [SMILES: C=C(C)C(=O)OCCOCCOCCNc1ccc(NCCOCCOCCOC(=O)C(=C)C)c2c1C(=O)c1ccccc1C2=O]

Clause 31. The ophthalmic device of any one of clauses 24 to 25 wherein the third visible light filtering compound comprises a visible light filter of Formula IV:

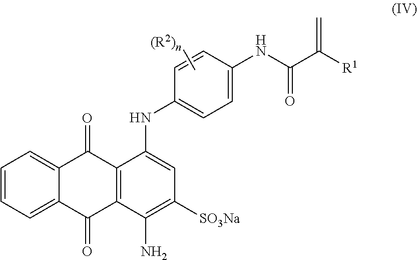

wherein R¹ is H, methyl, or Br and R₂ is independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), benzyl, halo, hydroxy, amino, NR³R₄, SO₃H, or SO₃M (M is a monovalent cation, such as sodium or potassium), wherein R³ and R₄ are independently H or C₁-C₆ alkyl, or two adjacent R₂ groups, together with the carbon atoms to which they are attached, combine to form a cycloalkyl or aryl ring.
Clause 32. The ophthalmic device of clause 31 wherein the third visible light filtering compound is sodium 1-amino-4-((4-(2-bromoacrylamido)-2-sulfonatophenyl)amino)-9,10-dioxo-9,10-dihydroanthracene-2-sulfonate, sodium 4-((4-acrylamidophenyl)amino)-1-amino-9,10-dioxo-9,10-dihydroanthracene-2-sulfonate, sodium 1-amino-4-((4-methacrylamidophenyl)amino)-9,10-dioxo-9,10-dihydroanthracene-2-sulfonate, or combinations thereof.
Clause 33. The ophthalmic device of clause 32 wherein the third visible light filtering compound is sodium 1-amino-4-((4-(2-bromoacrylamido)-2-sulfonatophenyl)amino)-9,10-dioxo-9,10-dihydroanthracene-2-sulfonate having the chemical structure:

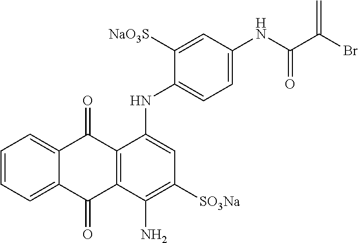

Clause 34. The ophthalmic device of clause 24 wherein the third visible light filtering compound comprises a visible light filter of Formula V:

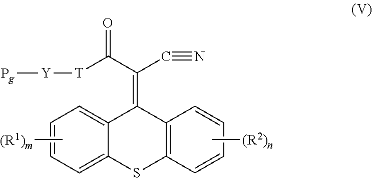

wherein:
m and n are independently 0, 1, 2, 3, or 4; T is a bond, O, or NR; Y is a linking group; P_{g} is a polymerizable group; R at each occurrence is independently H, C₁-C₆ alkyl, cycloalkyl, heterocycloalkyl, aryl, heteroaryl, or Y—P_{g}; and R₁ and R₂, when present, are independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), halo, hydroxy, amino, NR³R₄, or benzyl, wherein R³ and R₄ are independently H or C₁-C₆ alkyl, or two adjacent R₁ or R₂ groups, together with the carbon atoms to which they are attached, combine to form a cycloalkyl or aryl ring.
Clause 35. The ophthalmic device of clause 34 wherein m and n are each independently 0 or 1.
Clause 36. The ophthalmic device of any one of clauses 34 to 35 wherein Y at each occurrence is independently alkylene, oxaalkylene, alkyleneoxy, cycloalkylene, heterocycloalkylene, arylene, heteroarylene, alkylene-amide-alkylene, alkylene-amine-alkylene, or combinations thereof.
Clause 37. The ophthalmic device of any one of clauses 34 to 35 wherein P_{g} comprises styryl, vinyl carbonate, vinyl ether, vinyl carbamate, N-vinyl lactam, N-vinylamide, (meth)acrylate, or (meth)acrylamide.
Clause 38. The ophthalmic device of clause 37 wherein the third visible light filtering compound comprises: 2-(2-cyano-2-(9H-thioxanthen-9-ylidene) acetamido)ethyl methacrylate; 2-(2-cyano-2-(9H-thioxanthen-9-ylidene) acetamido)ethyl acrylate; N-(2-(2-cyano-2-(9H-thioxanthen-9-ylidene) acetamido)ethyl) methacrylamide; N-(2-(2-cyano-2-(9H-thioxanthen-9-ylidene) acetamido)ethyl) acrylamide; 2-(2-cyano-N-methyl-2-(9H-thioxanthen-9-ylidene) acetamido)ethyl methacrylate; 2-cyano-2-(9H-thioxanthen-9-ylidene)-N-(2-(N-vinylacetamido)ethyl) acetamide; 2-(2-cyano-2-(9H-thioxanthen-9-ylidene) acetamido)-2-methylpropyl methacrylate;2-(2-cyano-2-(2,4-dichloro-9H-thioxanthen-9-ylidene) acetamido)ethyl methacrylate; 2-(2-(2-chloro-9H-thioxanthen-9-ylidene)-2-methacrylate; cyanoacetamido)ethyl 2-(2-cyano-2-(2-isopropyl-9H-thioxanthen-9-ylidene) acetamido)ethyl methacrylate; 2-(2-cyano-2-(4-isopropyl-9H-thioxanthen-9-ylidene) acetamido)ethyl methacrylate; 2-(2-cyano-2-(9H-thioxanthen-9-ylidene) acetoxy)ethyl methacrylate; 1-cyano-2-oxo-1-(9H-thioxanthen-9-ylidene)-6,9,12,15,18-pentaoxa-3-azaicosan-20-yl methacrylate; or mixtures of two or more thereof.
Clause 39. The ophthalmic device of clause 38 wherein the third visible light filtering compound is 2-(2-cyano-2-(9H-thioxanthen-9-ylidene) acetamido)ethyl methacrylate having the chemical structure:

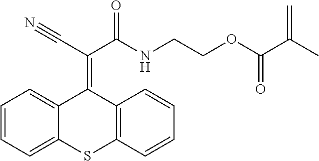 [SMILES: C=C(C)C(=O)OCCNC(=O)C(C#N)=C1c2ccccc2Sc2ccccc21]

Clause 40. The ophthalmic device of clause 24 wherein the third visible light filtering compound comprises a visible light filter of Formula VI:

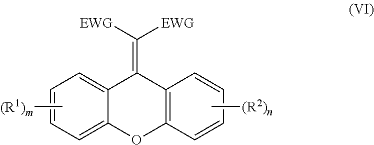

wherein m and n are independently 0, 1, 2, 3, or 4; R₁ and R₂ are independently at each occurrence H, an optional substituent, or —Y—P_{g}, or two adjacent R₁ or R₂ groups, together with the atoms to which they are attached, combine to form a cycloalkyl or aryl ring optionally substituted with —Y—P_{g}; EWG at each occurrence is independently an electron withdrawing group; P_{g} at each occurrence is independently a polymerizable group; and Y at each occurrence is independently a linking group; wherein the compound of Formula VI contains at least one P_{g} group.
Clause 41. The ophthalmic device of clause 40 wherein m and n are independently 0 or 1.
Clause 42. The ophthalmic device of any one of clauses 40 to 41 wherein R¹ is H, C₁-C₆ alkyl, C₁-C₆ alkoxy, C₁-C₆ thioalkyl, C₃-C₇ cycloalkyl, aryl, halo, hydroxy, amino, NR⁴R₅, benzyl, SO₃H, or SO₃Na, wherein R⁴ and R⁵ are independently H or C₁-C₆ alkyl.
Clause 43. The ophthalmic device of any one of clauses 40 to 42 wherein R₂ is —Y—P_{g}.
Clause 44. The ophthalmic device of any one of clauses 40 to 43 wherein P_{g} at each occurrence independently comprises styryl, vinyl carbonate, vinyl ether, vinyl carbamate, N-vinyl lactam, N-vinylamide, (meth)acrylate, or (meth)acrylamide.
Clause 45. The ophthalmic device of any one of clauses 40 to 44 wherein Y at each occurrence is independently alkylene, oxaalkylene, alkyleneoxy, cycloalkylene, heterocycloalkylene, arylene, heteroarylene, alkylene-amide-alkylene, alkylene-amine-alkylene, or combinations of any of the foregoing groups.
Clause 46. The ophthalmic device of any one of clauses 40 to 45 wherein EWG at each occurrence is independently cyano, amide, ester, keto, or aldehyde.
Clause 47. The ophthalmic device of any one of clauses 40 to 46 wherein the compound contains one Y—P_{g} group.
Clause 48. The ophthalmic device of clause 47 wherein the third visible light filtering compound comprises:
   (a) 3-((9-(dicyanomethylene)-9H-xanthen-3-yl)oxy) propyl methacrylate;
   (b) 3-((9-(dicyanomethylene)-9H-xanthen-2-yl)oxy) propyl methacrylate;
   (c) 1-((9-(dicyanomethylene)-9H-xanthen-3-yl)oxy) propan-2-yl methacrylate;
   (d) 4-((9-(dicyanomethylene)-9H-xanthen-3-yl)oxy)butyl methacrylate;
   (e) 3-((9-(dicyanomethylene)-9H-xanthen-3-yl)oxy) propyl acrylate;
   (f) 1-((9-(dicyanomethylene)-9H-xanthen-3-yl)oxy) propan-2-yl acrylate;
   (g) 4-((9-(dicyanomethylene)-9H-xanthen-3-yl)oxy)butyl acrylate;
   (h) N-(3-((9-(dicyanomethylene)-9H-xanthen-3-yl)oxy) propyl) methacrylamide;
   (i) N-(3-((9-(dicyanomethylene)-9H-xanthen-3-yl)oxy) propyl) acrylamide;
   (j) 3-((9-(dicyanomethylene)-9H-xanthen-3-yl)amino) propyl methacrylate;
   (k) 17-((9-(dicyanomethylene)-9H-xanthen-3-yl)oxy)-3,6,9,12,15-pentaoxaheptadecyl methacrylate;
   (1) or mixtures of two or more thereof.
Clause 49. The ophthalmic device of clause 48 wherein the third visible light filtering compound is 3-((9-(dicyanomethylene)-9H-xanthen-3-yl)oxy) propyl methacrylate having the chemical structure:

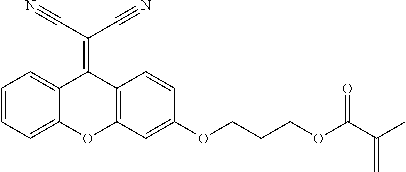 [SMILES: C=C(C)C(=O)OCCCOc1ccc2c(c1)Oc1ccccc1C2=C(C#N)C#N]

Clause 50. The ophthalmic device of any preceding clause wherein the reactive mixture further comprises an ultraviolet absorbing compound, wherein the ultraviolet absorbing compound comprises a benzophenone, a benzotriazole, a triazine, a substituted acrylonitrile, a salicyclic acid derivative, a benzoic acid derivative, a cinnamic acid derivative, a chalcone derivative, a dypnone derivative, a crotonic acid derivative, or mixtures thereof.
Clause 51. The ophthalmic device of clause 50 wherein the ultraviolet absorbing compound is (2-(2′-hydroxy-5-methacrylyloxyethylphenyl)-2H-benzotriazole.
Clause 52. The ophthalmic device of any preceding clause wherein the ophthalmic device has a transmittance:
   (a) between 1 percent and 50 percent across a wavelength range of 480 nanometers to 660 nanometers; and
   (b) between 20 percent and 70 percent across a wavelength range of 375 nanometers and 425 nanometers.
Clause 53. The ophthalmic device of clause 52 wherein the ophthalmic device has a transmittance:
   (a) between 10 percent and 40 percent across a wavelength range of 480 nanometers to 660 nanometers; and
   (b) between 30 percent and 60 percent across a wavelength range of 375 nanometers and 425 nanometers.
Clause 54. The ophthalmic device of any one of clauses 52 to 53 wherein the transmittance between 480 nanometers to 660 nanometers varies from an average transmittance by 15 percent or less.
Clause 55. The ophthalmic device of any one of clauses 52 to 53 wherein the transmittance between 480 nanometers to 660 nanometers varies from an average transmittance by 10 percent or less.
Clause 56. The ophthalmic device of any one of clauses 52 to 53 wherein the transmittance between 480 nanometers to 660 nanometers varies from an average transmittance by 7.5 percent or less.
Clause 57. The ophthalmic device of any one of clauses 52 to 53 wherein the transmittance between 480 nanometers to 660 nanometers varies from an average transmittance by 5 percent or less.
Clause 58. The ophthalmic device of any one of clauses 54 to 57 wherein the average transmittance is between 20 percent and 50 percent.
Clause 59. The ophthalmic device of any one of clauses 52 to 58 wherein the transmittances are normalized using Equation 1 or Equation 2:

$${T}_{N} = [ T - {T}_{min} ] \div [ {T}_{max} - {T}_{min} ] \qquad Equation 1$$

$$\% {T}_{N} = 100 \times \{ [ T - {T}_{min} ] \div [ {T}_{max} - {T}_{min} ] \} \qquad Equation 2$$

wherein T_{N} is the normalized transmittance calculated from the measured transmittance T, Tₘᵢₙ is the minimum transmittance value between 300 and 800 nanometers, and Tₘₐₓ is the maximum transmittance value between 300 and 800 nanometer
Clause 60. The ophthalmic device of any one of clauses 1 to 59 that is formed by photocuring of the reactive mixture.
Clause 61. The ophthalmic device of any one of clauses 1 to 59 that is formed by thermal curing of the reactive mixture.
Clause 62. The ophthalmic device of any one of clauses 1 to 59 that is formed by a combination of photocuring and thermal curing of the reactive mixture.
Clause 63. The ophthalmic device any preceding clause that is selected from the group consisting of a contact lens, an intraocular lens, phakic intraocular lens, a punctal plug, and an ocular insert.
Clause 64. The ophthalmic device of any preceding clause that is a contact lens, the contact lens having a central zone and a peripheral zone.
Clause 65. The ophthalmic device of clause 64 wherein the molar concentrations of the first, second, and third visible light filtering compounds are independently distributed in the central zone and in the peripheral zone.
Clause 66. The ophthalmic device of clause 64 wherein the molar concentrations of the first, second, and third visible light filtering compounds are independently greater in the central zone than in the peripheral zone.
Clause 67. The ophthalmic device of clause 64 wherein the molar concentrations of the first, second, and third visible light filtering compounds are independently distributed in the central zone only.
Clause 68. The ophthalmic device of any of clauses 63 to 67 wherein the molar concentrations of the first, second, and third visible light filtering compounds independently vary spatially to form an apodization profile.
Clause 69. The ophthalmic device of clause 68 wherein the molar concentrations of the first, second, and third visible light filtering compounds independently vary radially, circumferentially, or combinations thereof to form the apodization profile.
Clause 70. The ophthalmic device of any one of clauses 68 to 69 wherein the apodization profile varies according to a mathematical function.
Clause 71. The ophthalmic device of clause 70 wherein the mathematical function is linear, polynomial, Gaussian, Lorentzian, logarithmic, exponential, numeric, or combinations thereof.
Clause 72. The ophthalmic device of any one of clauses 68 to 71 wherein the apodization profile further comprises a transparent region in the center of the contact lens.
Clause 73. The ophthalmic device of clause 72 wherein the transparent region is circular in shape having a diameter between 0.1 millimeters and 5 millimeters.
Clause 74. The ophthalmic device of clause 73 wherein the transparent region has a diameter between 1 millimeter and 4 millimeters.
Clause 75. The ophthalmic device of any one of clauses 68 to 74 wherein the central zone comprises an optical zone for the correction of refractive errors selected from the group consisting of myopia, hyperopia, presbyopia, and astigmatism.
Clause 76. The ophthalmic device of any preceding clause wherein the reactive monomer mixture comprises a hydrophilic component, a silicone-containing component, or mixtures thereof.
Clause 77. The ophthalmic device of any preceding clause wherein the device is a silicone hydrogel contact lens, the lens having a contact angle of about 100° or less, a water content of at least 25 weight percent, and an oxygen permeability (edge corrected) of at least 60 barrers.
Clause 78. An apodised ophthalmic device formed by a process comprising:
   (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker;
   (b) subjecting the first reactive composition to a first activation step such that the first reactive composition polymerizes therein to form a crosslinked substrate network containing a covalently bound activatable free radical initiator;
   (c) contacting the crosslinked substrate network with a first grafting composition containing a first visible light filtering compound and a second visible light filtering compound, wherein the contacting is conducted under conditions such that the first grafting composition penetrates into the crosslinked substrate network; and
   (d) activating the covalently bound activatable free radical initiator at one or more selective regions of the crosslinked substrate network such that the first grafting composition polymerizes with the crosslinked substrate network at the selective regions, thereby forming an apodization profile.
Clause 79. The ophthalmic device of clause 78 further comprising a third visible light filtering compound in the first grafting composition.
Clause 80. The ophthalmic device of clauses 78 to 79 wherein the first grafting composition of step (c) contains a crosslinker.
Clause 81. The ophthalmic device of clauses 78 to 79 wherein the first grafting composition of step (c) is free of a crosslinker.
Clause 82. The ophthalmic device of any one of clauses 78 to 81 wherein the one or more ethylenically unsaturated compounds of step (a) comprise one or more polymerizable groups independently selected from: (meth)acrylate, (meth)acrylamide, styryl, vinyl, N-vinyl lactam, N-vinylamide, O-vinylether, O-vinylcarbonate, O-vinylcarbamate, C₂-12 alkenyl, C₂-12alkenylphenyl, C₂-12 alkenylnaphthyl, and C₂-6 alkenylphenyl-C₁-6 alkyl.
Clause 83. The ophthalmic device of any one of clauses 78 to 82 wherein the first reactive composition comprises a hydrophilic reactive component, a silicone-containing component, or combinations thereof.
Clause 84. The ophthalmic device of any one of clauses 78 to 83 wherein the first visible light filtering compound of the first grafting composition of step (c) comprises compounds having the chemical structure of Formula (I).
Clause 85. The ophthalmic device of any one of clauses 78 to 84 wherein the second visible light filtering compound of the first grafting composition of step (c) comprises compounds having the chemical structure of Formula (II).
Clause 86. The ophthalmic device of any one of clauses 78 to 85 wherein the third visible light filtering compound of the first grafting composition of step (c) comprises compounds having the chemical structures of Formula (III), Formula (IV), Formula (V), Formula (VI) or combinations thereof.
Clause 87. The ophthalmic device of any one of clauses 78 to 86 wherein the polymerization initiator is a bisacylphosphine oxide, a bisacylphosphane oxide, a di-azo compound, a di-peroxide compound, an azo-bis(monoacylphosphine oxide), an azo-bis(monoacylphosphane oxide), a peroxy-bis(monoacylphosphine oxide), a peroxy-bis(monoacylphosphane oxide), an azo-bis(alpha-hydroxy ketone), a peroxy-bis(alpha-hydroxy ketone), an azo-bis(1,2-diketone), a peroxy-bis(1,2-diketone), a germanium based compound, tert-butyl 7-methyl-7-(tert-butylazo) peroxyoctanoate, or combinations thereof.
Clause 88. The ophthalmic device of clause 87 wherein the polymerization initiator is a bisacylphosphine oxide.
Clause 89. The ophthalmic device of clause 88 wherein the first activation is irradiation using a wavelength between 400 nanometers and 450 nanometers.
Clause 90. The ophthalmic device of clause 89 wherein the first activation is irradiation using a wavelength between 420 nanometers and 450 nanometers.
Clause 91. The ophthalmic device of any one of claims 89 to 90 wherein the second activation is irradiation using a wavelength between 365 nanometers and 420 nanometers.
Clause 92. The ophthalmic device of any one of clauses 78 to 91 wherein the process further comprises: following step (b), extracting the crosslinked substrate network with a solvent and optionally hydrating the extracted crosslinked substrate network with an aqueous solution, under conditions that preserve the covalently bound activatable free radical initiators of the crosslinked substrate network.
Clause 93. The ophthalmic device of any one of clauses 78 to 92 wherein the process further comprises: following step (d), contacting the crosslinked substrate network with a second grafting composition containing a different mixture of first, second, and optionally third visible light filtering compounds than the first grafting composition, and activating the retained covalently bound activatable free radical initiators such that the second grafting composition polymerizes with the crosslinked substrate network outside of the selective regions and optionally partially within the selective regions.
Clause 94. The ophthalmic device of any one of clauses 78 to 93 wherein the process further comprises: following step (d) extracting the crosslinked substrate network with a solvent, hydrating the extracted crosslinked substrate network with an aqueous solution, and autoclaving the ophthalmic device.
Clause 95. The ophthalmic device of any one of clauses 78 to 94 wherein the process steps (a) and (b) are performed in a mold assembly comprised of a front mold and a back mold, the front mold and a back mold defining and enclosing a cavity in the shape of the ophthalmic device therebetween, and process steps (c) and (d) are performed in the mold assembly after the back mold has been removed.
Clause 96. The ophthalmic device of any one of clauses 78 to 95 wherein the activation of steps (b) and (d) is via a source of actinic irradiation and the source includes a plurality of selectively controllable beams of the actinic irradiation controlled by a digital micro-mirror device according to a predetermined script.
Clause 97. The ophthalmic device of clause 96 wherein the plurality of selectively controllable beams of actinic irradiation controlled by the digital micro-mirror devices according to predetermined scripts are directed to one or more surfaces of the ophthalmic device.
Clause 98. The ophthalmic device of any one of clauses 96 to 97 wherein the digital micro-mirror device includes an illumination source containing at least one light emitting diode.
Clause 99. The ophthalmic device of any one of clauses 78 to 98 wherein the predetermined script creates the apodization profile.
Clause 100. The ophthalmic device of any one of clauses 78 to 99 wherein the ophthalmic device is selected from the group consisting of a contact lens, an intraocular lens, phakic intraocular lens, a punctal plug, and an ocular insert.
Clause 101. The ophthalmic device of any of clauses 78 to 100 wherein the ophthalmic device is a hydrogel.
Clause 102. The ophthalmic device of any of clauses 78 to 101 wherein the ophthalmic device has a central zone and a peripheral zone.
Clause 103. The ophthalmic device of clause 102 wherein the apodization profile varies across the central zone.
Clause 104. The ophthalmic device of clause 102 wherein the apodization profile varies across the peripheral zone.
Clause 105. The ophthalmic device of clause 102 wherein the apodization profile varies across the central zone and the peripheral zone.
Clause 106. The ophthalmic device of any one of clauses 78 to 105 wherein the apodization profile varies according to a mathematical function.
Clause 107. The ophthalmic device of clause 106 wherein the mathematical function is linear, polynomial, Gaussian, Lorentzian, logarithmic, exponential, numeric, or combinations thereof.
Clause 108. The ophthalmic device of any one of clauses 78 to 107 wherein the apodization profile further comprises a transparent region in the center of the ophthalmic device.
Clause 109. The ophthalmic device of clause 108 wherein the transparent region is circular in shape having a diameter between 0.1 millimeters and 5 millimeters.
Clause 110. The ophthalmic device of clause 109 wherein the transparent region has a diameter between 1 millimeter and 4 millimeters.
Clause 111. The ophthalmic device of any one of clauses 78 to 110 wherein the central zone comprises an optical zone for the correction of refractive errors selected from the group consisting of myopia, hyperopia, presbyopia, and astigmatism.
Clause 112. A process of making an apodised ophthalmic device comprising:
   (a) providing a first reactive composition containing: (i) a polymerization initiator that is capable, upon a first activation, of forming two or more free radical groups, at least one of which is further activatable by subsequent activation; (ii) one or more ethylenically unsaturated compounds; and (iii) a crosslinker;
   (b) subjecting the first reactive composition to a first activation step such that the first reactive composition polymerizes therein to form a crosslinked substrate network containing a covalently bound activatable free radical initiator;
   (c) contacting the crosslinked substrate network with a first grafting composition containing a first visible light filtering compound and a second visible light filtering compound, wherein the contacting is conducted under conditions such that the first grafting composition penetrates into the crosslinked substrate network; and
   (d) activating the covalently bound activatable free radical initiator at one or more selective regions of the crosslinked substrate network such that the first grafting composition polymerizes with the crosslinked substrate network at the selective regions, thereby forming an apodization profile.
Clause 113. The process of clause 112 further comprising a third visible light filtering compound in the first grafting composition.
Clause 114. The process of clauses 112 to 113 wherein the first grafting composition of step (c) contains a crosslinker.
Clause 115. The process of clauses 112 to 113 wherein the first grafting composition of step (c) is free of a crosslinker.
Clause 116. The process of any one of clauses 112 to 115 wherein the one or more ethylenically unsaturated compounds of step (a) comprise one or more polymerizable groups independently selected from: (meth)acrylate, (meth)acrylamide, styryl, vinyl, N-vinyl lactam, N-vinylamide, O-vinylether, O-vinylcarbonate, O-vinylcarbamate, C₂-12 alkenyl, C₂-12alkenylphenyl, C₂-12 alkenylnaphthyl, and C₂-6 alkenylphenyl-C₁-6 alkyl.
Clause 117. The process of any one of clauses 112 to 116 wherein the first reactive composition comprises a hydrophilic reactive component, a silicone-containing component, or combinations thereof.
Clause 118. The process of any one of clauses 112 to 117 wherein the first visible light filtering compound of the first grafting composition of step (c) comprises compounds having the chemical structure of Formula (I).
Clause 119. The process of any one of clauses 112 to 118 wherein the second visible light filtering compound of the first grafting composition of step (c) comprises compounds having the chemical structure of Formula (II).
Clause 120. The process of any one of clauses 112 to 119 wherein the third visible light filtering compound of the first grafting composition of step (c) comprises compounds having the chemical structures of Formula (III), Formula (IV), Formula (V), Formula (VI) or combinations thereof.
Clause 121. The process of any one of clauses 112 to 120 wherein the polymerization initiator is a bisacylphosphine oxide, a bisacylphosphane oxide, a di-azo compound, a di-peroxide compound, an azo-bis(monoacylphosphine oxide), an azo-bis(monoacylphosphane oxide), a peroxy-bis(monoacylphosphine oxide), a peroxy-bis(monoacylphosphane oxide), an azo-bis(alpha-hydroxy ketonc), a peroxy-bis(alpha-hydroxy ketone), an azo-bis(1,2-diketone), a peroxy-bis(1,2-diketone), a germanium based compound, tert-butyl 7-methyl-7-(tert-butylazo) peroxyoctanoate, or combinations thereof.
Clause 122. The process of clause 121 wherein the polymerization initiator is a bisacylphosphine oxide.
Clause 123. The process of clause 122 wherein the first activation is irradiation using a wavelength between 400 nanometers and 450 nanometers.
Clause 124. The process of clause 123 wherein the first activation is irradiation using a wavelength between 420 nanometers and 450 nanometers.
Clause 125. The process of any one of claims 123 to 124 wherein the second activation is irradiation using a wavelength between 365 nanometers and 420 nanometers.
Clause 126. The process of any one of clauses 112 to 125 wherein the process further comprises: following step (b), extracting the crosslinked substrate network with a solvent and optionally hydrating the extracted crosslinked substrate network with an aqueous solution, under conditions that preserve the covalently bound activatable free radical initiators of the crosslinked substrate network.
Clause 127. The process of any one of clauses 112 to 126 wherein the process further comprises: following step (d), contacting the crosslinked substrate network with a second grafting composition containing a different mixture of first, second, and optionally third visible light filtering compounds than the first grafting composition, and activating the retained covalently bound activatable free radical initiators such that the second grafting composition polymerizes with the crosslinked substrate network outside of the selective regions and optionally partially within the selective regions.
Clause 128. The process of any one of clauses 112 to 127 wherein the process further comprises: following step (d) extracting the crosslinked substrate network with a solvent, hydrating the extracted crosslinked substrate network with an aqueous solution, and autoclaving the ophthalmic device.
Clause 129. The process of any one of clauses 112 to 128 wherein the process steps (a) and (b) are performed in a mold assembly comprised of a front mold and a back mold, the front mold and a back mold defining and enclosing a cavity in the shape of the ophthalmic device therebetween, and process steps (c) and (d) are performed in the mold assembly after the back mold has been removed.
Clause 130. The process of any one of clauses 112 to 129 wherein the activation of steps (b) and (d) is via a source of actinic irradiation, the source including a plurality of selectively controllable beams of the actinic irradiation controlled by a digital micro-mirror device according to a predetermined script.
Clause 131. The process of clause 130 wherein the plurality of selectively controllable beams of actinic irradiation controlled by the digital micro-mirror devices according to predetermined scripts are directed to one or more surfaces of the ophthalmic device.
Clause 132. The process of any one of clauses 112 to 131 wherein the digital micro-mirror device includes an illumination source containing at least one light emitting diode.
Clause 133. The process of any one of clauses 112 to 132 wherein the predetermined script creates the apodization profile.
Clause 134. The process of any one of clauses 112 to 133 wherein the ophthalmic device is selected from the group consisting of a contact lens, an intraocular lens, phakic intraocular lens, a punctal plug, and an ocular insert.
Clause 135. The process of any of clauses 112 to 134 wherein the ophthalmic device is a hydrogel.
Clause 136. The process of any of clauses 112 to 135 wherein the ophthalmic device has a central zone and a peripheral zone.
Clause 137. The process of clause 136 wherein the apodization profile varies across the central zone.
Clause 138. The process of clause 136 wherein the apodization profile varies across the peripheral zone.
Clause 139. The process of clause 136 wherein the apodization profile varies across the central zone and the peripheral zone.
Clause 140. The process of any one of clauses 112 to 139 wherein the apodization profile varies according to a mathematical function.
Clause 141. The process of clause 140 wherein the mathematical function is linear, polynomial, Gaussian, Lorentzian, logarithmic, exponential, numeric, or combinations thereof.
Clause 142. The process of any one of clauses 112 to 141 wherein the apodization profile further comprises a transparent region in the center of the process.
Clause 143. The process of clause 142 wherein the transparent region is circular in shape having a diameter between 0.1 millimeters and 5 millimeters.
Clause 144. The process of clause 143 wherein the transparent region has a diameter between 1 millimeter and 4 millimeters.
Clause 145. The process of any one of clauses 136 to 144 wherein the central zone comprises an optical zone for the correction of refractive errors selected from the group consisting of myopia, hyperopia, presbyopia, and astigmatism.
Clause 146. A compound having the chemical structure depicted by Formula II:

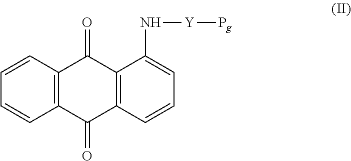

wherein Y is a linking group, and P_{g} is a polymerizable group.
Clause 147. The compound of clause 146 wherein Y is alkylene, oxaalkylene, alkyleneoxy, or combinations thereof.
Clause 148. The compound of any one of clauses 146 to 147 wherein the alkylene has between five and ten carbon atoms.
Clause 149. The compound of any one of clauses 146 to 147 wherein the oxaalkylene has between five and ten carbon atoms.
Clause 150. The compound of any one of clauses 146 to 147 wherein the alkyleneoxy is ethyleneoxy (CH₂CH₂O)ₚ and p is between three and six.
Clause 151. The compound of any one of clauses 146 to 150 wherein Pe comprises styryl, vinyl carbonate, vinyl ether, vinyl carbamate, N-vinyl lactam, N-vinylamide, (meth)acrylate, or (meth)acrylamide.
Clause 152. The compound of clause 151 wherein the compound is 2-(2-(2-((9,10-dioxo-9,10-dihydroanthracen-1-yl)amino) ethoxy) ethoxy)ethyl methacrylate, 5-((9,10-dioxo-9,10-dihydroanthracen-1-yl)amino) pentyl methacrylate, or 2-((9,10-dioxo-9,10-dihydroanthracen-1-yl)amino) ethyl methacrylate.
Clause 153. A compound having the chemical structure depicted by Formula VII:

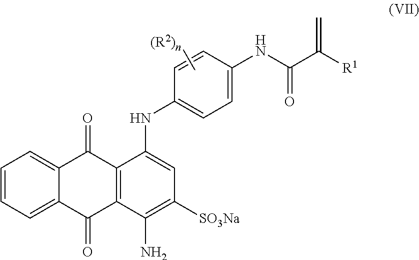

wherein R¹ is H or methyl, and wherein R₂ is independently at each occurrence C₁-C₆ alkyl, C₁-C₆ alkoxy, C₁-C₆ thioalkyl, C₃-C₇ cycloalkyl, aryl (preferably unsubstituted phenyl or phenyl substituted with alkyl or halo), benzyl, halo, hydroxy, amino, NR³R₄, wherein R³ and R₄ are independently H or C₁-C₆ alkyl, or two adjacent R₁ or R₂ groups, together with the carbon atoms to which they are attached, combine to form a cycloalkyl or aryl ring.
Clause 154. The compound of clause 153 wherein the compound is sodium 4-((4-acrylamidophenyl)amino)-1-amino-9,10-dioxo-9,10-dihydroanthracene-2-sulfonate, or sodium 1-amino-4-((4-methacrylamidophenyl)amino)-9,10-dioxo-9,10-dihydroanthracene-2-sulfonate.
Clause 155. A composition made by free radical polymerization of a reactive monomer mixture comprising any of the compounds of clauses 146 to 154.
Clause 156. The composition of clause 155 wherein the composition is a homopolymer, copolymer, block copolymer, graft copolymer, or polymeric network.
Clause 157. The composition of any of clauses 155 to 156 wherein the reactive monomer mixture further comprises a hydrophilic component, a silicone-containing component, a cross-linking agent, an initiator, or mixtures thereof.
Clause 158. The composition of clause 157 further comprising a visible light filtering compound selected from the group consisting of Formulae (I), (III), (V), (VI), and combinations thereof.
Clause 159. The composition of clause 158 wherein the composition is a hydrogel.
Clause 160. An ophthalmic device comprising any of the compositions of clauses 155 to 159.
Clause 161. The ophthalmic device of clause 160 wherein the ophthalmic device is selected from the group consisting of an intraocular lens, phakic intraocular lens, contact lens, corneal inlay, corneal outlay, or corneal insert.
Clause 162. The ophthalmic device of clause 161 wherein the ophthalmic device is a contact lens.

Some embodiments of the invention will now be described in detail in the following Examples.

### Test Methods

Ultraviolet-visible spectra of compounds in solution were measured on a Perkin Elmer Lambda 45, an Agilent Cary 6000i, or an Ocean Optics QE65 PRO (DH-2000-BAL Light Source) UV-VIS scanning spectrometer. The instrument was thermally equilibrated for at least thirty minutes prior to use. For the Perkin Elmer instrument, the scan range was 200-800 nm; the scan speed was 960 nm per minute; the slit width was 4 nm; the mode was set on transmission or absorbance; and baseline correction was selected. For the Cary instrument, the scan range was 200-800 nm; the scan speed was 600 nm/min; the slit width was 2 nm; the mode was transmission or absorbance; and baseline correction was selected. For the Ocean Optics instrument, the scan range was 200-800 nm; the slit width was 10 μm; the mode was transmission or absorbance; and baseline correction was selected. A baseline correction was performed before samples were analyzed using the autozero function.

Ultraviolet-visible spectra of contact lenses formed in part from the claimed compositions were measured on a Perkin Elmer Lambda 45 UV/VIS, an Agilent Cary 6000i, or an Ocean Optics UV-VIS scanning spectrometer using packing solution. The instrument was thermally equilibrated for at least thirty minutes prior to use. Baseline correction was performed using cuvettes containing plastic two-piece lens holders and the same solvents. These two-piece contact lens holders were designed to hold the sample in the quartz cuvette in the location through which the incident light beam traverses. The reference cuvette also contained a two-piece holder. To ensure that the thickness of the samples is constant, all lenses were made using identical molds. When noted, the center thickness of the contact lens was measured using an electronic thickness gauge, and the percent transmission spectra are obtained by averaging three individual lens data.

It is important to ensure that the outside surfaces of the cuvette are completely clean and dry and that no air bubbles are present in the cuvette. Repeatability of the measurement is improved when the reference cuvette and its lens holder remain constant and when all samples use the same sample cuvette and its lens holder, making sure that both cuvettes are properly inserted into the instrument.

To address some instrument and test method errors across the various apodised contact lenses, normalized UV-VIS transmission spectra (“Normalized % T” or “% T_{N}”) were generated from the measured UV-VIS transmission spectra by applying the following normalization factor or formula to the measured transmittance denoted at “T” for each wavelength between 200 and 800 nanometers to calculate the normalized transmittance denoted as “T_{N}” as shown in Equation 1:

$${T}_{N} = [ T - {T}_{min} ] \div [ {T}_{max} - {T}_{min} ] \qquad Equation 1$$

wherein Tₘᵢₙ is the minimum transmittance value between 300 and 800 nanometers, and Tₘₐₓ is the maximum transmittance value between 300 and 800 nanometers. UV-VIS spectra are usually plotted as percent transmission versus wavelength as shown in Equation 2:

$$\% {T}_{N} = 100 \times \{ [ T - {T}_{min} ] \div [ {T}_{max} - {T}_{min} ] \} \qquad Equation 2$$

The normalization factor is most easily applied to a spectral data table in Microsoft Excel before creating the spectral chart or spectrum.

The refractive index (“RI”) of a contact lens was measured by a Leica ARIAS 500 Abbe refractometer in manual mode or by a Reichert ARIAS 500 Abbe refractometer in automatic mode with a prism gap distance of 100 microns. The instrument was calibrated using deionized water at 20° C. (+0.2° C.). The prism assembly was opened, and the test lens was placed on the lower prism between the magnetic dots closest to the light source. If the prism was dry, a few drops of saline were applied to the bottom prism. The front curve of the lens was against the bottom prism. The prism assembly was then closed. After adjusting the controls so that the shadow line appeared in the reticle field, the refractive index was measured. The RI measurement was made on five test lenses. The average RI calculated from the five measurements was recorded as the refractive index as well as its standard deviation.

Water content was measured gravimetrically. Lenses were equilibrated in packing solution for 24 hours. Each of three test lenses are removed from packing solution using a sponge tipped swab and placed on blotting wipes which have been dampened with packing solution. Both sides of the lens are contacted with the wipe. Using tweezers, the test lens is placed in a tared weighing pan and weighed. Two more samples are prepared and weighed. All weight measurements were done in triplicate, and the average of those values used in the calculations. The wet weight is defined as the combined weight of the pan and wet lenses minus the weight of the weighing pan alone.

The dry weight was measured by placing the sample pans in a vacuum oven which has been preheated to 60° C. for 30 minutes. Vacuum was applied until the pressure reaches at least 1 inch of Hg; lower pressures are allowed. The vacuum valve and pump are turned off, and the lenses are dried for at least 12 hours, typically overnight. The purge valve is opened allowing dry air or dry nitrogen gas to enter. The oven is allowed reach atmospheric pressure. The pans are removed and weighed. The dry weight is defined as the combined weight of the pan and dry lenses minus the weight of the weighing pan alone. The water content of the test lens was calculated as follows: % water content=(wet weight-dry weight)/wet weight×100.

The average and standard deviation of the water content were calculated and the average value reported as the percent water content of the test lens.

Oxygen permeability (“Dₖ”) was determined by the polarographic method generally described in ISO 9913-1:1996 and ISO 18369-4:2006, but with the following modifications. The measurement was conducted at an environment containing 2.1% oxygen created by equipping the test chamber with nitrogen and air inputs set at the appropriate ratio, for example, 1800 mL/min of nitrogen and 200 mL/min of air. The t/Dₖ was calculated using the adjusted oxygen concentration. Borate buffered saline was used. The dark current was measured by using a pure humidified nitrogen environment instead of applying MMA lenses. The lenses were not blotted before measuring. Four lenses were stacked instead of using lenses of various thickness (t) measured in centimeters. A curved sensor was used in place of a flat sensor; radius was 7.8 mm. The calculations for a 7.8 mm radius sensor and 10% (v/v) air flow were as follows:

$${D}_{k} / t = ( measured current - dark current ) \times ( 2.97 \times 10 ‐ 8 mL {O}_{2} / ( μ A ‐ sec ‐ {cm}^{2} ‐ mm Hg )$$

The edge correction was related to the Dₖ of the material.

For all Dₖ values less than 90 barrers:

$$t / {D}_{k} ( edge corrected ) = ( 1 + ( 5 \text{.88} \times t ) ) \times ( t / {D}_{k} )$$

For Dₖ values between 90 and 300 barrers:

$$t / {D}_{k} ( edge corrected ) = ( 1 + ( 3 \text{.56} \times t ) ) \times ( t / {D}_{k} )$$

For Dₖ values greater than 300 barrers:

$$t / {D}_{k} ( edge corrected ) = ( 1 + ( 3 \text{.16} \times t ) ) \times ( t / {D}_{k} )$$

Non-edge corrected Dₖ was calculated from the reciprocal of the slope obtained from the linear regression analysis of the data wherein the x variable is the center thickness in centimeters and the y variable is the t/Dₖ value. On the other hand, edge corrected Dₖ (“EC Dₖ”) was calculated from the reciprocal of the slope obtained from the linear regression analysis of the data wherein the x variable is the center thickness in centimeters and the y variable is the edge corrected t/Dₖ value. The resulting Dₖ value was reported in barrers.

Wettability of lenses was determined by a modified Wilhelmy plate method using a calibrated Kruss K100 tensiometer at room temperature (23±4° C.) and using surfactant free borate buffered saline as the probe solution. All equipment must be clean and dry; vibrations must be minimal around the instrument during testing. Wettability is usually reported as the advancing contact angle (“Kruss DCA”). The tensiometer was equipped with a humidity generator, and temperature and humidity gages were placed in the tensiometer chamber. The relative humidity was maintained at 70±5%. The experiment was performed by dipping the lens specimen of known perimeter into the packing solution of known surface tension while measuring the force exerted on the sample due to wetting by a sensitive balance. The advancing contact angle of the packing solution on the lens is determined from the force data collected during sample dipping. The receding contact angle is determined from force data while withdrawing the sample from the liquid. The Wilhelmy plate method is based on the following formula: Fg=γρcosθ−B, wherein F=the wetting force between the liquid and the lens (mg), g=gravitational acceleration (980.665 cm/sec²), γ=surface tension of probe liquid (dyne/cm), p=the perimeter of the contact lens at the liquid/lens meniscus (cm), θ=the dynamic contact angle (degree), and B=buoyancy (mg). B is zero at the zero depth of immersion. Typically, a test strip was cut from the central area of the contact lens. Each strip was approximately 5 mm in width and 14 mm in length, attached to a metallic clip using plastic tweezers, pierced with a metallic wire hook, and equilibrated in packing solution for at least 3 hours. Then, each sample was cycled four times, and the results were averaged to obtain the advancing and receding contact angles of the lens. Typical measuring speeds were 12 mm/min. Samples were kept completely immersed in packing solution during the data acquisition and analysis without touching the metal clip. Values from five individual lenses were averaged to obtain the reported advancing and receding contact angles of the experimental lens.

Wettability of lenses was determined using a sessile drop technique using Kruss K100 TM instrument at room temperature and using deionized water as probe solution (“Sessile Drop”). The lenses to be tested were rinsed in deionized water to remove carry over from packing solution. Each test lens was placed on blotting lint free wipes which are dampened with packing solution. Both sides of the lens were contacted with the wipe to remove surface water without drying the lens. To ensure proper flattening, lenses were placed “bowl side down” on the convex surface of contact lens plastic molds. The plastic mold and the lens were placed in the sessile drop instrument holder, ensuring proper central syringe alignment. A 3 to 4 microliter drop of deionized water was formed on the syringe tip using DSA 100-Drop Shape Analysis software ensuring the liquid drop was hanging away from the lens. The drop was released smoothly on the lens surface by moving the needle down. The needle was withdrawn away immediately after dispensing the drop. The liquid drop was allowed to equilibrate on the lens for 5 to 10 seconds, and the contact angle was measured between the drop image and the lens surface. Typically, three to five lenses were evaluated, and the average contact angle was reported. The contact angles were measured on both the front and back surface of the lenses as denoted by front curve (“FC”) and base curve (“BC”) in the tables.

The mechanical properties of the contact lenses were measured by using a tensile testing machine such as an Instron model 1122 or 5542 equipped with a load cell and pneumatic grip controls. Minus one diopter lens is the preferred lens geometry because of its central uniform thickness profile. A dog-bone shaped sample cut from a minus one diopter spherical lens having a 0.522 inch length, 0.276 inch “ear” width and 0.213 inch “neck” width was loaded into the grips and elongated at a constant rate of strain of 2 inches per minute until it breaks. The center thickness of the dog-bone sample was measured using an electronic thickness gauge prior to testing. The initial gauge length of the sample (Lₒ) and sample length at break (L_{f}) were measured. At least five specimens of each composition were measured, and the average values were used to calculate the percent elongation to break: percent elongation=[(L_{f}-Lₒ)/Lₒ]×100. The tensile modulus was calculated as the slope of the initial linear portion of the stress-strain curve; the units of modulus are pounds per square inch or psi. The tensile strength was calculated from the peak load and the original cross-sectional area: tensile strength=peak load divided by the original cross-sectional area; the units of tensile strength are psi. Toughness was calculated from the energy to break and the original volume of the sample: toughness=energy to break divided by the original sample volume; the units of toughness are in-lbs/in³.

A calibrated dual interferometric method was used for measuring contact lens parameters in packing solution. These parameters included equivalent sphere power at multiple apertures (diopters or D), cylinder power at multiple apertures (diopters or D), diameter (millimeters or mm), center thickness (millimeters or mm), sagittal height (millimeters or mm), and root mean squared (RMS) optical path wavefront deviation from lens design target in micrometers or microns (μm) with sphere/cylinder power and coma removed as measured using a 6.5 millimeter aperture. The instrument consists of a custom, propitiatory interferometer for the measurement of wavefront parameters and a Lumetrics OptiGauge® II low-coherence interferometer for the measurement of the dimensional parameters of sagittal height and center thickness. The two individual instruments combined are similar to Lumetrics Clearwave™ Plus, and the software is similar to Lumetrics OptiGauge Control Center v7.0 or higher. With the Clearwave™ Plus, a camera is used to find the lens edge, and then the lens center is calculated, which is then used to align a 1310 nanometer interferometer probe at the lens center for the measurement of sagittal height and center thickness. The transmitted wavefront is also collected in series using a wavefront sensor (shack-Hartmann sensor). Multiple parameters from the transmitted wavefront of the contact lens are measured, and others are calculated from those measurements.

From the data collected, difference terms are calculated by comparing the measured values from the target. These include root mean squared optical path wave front deviation from lens design target in μm (sphere/cylinder power and coma deviation removed) as measured using a 6.5 millimeter aperture (RMS_65), the second equivalent sphere power deviation from lens design target in diopters (D) as measured using a 5 millimeter aperture (PW2EQD), deviation from lens design target diameter in mm (DMD), deviation from lens design target base curve radius as calculated from the measured sagittal height and target lens diameter according to ISO 18369-3 in mm (BCD), and deviation from lens design target center thickness in mm (CTD).

The following abbreviations will be used throughout the Examples and Figures and have the following meanings:
L: liter(s)
mL: milliliter(s)
Equiv. or eq.: equivalent
kg: kilogram(s)
g: gram(s)
mg: milligram(s)
mol: mole(s)
mmol: millimole(s)
M: molar
mM: millimolar
Da: dalton or g/mole
kDa: kilodalton or an atomic mass unit equal to 1,000 daltons
min: minute(s)
sec: second(s)
mm: millimeter(s)
cm: centimeter(s)
μm: micrometer(s)
nm: nanometer(s)
λ: wavelength
wt. %: weight percent
Cmpd: compound
TLC: thin layer chromatography
¹H NMR: proton nuclear magnetic resonance spectroscopy
UV-VIS: ultraviolet-visible spectroscopy
HEV: high energy visible (light)
LED: light emitting diode
mW: milliwatts
AU: absorbance units
% T: percent transmission
BC: base curve plastic mold
FC: front curve plastic mold
PP: polypropylene which is the homopolymer of propylene
TT: Tuftec which is a hydrogenated styrene butadiene block copolymer (Asahi Kasei Chemicals)
Z: Zeonor which is a polycycloolefin thermoplastic polymer (Nippon Zeon Co Ltd)
RMM: reactive monomer mixture(s)
DMA: N, N-dimethylacrylamide (Jarchem)
HEMA: 2-hydroxyethyl methacrylate (Bimax)
PVP K90: poly(N-vinylpyrrolidone) (ISP Ashland)
EGDMA: ethylene glycol dimethacrylate (Esstech)
TEGDMA: tetraethylene glycol dimethacrylate (Esstech)
Tegomer MA: bis-3-methacryloxy-2-hydroxypropyloxypropyl polydimethylsiloxane (Mₙ=2000 grams/mole, n=20) (Shin Etsu)

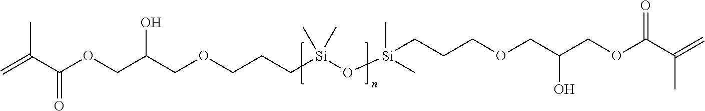

Omnirad 1870: blend of bis(2,6-dimethoxybenzoyl)-2,4,4-trimethyl-pentylphosphineoxide and 1-hydroxy-cyclohexyl-phenyl-ketone (IGM Resins or BASF or Ciba Specialty Chemicals)
AIBN: azobisisobutyronitrile [CAS 78-67-1]
mPDMS: mono-n-butyl terminated monomethacryloxypropyl terminated polydimethylsiloxane (Mₙ=800-1500 daltons) (Gelest)
HO-mPDMS: mono-n-butyl terminated mono-(2-hydroxy-3-methacryloxypropyloxy)-propyl terminated polydimethylsiloxane (Mₙ=400 to 1400 grams/mole) (Ortec or DSM-Polymer Technology Group)
OH-mPDMS (n=4):

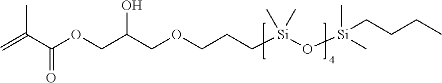

OH-mPDMS (n=15) which is an oligomeric macromer having a number average degree of polymerization DP=15:

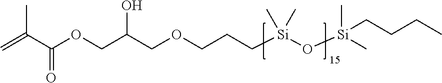

SiMAA: 2-propenoic acid, 2-methyl-2-hydroxy-3-[3-[1,3,3,3-tetramethyl-1-[(trimethylsilyl)oxy]disiloxanyl]ₚ ropoxy]ₚ ropyl ester (Toray) or 3-(3-(1,1,1,3,5,5,5-heptamethyltrisiloxan-3-yl) propoxy)-2-hydroxypropyl methacrylate
Norbloc: 2-(2′-hydroxy-5-methacrylyloxyethylphenyl)-2H-benzotriazole (Janssen)
IMT Blue: sodium 1-amino-4-((4-(2-bromoacrylamido)-2-sulfonatophenyl)amino)-9,10-dioxo-9,10-dihydroanthracene-2-sulfonate

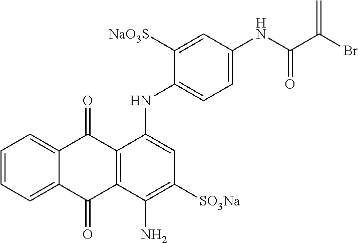

RB246: (((9,10-dioxo-9,10-dihydroanthracene-1,4-diyl)bis(azanediyl)) bis(4,1-phenylene))bis(ethane-2,1-diyl)bis(2-methylacrylate)

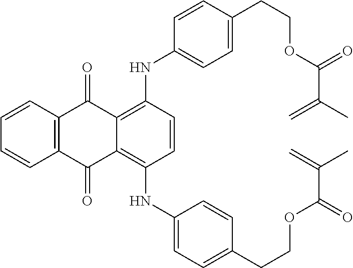 [SMILES: C=C(C)C(=O)OCCc1ccc(Nc2ccc(Nc3ccc(CCOC(=O)C(=C)C)cc3)c3c2C(=O)c2ccccc2C3=O)cc1]

RB247: 1,4-bis [2-methacryloxyethylamino]-9,10-anthraquinone

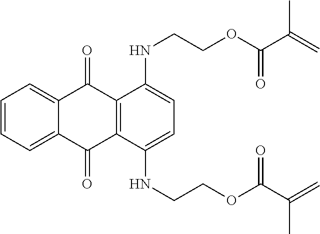 [SMILES: C=C(C)C(=O)OCCNc1ccc(NCCOC(=O)C(=C)C)c2c1C(=O)c1ccccc1C2=O]

### Compound B: 2-(2-cyano-2-(2-methoxy-10-butylacridin-9 (10H)-ylidene) acetamido)ethyl methacrylate

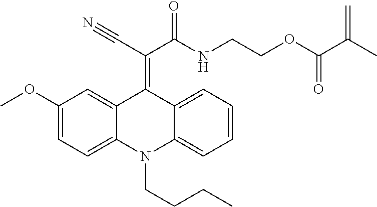 [SMILES: C=C(C)C(=O)OCCNC(=O)/C(C#N)=C1\c2ccccc2N(CCCC)c2ccc(OC)cc21]

### Compound C: 2-(2-cyano-2-(9H-thioxanthen-9-ylidene) acetamido)ethyl methacrylate (prepared as described in US20210061934)

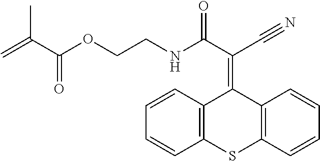 [SMILES: C=C(C)C(=O)OCCNC(=O)C(C#N)=C1c2ccccc2Sc2ccccc21]

### Compound D: 3-((9-(dicyanomethylene)-9H-xanthen-3-yl)oxy) propyl methacrylate

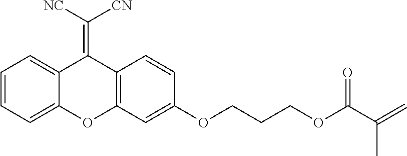 [SMILES: C=C(C)C(=O)OCCCOc1ccc2c(c1)Oc1ccccc1C2=C(C#N)C#N]

D30: 3,7-dimethyl-3-octanol (Vigon)
DIW: deionized water
NPA: n-propanol or 1-propanol or 1-propyl alcohol
IPA: isopropyl alcohol
PG: 1,2-propanediol or 1,2-propylene glycol
DMF: dimethylformamide
CDCl₃: deutrochloroform
HCl: hydrochloric acid
PS: Borate Buffered Packing Solution: 18.52 grams (300 mmol) of boric acid, 3.7 grams (9.7 mmol) of sodium borate decahydrate, and 28 grams (197 mmol) of sodium sulfate were dissolved in enough deionized water to fill a 2-liter volumetric flask.

### Example 1-Synthesis of 2-(2-cyano-2-(2-methoxy-10-propylacridin-9 (10H)-ylidene) acetamido)ethyl methacrylate (Compound A) as shown in Scheme 1

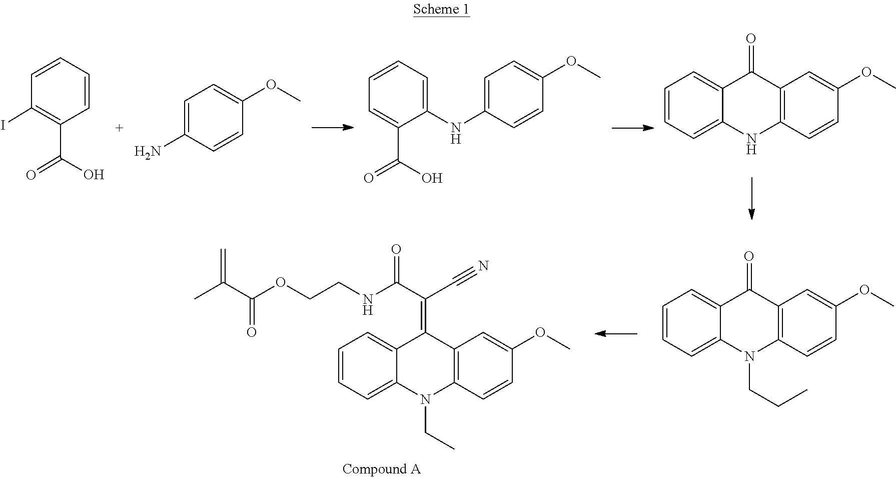

2-Iodobenzoic acid (12.40 g, ˜ 0.05 mol), 12.32 g of 4-methoxyaniline (˜ 2 eq.), 6.91 g of anhydrous potassium carbonate (˜0.05 mol), and 300 mg of copper powder (4.76 mmol) were charged in a 100 mL, 3 neck round bottom flask equipped with a magnetic stir bar and reflux condenser. Deionized water (30 mL) was added to the mixture of solids, and the system heated at reflux for 6 hours with constant stirring. The mixture solidified upon cooling to room temperature. The system was diluted with deionized water and gradually poured into 1 normal aqueous hydrochloric acid with stirring. The mixture was stirred at room temperature for 30 minutes, after which it was filtered over a fritted glass funnel and dried in a vacuum oven at 60° C. The residue 2-((4-methoxyphenyl)amino)benzoic acid was washed with 3×100 mL of deionized water and used “as is” for the intramolecular cyclization. 1H NMR (CDCl₃)−δ3.81 (3H, s), 6.66 (1H, t), 6.89-6.93 (3H, m), 7.16 (2H, d), 7.27 (1H, t), 7.99 (1H, d), 9.12 (1H, bs)

A 250 mL round bottom flask equipped with a magnetic stir bar and reflux condenser was charged with 12.5 g of 2-((4-methoxyphenyl)amino)benzoic acid and 100 mL of Eaton's acid (10 weight % P₂O₅ in methanesulfonic acid). The mixture was heated with constant stirring at 90° C. (mantle temperature) for 5 hours, while monitoring the progress by TLC. Upon cooling to room temperature, the reaction mixture was poured over ice, stirred for 30 minutes, and filtered over a fritted glass funnel. The residue 2-methoxyacridin-9 (10H)-one was washed with 3×100 mL of deionized water, followed by acetonitrile, and dried in a vacuum oven at 60° C. 1H NMR (DMSO d6)−δ 3.86 (3H, s), 7.23 (1H, t), 7.41 (1H, dd), 7.52 (1H, d), 7.53 (1H, d), 7.63 (1H, d), 7.70 (1H, dt), 8.23 (1H, d)

A 250 mL round bottom flask equipped with a magnetic stir bar and reflux condenser was charged with 5.4 g of 2-methoxyacridin-9 (10H)-one (0.0244 mole) and 12.9 g of cesium carbonate (˜1.5 cq.). The solids were dried under vacuum at 80° C., after which the system was placed under a nitrogen blanket and 80 mL of anhydrous N,N-dimethylformamide was added to the flask. 1-bromopropane (6.0 g, ˜ 2 eq.) was added to the flask, and the mixture was heated at 50° C. (mantle temperature) for 36 hours. TLC indicated the presence of two compounds (O-alkylation and N-alkylation). The organics were poured into 200 mL of deionized water and extracted into ˜ 150 mL of ethyl acetate. The organics were then washed with 3×100 ml of water, followed by 3×100 mL of dilute aqueous HCl to remove the O-alkylated acridine byproduct, and a final deionized water wash. TLC of the organics indicated a single compound present at this point, namely 2-methoxy-10-propylacridin-9 (10H)-one, which was dried under reduced pressure and used for the subsequent transformation. 1H NMR (CDCl₃)−δ 1.12 (3H, t), 1.93 (2H, m), 4.28 (2H, dd), 7.25 (1H, ddd), 7.35 (1H, dd), 7.45 (1H, dd), 7.66 (1H, m), 7.96 (1H, d), 7.57 (1H, dd).

A 250 mL, three neck round bottom flask equipped with a magnetic stir bar and reflux condenser was charged with 4.5 g of 2-methoxy-10-propylacridin-9 (10H)-one (0.017 mole) and 6.4 g of N-2-methacryloxyethyl-2-cyanoacetamide (0.033 mole). The system was placed under a nitrogen blanket, and 20 mL of dichloromethane was added to the mixture and stirred until homogeneous. After cooling the system in an ice bath, titanium tetrachloride (4.5 mL, 7.78 g, 0.041 mole) was added to the mixture in a dropwise fashion and stirring continued for an additional 15 minutes. Pyridine 5 mL (4.9 g, 0.06 mole) was added to the mixture, which was allowed to warm up to ambient temperature and then heated to reflux for 8 hours. After cooling the mixture to room temperature, it was poured over dilute aqueous HCl, and the product mixture was extracted into dichloromethane. Volatiles were evaporated under reduced pressure, and the product Compound A was purified by flash chromatography. 1H NMR (CDCl₃)−δ 1.07 (3H, t), 1.87 (3H, s), 1.91 (2H, m), 3.58 (2H, dd), 3.85 (3H, s), 4.07 (2H, dd), 4.18 (2H, t), 5.5 (1H, dd), 6.03 (1H, ss), 6.07 (1H, t), 7.07 (1H, t), 7.14 (1H, dd), 7.23 (2H, two doublets), 7.48 (1H, m), 7.92 (1H, bs).

### Example 2-Synthesis of 2-(2-cyano-2-(2-methoxy-10-butylacridin-9 (10H)-ylidene) acetamido)-ethyl methacrylate (Compound B) as shown in Scheme 2

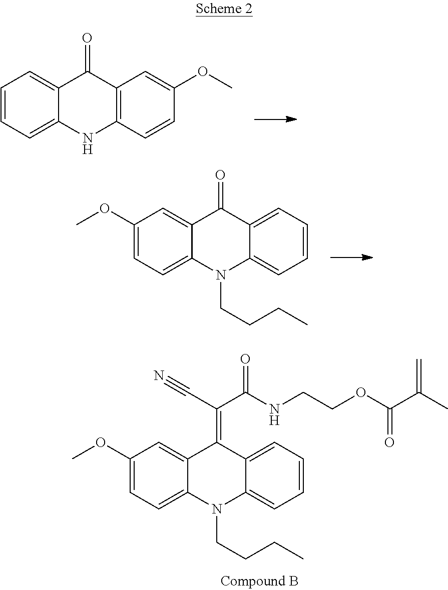

A 200 mL round bottom flask equipped with a magnetic stir bar and reflux condenser was charged with 10.0 g of 2-methoxyacridin-9 (10H)-one (0.044 mole) and 19.6 g of cesium carbonate (˜1.25 eq.). The solids were dried under vacuum at 80° C., after which the system was placed under a nitrogen blanket, and 60 mL of anhydrous DMSO was added to the flask. 1-bromobutane (7.55 g, ˜ 1.25 eq.) was added to the flask, and the mixture was heated at 110° C. (mantle temperature) for 6 hours. Two products, very close in retention factor and inseparable by chromatography, were observed by TLC. The cooled suspension was poured over 500 mL of deionized water, and the mixture was stirred for 30 minutes at room temperature. The organics were extracted into ethyl acetate and washed with 3×200 mL of deionized water. NMR of the organics indicated the presence of the O-alkylated acridine derivative in addition to the desired compound, 2-methoxy-10-butylacridin-9 (10H)-one. This material can be used “as is” for the Knoevenagel condensation. Preferably, the crude product was washed with dilute aqueous HCl to remove the O-alkylated acridine derivative, resulting in pure 2-methoxy-10-butylacridin-9 (10H)-one. 1H NMR (CDCl₃)−δ 1.05 (3H, t), 1.55 (2H, m), 1.82 (2H, m), 4.31 (2H, dd), 7.25 (1H, ddd), 7.34 (1H, dd), 7.45 (1H, dd), 7.68 (1H, m), 7.96 (1H, d), 8.56 (1H, dd).

A 250 mL, three neck round bottom flask equipped with a magnetic stir bar and reflux condenser was charged with 10.0 of the crude product mixture containing 2-methoxy-10-butylacridin-9 (10H)-one and 15 g of N-2-methacryloxyethyl-2-cyanoacetamide. The system was placed under a nitrogen blanket, 150 mL of dichloromethane was added to the mixture and stirred until homogeneous. After cooling the system in an ice bath, titanium tetrachloride (10 mL, 17.3 g, 1.092 mole) was added to the mixture in a dropwise fashion and stirring continued for an additional 15 minutes. Pyridine 10 mL (9.82 g, 0.12 mole) was added to the mixture, which was allowed to warm up to ambient temperature and then heated to reflux for 8 hours.

TLC indicated the presence of several compounds including the unreacted O-alkylated derivative present in the starting material mixture. The major product, Compound B, was a slightly more polar, dark brownish orange species, which was isolated after quenching the system in dilute aqueous HCl, followed by aqueous extractions, and chromatography. 1H NMR (CDCl₃) −δ 1.04 (3H, t), 1.51 (2H, m), 1.87 (3H, s, 2H, m), 3.58 (2H, dd), 3.84 (3H, s), 4.12 (2H, dd), 4.19 (2H, t), 5.55 (1H, dd), 6.03 (1H, bs), 6.07 (1H, t), 7.07 (1H, t), 7.15 (1H, dd), 7.25 (2H, two doublets), 7.48 (1H, t), 7.75 (1H, bs), 7.92 (1H, bs).

An alternative Synthesis of Compound B is shown in Scheme 3

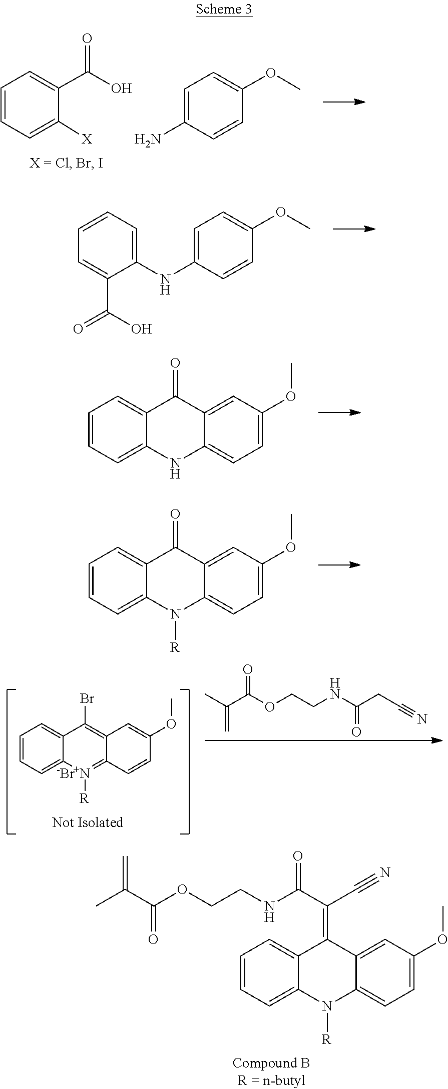

Synthesis of 2-(2-(10-butyl-2-methoxyacridin-9 (10H)-ylidene)-2-cyanoacetamido)ethyl methacrylate or Compound B when R is n-butyl: A 3 neck 500 mL RBF equipped with a magnetic stir bar and a reflux condenser was charged with 9.43 g of triphenylphosphine (36 mmol) and 120 mL of anhydrous dichloromethane. Bromine (5.76 g, 33 mmol) was added dropwise to the solution, which was stirred at room temperature for an additional 30 minutes, after which, 10-butyl-2-methoxyacridin-9 (10H)-one (8.43 g, 30 mmol) was added to the mixture and heated to reflux for 18 hours. 2-(2-cyanoacetamido)ethyl methacrylate (8.23 g, 36 mmol, 1.4 eq.) was added to the reaction mixture which was heated and stirred for an additional 8 hours. Very little starting material was observed at this point by TLC and an orange-brown compound was observed at the baseline. The mixture was cooled to room temperature, 150 mL of aqueous sodium carbonate (˜10.6 g, 100 mmol dissolved Na2CO₃) was added and the mixture stirred for 30 minutes. Treatment with base resulted in the desired compound. The aqueous layer was extracted with additional dichloromethane. The organics were removed under reduced pressure, and the product purified by chromatography. The crude material was first flushed through silica gel using dichloromethane and ethyl acetate to remove the polar components. Then, a second pass using ethyl acetate/hexanes or diethyl ether/hexanes after loading the material with a minimal amount of methylene chloride provided the desired product in yields >80%.

Select absorbance properties of Compounds A and B are shown in Table 1.

TABLE 1

| | λₘₐₓ | | | | Extinction | |
|---|---|---|---|---|---|---|
| | wavelength | | Pathlength | Concentration | Coefficient | FWHM¹ |
| Cmpd | (nm) | Abs | (cm) | (M) | (M⁻¹cm⁻¹) | (nm) |
| A | 463 | 1.312186 | 1 | 0.0001 | 13121.86 | 64 |
| B | 464 | 1.261670 | 1 | 0.0001 | 12616.70 | 62 |

¹Full width half maximum (FWHM) at λₘₐₓ

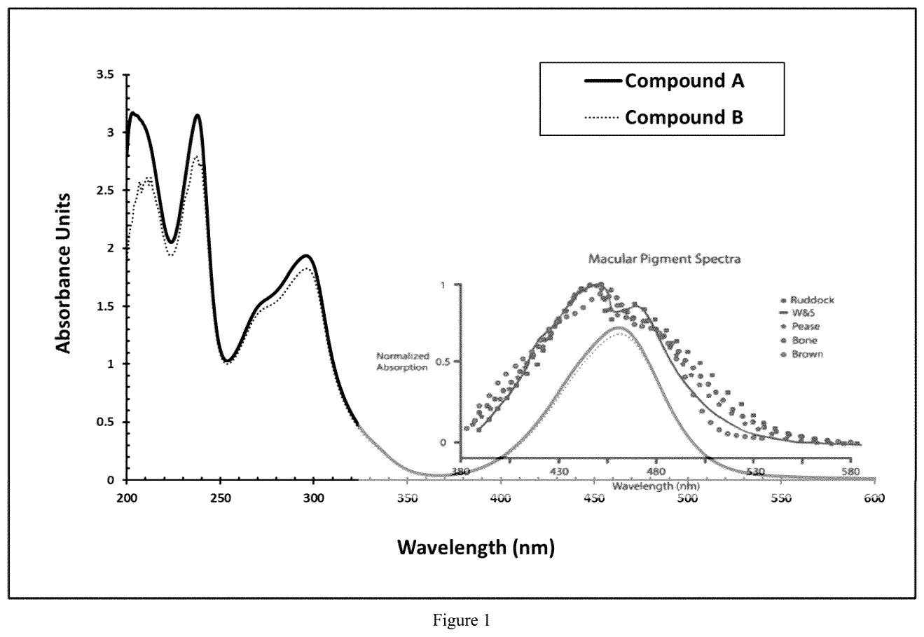

The UV-VIS absorbance spectra of 0.1 mM methanolic solutions of Compound A and Compound B are shown in FIG. 1 and are superimposed on the literature spectrum of macular pigment.

### Example 3-Synthesis of 2-(2-cyanoacetamido)ethyl methacrylate (A) and 2-(2-cyano-2-(9H-thioxanthen-9-ylidene) acetamido)ethyl methacrylate as shown in Scheme 4

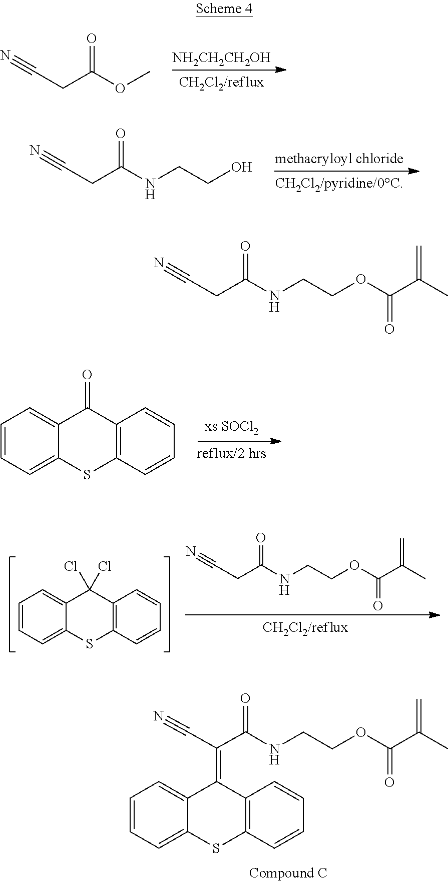

Methyl cyanoacetate (40 grams, 0.4037 mole) and 25 mL of dichloromethane were stirred in a 3 neck, 500 mL round bottom flask under equipped with a reflux condenser under a nitrogen environment. 2-aminoethanol (23.8 grams, 0.3897 mole, ˜0.97 eq.) was added to the solution via an addition funnel, after which the temperature rose and the methylene chloride began to reflux. After the exotherm ceased, external heat was applied to continue a gentle reflux for a total of two hours, after which no ethanolamine was observed by thin layer chromatography.

The reaction may also be conducted at room temperature and is complete within a few hours.

The mixture was cooled to room temperature and all the methylene chloride was evaporated at reduced pressure. The residual oil was washed three times with 50 mL of ethyl acetate to remove unreacted starting material and non-polar impurities. The residual ethyl acetate was then removed under reduced pressure, and the resulting oil was used for acylation without any further purification.

The crude N-2-hydroxyethylacetamide derivative was dissolved in 150 mL of dichloromethane containing 40 grams of pyridine (˜ 0.5 mole) in a three-neck round bottom flask equipped with a reflux condenser, an addition funnel, and a magnetic stirring bar. The flask was immersed in an ice bath and allowed to cool down to around 0° C. Methacryloyl chloride (45.76 grams, ˜0.44 mole) was added dropwise from the addition funnel, and the resulting reaction mixture was allowed to warm up to room temperature while constantly stirring the system. Methanol (20 mL) was the added to the flask to quench any unreacted methacryloyl chloride. The volatile components were removed by rotary evaporation under reduced pressure, and the crude product dissolved in 800 mL of dilute aqueous HCl. The resulting aqueous solution was extracted three times with 100 mL of hexanes in a separatory funnel to remove any non-polar impurities. The organic layers were discarded. Sodium chloride was added to the aqueous layer which was then extracted three times with 300 mL of ethyl acetate. About 50 milligrams of BHT were added to the combined organic fractions as an inhibitor, and the ethyl acetate removed by rotary evaporation under reduced pressure. The crude product crystalized out of solution during solvent removal. When about 100 mL of ethyl acetate was left in the flask, 250 mL of hexanes was added, and the crude product was isolated by vacuum filtration using a fritted glass funnel. Thin layer chromatography indicated the presence of a single compound. The filter cake was washed two times with 150 mL of hexanes and then vacuum dried at 40° C., yielding 53 grams (about 70% yield) of 2-(2-cyanoacetamido)ethyl methacrylate (A). 1H NMR (500 MHz, CDCl₃) δ 1.93 (3H, s, CH₃), 3.36 (2H, s, CNCH₂), 3.60 (2H, dd, CH₂NH), 4.26 (2H, t, CH₂OC═O), 5.59 (1H, m, vinylic), 6.11 (1H, bs, vinylic), 6.52 (1H, bs, NH).

A mixture of 9H-thioxanthene-9-one (2.12 grams, 0.01 mole) and thionyl chloride (5 mL, 8.2 grams, ˜0.07 mole) was refluxed in a 50 mL round bottom flask under a nitrogen atmosphere with constant stirring. After two hours, the red solution was evaporated to dryness ensuring that all unreacted thionyl chloride was removed from the system. 2-(2-Cyanoacetamido)ethyl methacrylate (A) (2.3 grams, 0.0117 mole, ˜1.17 eq.) and 15 mL of dichloromethane were added, and the resulting reaction mixture was heated to reflux under a nitrogen blanket. The reaction was monitored by thin layer chromatography. After two hours, no changes were observed in the chromatogram, so the reactive mixture was allowed to cool down to room temperature. 2-(2-cyano-2-(9H-thioxanthen-9-ylidene) acetamido)ethyl methacrylate (B) was isolated as yellow crystals (3.2 grams, 82% yield) after passing through a short silica gel column (CH₂Cl₂, followed by 8 weight % EtOAc in CH₂Cl₂). The UV-VIS transmission spectrum of a 0.2 mM methanol solution Compound B is shown in FIG. 1. ¹H NMR (500 MHz, CDCl₃) δ 1.84 (3H, s, CH₃), 3.47 (2H, m, CH₂NH), 4.01 (2H, t, CH₂OC═O), 5.55 (1H, m, vinylic), 5.91 (1H, bs, NH), 5.98 (1H, bs, vinylic), 7.24 (1H, t, Ar—H), 7.31 (1H, t, Ar—H), 7.39 (2H, m, Ar—H), 7.49 (1H, d, Ar—H), 7.55 (1H, m, Ar—H), 7.61 (1H, d, Ar—H), 8.04 (1H, m, Ar—H).

### Example 4. Synthesis of 3-((9-(dicyanomethylene)-9H-xanthen-3-yl)oxy) propyl methacrylate (Compound D) as shown in Scheme 5

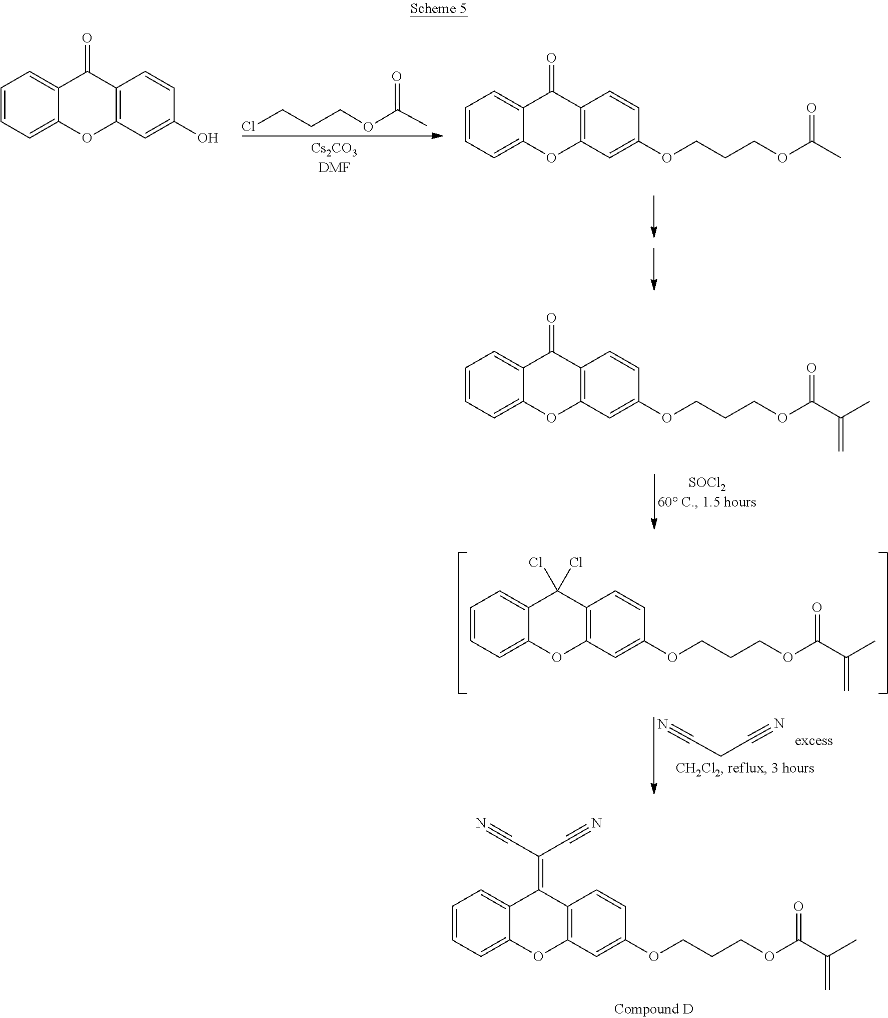

### Synthesis of 3-((9-oxo-9H-xanthen-3-yl)oxy) propyl acetate

A suspension of 3-hydroxy-9H-xanthen-9-one (42.4 grams, 0.2 mole), 70.0 grams Cs₂CO₃ (0.2 mole), and sodium iodide (catalytic 200 milligrams) were dried under vacuum in a 500 mL round bottom flask containing a magnetic stirring bar. Anhydrous DMSO (250 mL) was added followed by 2-chloroethyl methacrylate (30.0 grams, 0.2 mole). The reaction mixture was heated overnight at 70° C. Monitoring by TLC indicated complete consumption of the hydroxyxanthenone along with the formation of a less polar derivative. The reaction mixture was cooled to room temperature and slowly poured into dilute aqueous hydrochloric acid with constant stirring. After stirring for thirty minutes, the off-white solids were isolated by vacuum filtration using a fritted glass funnel. The filter cake was washed with deionized water, followed by two washes with 200 mL of hexanes. The 3-((9-oxo-9H-xanthen-3-yl)oxy) propyl acetate was vacuum dried at 60° C. to constant weight.

### Synthesis of 3-((9-oxo-9H-xanthen-3-yl)oxy) propyl alcohol

27 grams of 3-((9-oxo-9H-xanthen-3-yl)oxy) propyl acetate was stirred in about 700 mL of methanol at room temperature, during which 20 mL of 10 N aqueous sodium hydroxide solution was added to the mixture, followed by about 30 mL of deionized water. Monitoring by TLC indicated that the hydrolysis reaction was complete within a few minutes. The mixture was slowly acidified by addition of dilute aqueous hydrochloride acid, after which 150 mL of deionized water was added while constantly stirring the system. The 3-((9-oxo-9H-xanthen-3-yl)oxy) propyl alcohol was isolated by vacuum filtration using a fritted glass funnel, washed with additional amounts of water, and finally dried in a vacuum oven at 60° C.

### Synthesis of 3-((9-oxo-9H-xanthen-3-yl)oxy) propyl methacrylate

25 grams of 3-((9-oxo-9H-xanthen-3-yl)oxy) propanol and 15 mL (10.89 grams) of triethylamine were stirred in 300 mL of anhydrous acetonitrile in a three neck, one liter round bottom flask equipped with a magnetic stirring bar and a reflux condenser. Methacryloyl chloride (9.9 grams) was added to the flask in a dropwise fashion, and mixture was stirred for an hour. The volatile components were evaporated under reduced pressure, and the resulting solids were washed and filtered over a fritted glass funnel and rinsed with deionized water. The residue was washed further with dilute aqueous hydrochloric acid, followed by additional washes with deionized water and finally washed with hexanes. The 3-((9-oxo-9H-xanthen-3-yl)oxy) propyl methacrylate was then dried in a rotary evaporator with bath temperature maintained below 20° C.

### Synthesis of 3-((9-(dicyanomethylene)-9H-xanthen-3-yl)oxy) propyl methacrylate (Compound D)

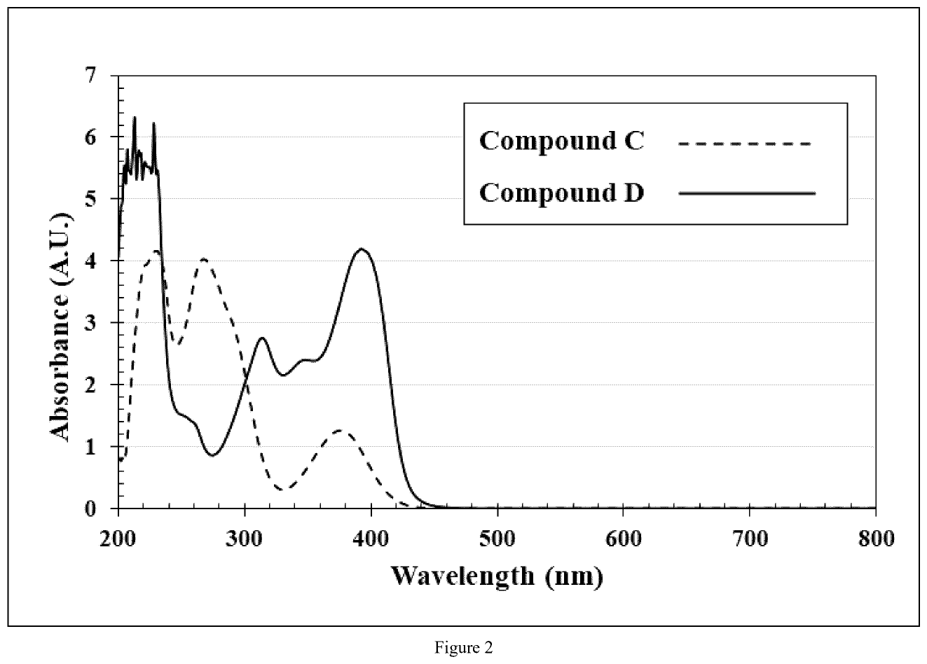

6.76 grams of 3-((9-oxo-9H-xanthen-3-yl)oxy) propyl methacrylate and 15 mL of thionyl chloride were heated for 2 hours at 65° C. (mantle temperature) in a round bottom flask equipped with a magnetic stirring bar and reflux condenser. The mixture was cooled to room temperature, and the excess thionyl chloride was evaporated under reduced pressure with the bath temperature maintained below 20° C. 3.96 grams of malononitrile was added to the flask, followed by 25 mL of anhydrous dichloromethane, and the mixture was stirred and heated at a gentle reflux for two hours. The mixture was cooled to room temperature and then flushed through a short silica gel plug eluting with methylene chloride. Volatile components were evaporated under reduced pressure with the temperature maintained below 20° C., after which the solids were suspended in cold methanol (100 mL) and stirred for 20 minutes. The crude product was isolated by vacuum filtration and the filter cake washed with additional cold methanol. 3-((9-(dicyanomethylene)-9H-xanthen-3-yl)oxy) propyl methacrylate was further purified by passing through a silica gel column eluting with methylene chloride. 1H NMR (500 MHz, CDCl₃)−δ 1.95 (3H, CH₃), 2.25 (2H, m, CH₂), 4.20 (2H, t, CH₂ benzylic), 4.37 (2H, t, CH₂O ester), 5.59 (1H, m, vinylic), 6.12 (1H, m, vinylic), 6.90 (1H, dAr-H), 6.97 (1H, dd, Ar—H), 7.40 (1H, ddd, Ar—H), 7.45 (1H, dd, Ar—H), 7.68 (1H, ddd, Ar—H), 8.50 (1H, d, Ar—H), 8.57 (1H, dd, Ar—H). The UV-VIS absorbance spectra of Compounds C and D in 0.2 mM in methanol are shown in FIG. 2. Compound D exhibited a molar extinction coefficient of 19,341 L·mol-1·cm⁻¹ as calculated at lambda max Amax=396 nanometers in 0.2 mM dichloromethane.

### Example 5. Synthesis of (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate) as shown in Scheme 6

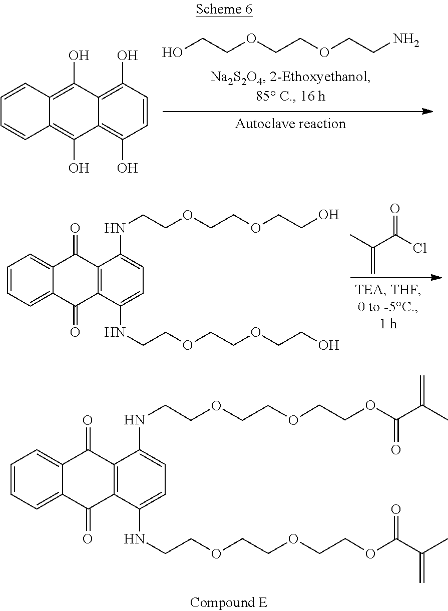

Anthracene-1,4,9,10-tetraol (75 grams, 0.3096 moles), 2-ethoxy ethanol (225 mL), 2-(2-(2-aminoethoxy) ethoxy) ethan-1-ol (161.58 grams, 1.083 moles), and sodium dithionite (107.81 grams, 0.6192 moles) were added into autoclave chamber under a nitrogen atmosphere at an ambient temperature. Reaction mixture was vigorously stirred for 16 hours at 85° C. under 5 kilograms of nitrogen gas pressure. Progress of reaction was monitored by thin layer chromatography (5% methanol in dichloromethane). Upon completion of reaction, reaction mixture was cooled to ambient temperature. Dichloromethane (2000 mL) and deionized water (1000 mL) were added, and the reactive mixture was stirred for 5-7 minutes. The organic layer was separated, and the aqueous layer was extracted with dichloromethane (500 mL). The combined organic extracts were washed with water (2×1000 mL) and brine (2×1000 mL). Activated charcoal (75 grams) was added into organic layer and stirred overnight at room temperature. The activated charcoal was removed by filtration through celite and washed with dichloromethane (3000 mL). The filtrate was dried over sodium sulphate and filtered. The solvent was removed under reduced pressure to afford a crude mass of 1,4-bis((2-(2-(2-hydroxyethoxy) ethoxy)ethyl)amino) anthracene-9,10-dione (126 grams). The crude product was stirred in ethyl acetate (1000 mL) for one hour at 60° C. followed by stirring for 14-16 hours at an ambient temperature. The solid was filtered and washed with ethyl acetate (300 mL), and the residue was air dried for 14-16 hour at 45° C. to afford 1,4-bis((2-(2-(2-hydroxyethoxy) ethoxy)ethyl)amino) anthracene-9,10-dione (100.0 grams; yield=64%) as a blue solid. 1H-NMR (DMSO-d⁶, 400 MHz): δ 3.70-3.45 (m, 24H), 7.51 (s, 2H), 7.78 (m, 2H), 8.25 (m, 2H), 10.89 (br s, 2H).

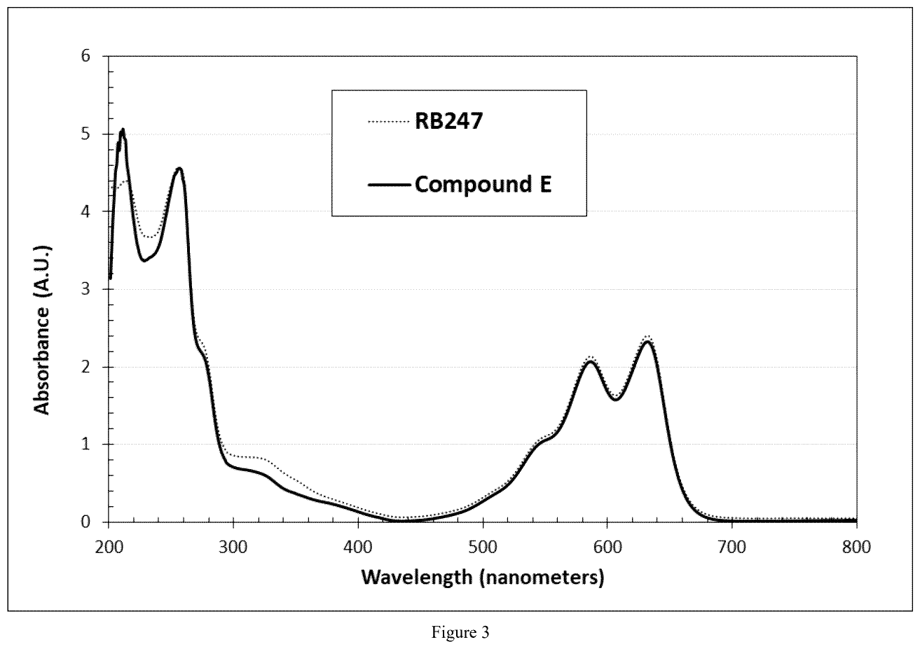

To a solution of 1,4-bis((2-(2-(2-hydroxyethoxy) ethoxy)ethyl)amino) anthracene-9,10-dione (75.0 grams, 0.1493 moles) in tetrahydrofuran (1500 mL) was added triethylamine (302.1 grams, 414.97 mL, 2.9866 moles) at an ambient temperature. After 15 minutes of stirring, a solution of methacryloyl chloride (62.43 grams, 58.35 mL, 0.5973 moles) in tetrahydrofuran (150 mL) was added dropwise while maintaining the reaction temperature between 0° and −5° C. The reaction mixture was stirred for 1 hour at 0 to −5° C., and progress of the reaction was monitored by thin layer chromatography (5% methanol in dichloromethane). Upon completion of reaction, ethyl acetate (3000 mL) and deionized water (2000 mL) were added at 10-15° C., and reaction mixture was stirred for 8-10 minutes. The organic layer was separated, and the aqueous layer was extracted with ethyl acetate (3×1000 mL). The combined organic extracts were washed with deionized water (4×2000 mL) and brine (1000 mL), dried over sodium sulphate, and filtered. The solvents were removed under reduced pressure to afford a crude product (86 grams) which was then purified by column chromatography using 230-400 mesh size silica gel (2.8 kg), eluted with 0.1-0.5% methanol in dichloromethane to yield (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate) or Compound E as blue solid (22 grams; yield=23%). 1H-NMR (DMSO-d6, 400 MHz): δ 1.83 (s, 6H), 4.20-4.16 (m, 20H), 4.21 (m, 4H), 5.62 (s, 2H), 5.98 (s, 2H), 7.5 (s, 2H), 7.77 (m, 2H), 8.23 (m, 2H), 10.87 (t, 2H, J=5.2, 5.6 Hz). The UV-VIS absorption spectra of (9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl)bis(2-methyl acrylate) labeled as Compound E as well as 1,4-bis [2-methacryloxyethylamino]-9,10-anthraquinone known as RB247 in 0.2 mM methanol solutions are shown in FIG. 3.

### Example 6. Synthesis of N,N′-(((((((9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl))diacrylamide as shown in Scheme 7

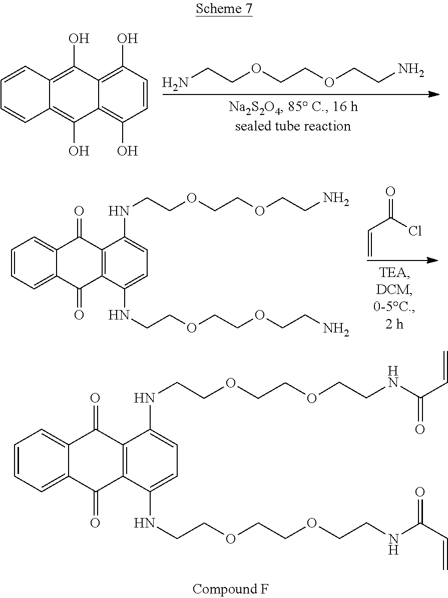

Anthracene-1,4,9,10-tetraol (10.0 grams, 0.042 moles), 2,2′-(ethane-1,2-diylbis(oxy)) bis(ethan-1-amine) (61.17 grams, 0.413 moles), and sodium hydrosulphite (10.0 grams, 0.058 moles) were added into tube at ambient temperature and then sealed. The reaction mixture was stirred for 16 hours at 85° C. The progress of reaction was monitored by thin layer chromatography (20% methanol in dichloromethane). After the reaction was completed, the reaction mixture was cooled down to room temperature, and deionized water (250 mL) and dichloromethane (250 mL) were added. The aqueous layer was re-extracted with dichloromethane (250 mL). The combined organic extracts were washed with deionized water (250 mL) and brine (250 mL). The organic phase was then dried over anhydrous sodium sulphate, filtered, and evaporated under reduced pressure to yield a crude product (23 grams) which was used in the next step without further purification.

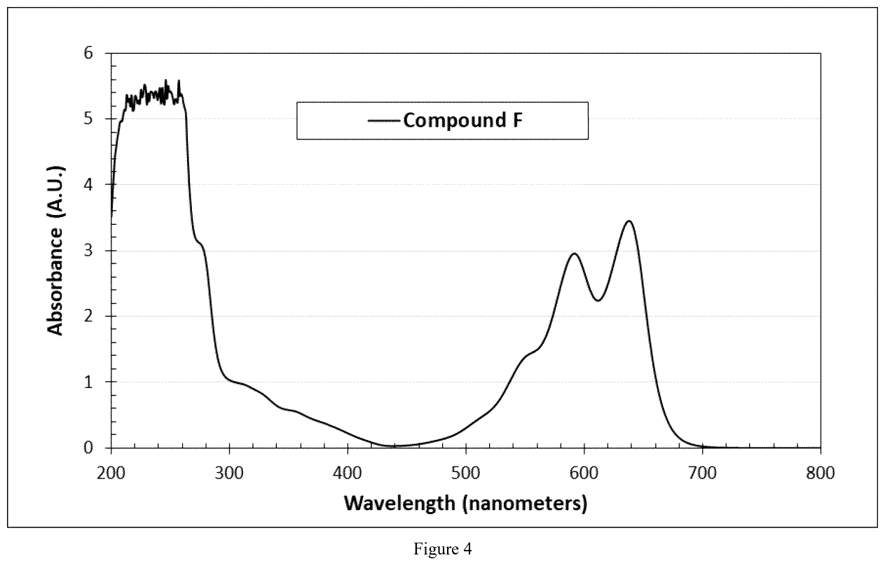

To a solution 1,4-bis((2-(2-(2-aminoethoxy) ethoxy)ethyl)amino) anthracene-9,10-dione (23.0 g, 0.046 moles) in dichloromethane (690 mL), triethylamine (46.5 grams, 64 mL, 0.46 moles) was added slowly at an ambient temperature, followed by the dropwise addition of a solution of acryloyl chloride (12.4 grams, 10.8 mL, 0.1379 moles) in dichloromethane (46 mL) while maintaining the reaction temperature between 0° C. and 5° C. and subsequently stirring for two hours. The progress of reaction was monitored by thin layer chromatography (5% methanol in dichloromethane. Upon completion of reaction, saturated sodium bicarbonate solution (300 mL) was added to reaction mixture at 0-5° C. The organic layer was separated, and aqueous layer was re-extracted with dichloromethane (2×230 mL). The combined organic extract were washed with deionized water (460 mL) and brine (460 mL), dried over sodium sulphate, filtered, and evaporated under reduced pressure at 30° C. to yield N,N′-(((((((9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl))diacrylamide (27 grams). The crude product was then purified by column chromatography using 100-200 mesh size silica gel, eluted with 0.2-0.6% methanol/dichloromethane to afford a blue solid (65% yield). ¹H-NMR (DMSO-d⁶, 400 MHz): § 3.71-3.28 (m, 24H), 5.56 (s, J=10.8 Hz, 2H), 6.09 (d, J=16.8 Hz, 2H), 6.24 (m, 2H), 7.47 (s, 2H), 7.85 (m, 2H), 8.24-8.15 (m, 4H), 10.86 (br s, 2H). The UV-VIS absorption spectrum of N, N′-(((((((9,10-dioxo-9,10-dihydroanthracene-1,4-diyl)bis(azanediyl)) bis(ethane-2,1-diyl))bis(oxy)) bis(ethane-2,1-diyl))bis(oxy)) bis(ethane-2,1-diyl))diacrylamide or Compound F in a 0.2 mM methanol solution is shown in FIG. 4.

### Example 7-Synthesis of 1-cyano-2-oxo-1-(9H-thioxanthen-9-ylidene)-6,9,12-trioxa-3-azatetradecan-14-yl methacrylate as shown in Scheme 8

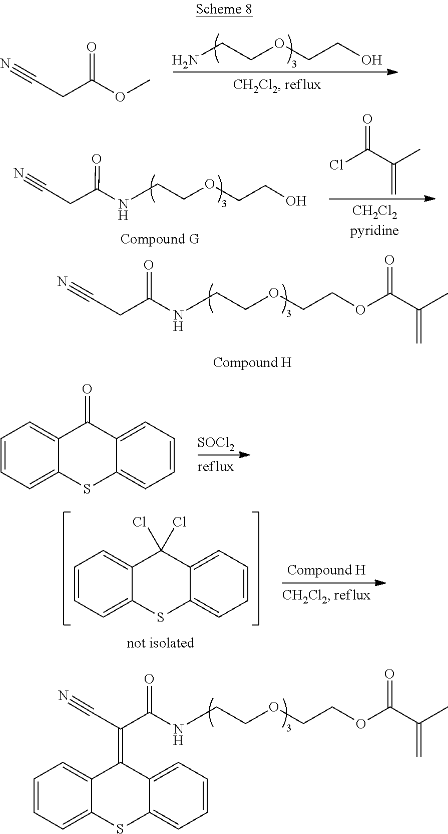

### Synthesis of 2-cyano-N-(2-(2-(2-(2-hydroxyethoxy) ethoxy) ethoxy)ethyl) acetamide

A solution of 2-(2-(2-(2-aminoethoxy) ethoxy) ethoxy) ethan-1-ol (0.98 equivalent) in of dichloromethane (25 mL) was added using an addition funnel to a solution of methyl cyanoacetate (1.0 equivalent) in chloromethane (50 mL) in a three-neck, 100 mL round bottom flask equipped with a reflux condenser under a nitrogen environment. As the reaction temperature rises, the reaction mixture begins to reflux. After the exotherm ceased, external heat was applied to continue reflux for a total of two hours, after which no 2-(2-(2-(2-aminoethoxy) ethoxy) ethoxy) ethan-1-ol was observed by thin layer chromatography. The reaction may also be conducted at room temperature but takes a few more few hours. The mixture was cooled to room temperature, and the methylene chloride was removed by rotary evaporation at reduced pressure. The residual oil was washed three times with 50 mL of ethyl acetate to remove unreacted starting material and non-polar impurities. The residual ethyl acetate was then removed by rotary evaporation under reduced pressure, and the resulting oil 2-cyano-N-(2-(2-(2-(2-hydroxyethoxy) ethoxy) ethoxy)ethyl) acetamide (Compound G) was used for subsequent acylation without any further purification.

### Synthesis of 1-cyano-2-oxo-6,9,12-trioxa-3-azatetradecan-14-yl methacrylate

Compound G was dissolved in 150 mL of dichloromethane containing pyridine (2.5 equivalents) in a three-neck round bottom flask equipped with a reflux condenser, an addition funnel, and a magnetic stirring bar. The flask was immersed in an ice bath and allowed to cool down to 0° C., and methacryloyl chloride (1.5 equivalents) was added dropwise from the addition funnel. The resulting reaction mixture was allowed to warm up to room temperature while constantly stirring the system. Methanol (20 mL) was then added to the flask to quench any unreacted methacryloyl chloride. The volatile components were removed by rotary evaporation under reduced pressure, and the crude product was dissolved in 800 mL of dilute aqueous hydrochloric acid. The resulting aqueous solution was extracted three times with 100 mL of hexanes in a separatory funnel to remove any non-polar impurities. The organic layers were discarded. Sodium chloride was added to the aqueous layer which was then extracted three times with 300 mL of ethyl acetate. About 50 milligrams of butylated hydroxytoluene (BHT) or 2,6-di-tert-butyl-4-methylphenol were added to the combined organic fractions as an inhibitor, and the ethyl acetate removed by rotary evaporation under reduced pressure. The crude product crystalized out of solution during solvent removal. When about 100 mL of ethyl acetate was left in the flask, 250 mL of hexanes was added, and the crude product was isolated by vacuum filtration using a fritted glass funnel. The filter cake was washed two times with 150 mL of hexanes and then vacuum dried at 40° C., yielding 1-cyano-2-oxo-6,9,12-trioxa-3-azatetradecan-14-yl methacrylate (Compound H).

### Synthesis of 1-cyano-2-oxo-1-(9H-thioxanthen-9-ylidene)-6,9,12-trioxa-3-azatetradecan-14-yl methacrylate

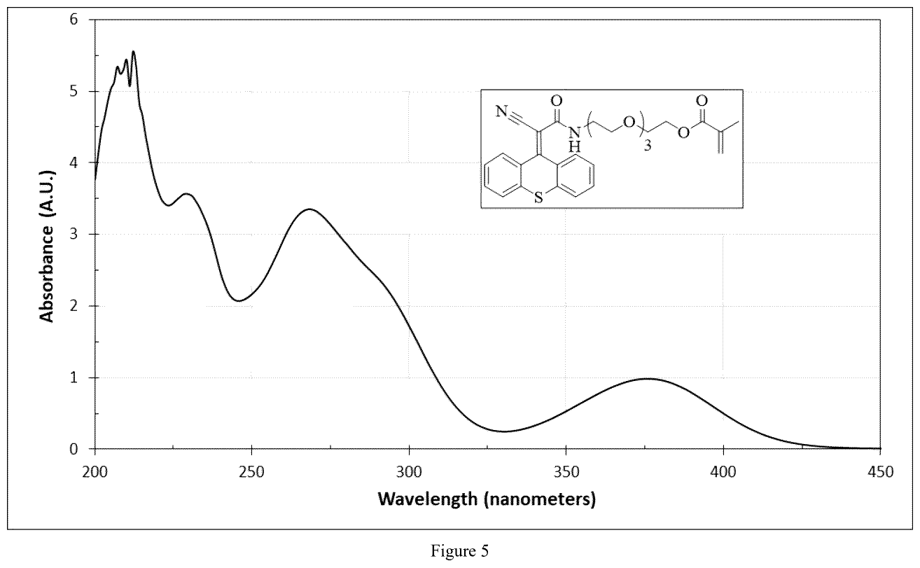

A mixture of 9H-thioxanthene-9-one (1.0 equivalent) and thionyl chloride (7.0 equivalents) was refluxed in a 100 mL round bottom flask under a nitrogen atmosphere with constant stirring. After two hours, the red solution was evaporated to dryness thereby removing excess thionyl chloride from the system. Compound H (1.05 equivalents) was dissolved in 100 mL of dichloromethane and is then added to the flask. The resulting reaction mixture was heated to reflux under a nitrogen blanket. The reaction was monitored by thin layer chromatography until completion (2 hours). The reactive mixture was allowed to cool down to room temperature. Solvents were removed on a rotary evaporator, the desired product, 1-cyano-2-oxo-1-(9H-thioxanthen-9-ylidene)-6,9,12-trioxa-3-azatetradecan-14-yl methacrylate, was isolated as thick yellow oil after passing through a short silica gel column (dichloromethane to remove unreacted 9H-thioxanthene-9-one, followed by 30% ethyl acetate in dichloromethane). 1H-NMR (CDCl₃, 500 MHz): δ 8.10 (1H, dd, J=5.0 Hz, J=10.0 Hz), 7.72 (1H, dd, J=5.0 Hz, J=10.0 Hz), 7.56-7.59 (2H, m), 7.42-7.47 (2H, m), 7.36-7.40 (1H, m), 7.29-7.32 (1H, m), 6.11 (1H, s), 5.57 (1H, s), 4.26-4.28 (2H, m), 3.69-3.71 (2H, m), 3.58-3.64 (4H, m), 3.50-3.52 (2H, m), 3.38-3.42 (6H, m), 1.94 (3H, s). The UV-VIS absorption spectra of 1-cyano-2-oxo-1-(9H-thioxanthen-9-ylidene)-6,9,12-trioxa-3-azatetradecan-14-yl methacrylate in a 0.2 mM methanol solution are shown in FIG. 5.

### Example 8-Synthesis of 1-(10-butyl-2-methoxyacridin-9 (10H)-ylidene)-1-cyano-2-oxo-6,9,12,15,18-pentaoxa-3-azaicosan-20-yl methacrylate as shown in Scheme 9 (Prophetic)

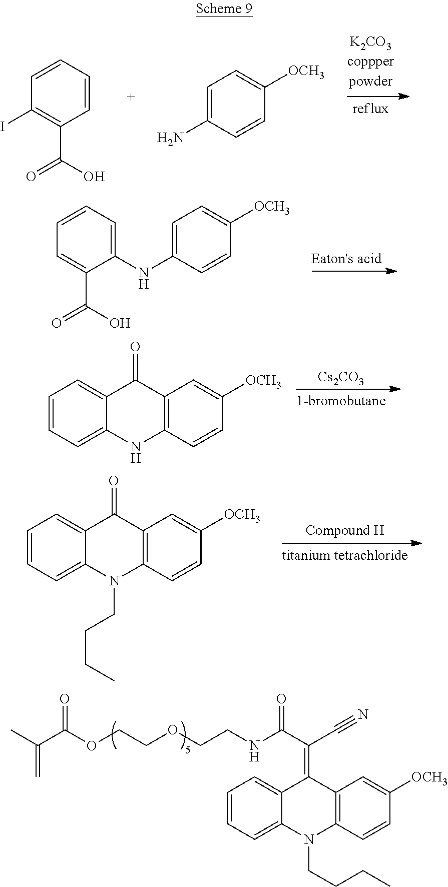

### Synthesis of 2-((4-methoxyphenyl)amino)benzoic acid

2-Iodobenzoic acid (1.0 equivalent), 4-methoxyaniline (2 equivalents), potassium carbonate (1.0 equivalent), and 300 milligrams of copper powder are charged into a three neck, 100 mL round bottom flask equipped with a magnetic stir bar and reflux condenser. Deionized water (30 mL) is added to the mixture of solids, and the reactive mixture is then heated at reflux for 6 hours with constant stirring. The mixture solidifies upon cooling down to room temperature. The reactive mixture is diluted with deionized water and is gradually poured into 1 normal aqueous hydrochloric acid with stirring. The reactive mixture is stirred at room temperature for 30 minutes, after which it is filtered over a fritted glass funnel and dried in a vacuum oven at 60° C. The resulting 2-((4-methoxyphenyl)amino)benzoic acid is washed with deionized water (3×100 mL) and is used “as is” for the intramolecular cyclization.

### Synthesis of 2-methoxyacridin-9 (10H)-one

A 250 mL round bottom flask equipped with a magnetic stir bar and reflux condenser is charged with 12.5 grams of 2-((4-methoxyphenyl)amino)benzoic acid and 100 mL of Eaton's acid (10 weight % P₂O₅ in methanesulfonic acid). The mixture is heated with constant stirring at 90° C. (mantle temperature) for 5 hours, while monitoring the reaction progress by thin layer chromatography. Upon cooling to room temperature, the reaction mixture is poured over crushed ice, stirred for 30 minutes, and filtered over a fritted glass funnel. The resulting 2-methoxyacridin-9 (10H)-one is washed with deionized water (3×100 mL), followed by acetonitrile, and dried in a vacuum oven at 60° C.

### Synthesis of 2-methoxy-10-butylacridin-9 (10H)-one

A 250 mL round bottom flask equipped with a magnetic stir bar and reflux condenser is charged with 5.4 grams of 2-methoxyacridin-9 (10H)-one (0.0244 mole) and 12.9 grams of cesium carbonate (1.5 equivalents). The solids are dried under vacuum at 80° C., after which the system is placed under a nitrogen blanket and 80 mL of anhydrous N,N-dimethylformamide is added to the flask. 1-Bromobutane (6.0 grams, 2 equivalents) is added to the flask, and the mixture is heated at 50° C. (mantle temperature) for 36 hours. Thin layer chromatography indicates the presence of two compounds (O-alkylation and N-alkylation). The organics are poured into 200 mL of deionized water and extracted into about 150 mL of ethyl acetate. The organics are then washed with deionized water (3×100 mL), followed by dilute aqueous HCl (3×100 mL), to remove the O-alkylated acridine byproduct, and then a final water with deionized water. Thin layer chromatography of the organic fraction confirms the present of a single compound at this point, namely 2-methoxy-10-propylacridin-9 (10H)-one, which is dried under reduced pressure and used for the subsequent transformation.

### Synthesis of 1-(10-butyl-2-methoxyacridin-9 (10H)-ylidene)-1-cyano-2-oxo-6,9,12,15,18-pentaoxa-3-azaicosan-20-yl methacrylate

A three neck, 250 mL round bottom flask equipped with a magnetic stir bar and reflux condenser is charged with 2-methoxy-10-butylacridin-9 (10H)-one (1.0 equivalent), 1-cyano-2-oxo-6,9,12,15,18-pentaoxa-3-azaicosan-20-yl methacrylate (Compound H, 2.0 equivalents), and 20 mL of dichloromethane. The system is placed under a nitrogen blanket, and the reaction mixture is stirred until homogeneous. After cooling the system in an ice bath, titanium tetrachloride (2.5 equivalents) is added to the reaction mixture in a dropwise fashion and stirred for an additional 15 minutes. Pyridine 5 mL (0.33 equivalent) is added to the reaction mixture, which is allowed to warm up to ambient temperature and is then heated to reflux for 8 hours. After cooling the reaction mixture to room temperature, the reaction mixture is poured over dilute aqueous hydrochloric acid, and the aqueous fraction is extracted with dichloromethane. The organic fractions are combined, and the volatile components are removed by rotary evaporation under reduced pressure. The desired product, 1-(10-butyl-2-methoxyacridin-9 (10H)-ylidene)-1-cyano-2-oxo-6,9,12,15,18-pentaoxa-3-azaicosan-20-yl methacrylate, is purified by flash chromatography to afford a dark yellow solid.

### Example 9-Synthesis of 17-((9-(dicyanomethylene)-9H-xanthen-3-yl)oxy)-3,6,9,12,15-pentaoxaheptadecyl methacrylate as shown in Scheme 9 (Prophetic)

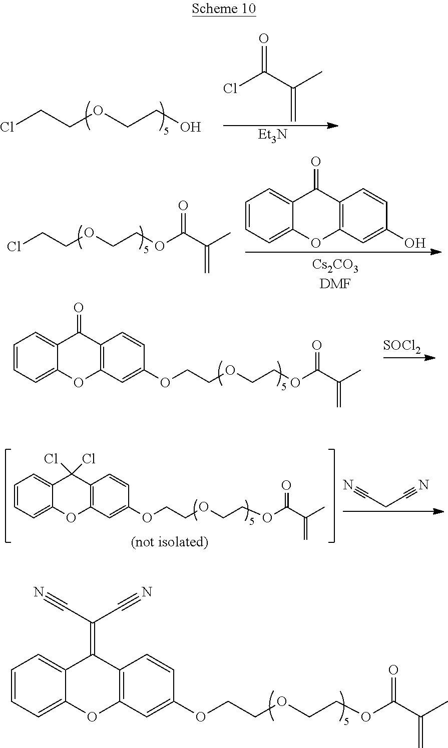

### Synthesis of 17-chloro-3,6,9,12,15-pentaoxaheptadecyl methacrylate

17-Chloro-3,6,9,12,15-pentaoxaheptadecan-1-ol (1.0 equivalent) and some crystals of 4-(dimethylamino)-pyridine (catalytic amount) are dissolved in dichloromethane (500 mL) in a round bottom flask equipped with a pressure equalizing addition funnel and nitrogen gas blanket. The reaction mixture is cooled to 0° C. using an ice bath thereafter triethylamine (4.0 equivalents) is added. Then, acryloyl chloride (1.1 equivalents) containing about 400 parts per million (ppm) of butylated hydroxytoluene (BHT) or 2,6-di-tert-butyl-4-methylphenol, is added dropwise, and the reaction mixture is stirred for two hours at 0° C. and then allow to warm up to ambient temperature and stirred for about 6 hours. The reaction mixture is quenched with 150 mL of deionized water and subsequently poured into 200 mL of 1 Molar hydrochloric acid and stirred. After adding some saturated sodium chloride solution, the phases are separated. The aqueous phase is extracted twice with ethyl acetate. The combined organic phases are washed with saturated sodium bicarbonate solution and saturated sodium chloride solution. After adding about 100 ppm BHT per gram of the desired product, the organic phase is concentrated by rotary evaporation under reduced pressure, yielding the crude product. The crude product is dissolved in 30% (v/v) ethyl acetate in n-hexanes and passed through a short silica gel column eluting with 30% (v/v) ethyl acetate in n-hexanes to afford 17-chloro-3,6,9,12,15-pentaoxaheptadecyl methacrylate.

### Synthesis of 17-((9-oxo-9H-xanthen-3-yl)oxy)-3,6,9,12,15-pentaoxaheptadecyl methacrylate

A suspension of 3-hydroxy-9H-xanthen-9-one (1.0 equivalent), Cs₂CO₃ (1.0 equivalent), and sodium iodide (catalytic amount, about 200 milligrams) are dried under vacuum in a 500 mL round bottom flask containing a magnetic stirring bar. Anhydrous dimethyl sulfoxide (DMSO) (250 mL) is added followed by 17-chloro-3,6,9,12,15-pentaoxaheptadecyl methacrylate (1.0 equivalent). The reaction mixture is heated overnight at 70° C. and is monitored by thin layer chromatography. The reaction mixture is cooled to room temperature and slowly poured into dilute aqueous hydrochloric acid with constant stirring. After stirring for thirty minutes, the off-white solids are isolated by vacuum filtration using a fritted glass funnel. The filter cake is then washed with deionized water, followed by two washes with 200 mL of hexanes. The resulting 17-((9-oxo-9H-xanthen-3-yl)oxy)-3,6,9,12,15-pentaoxaheptadecyl methacrylate is vacuum dried at 60° C. to constant weight.

### Synthesis of 17-((9-(dicyanomethylene)-9H-xanthen-3-yl)oxy)-3,6,9,12,15-pentaoxaheptadecyl methacrylate

17-((9-oxo-9H-xanthen-3-yl)oxy)-3,6,9,12,15-pentaoxaheptadecyl methacrylate (1.0 equivalent) and of thionyl chloride (7.0 equivalents) are dissolved in dichloromethane (50 mL) in a round bottom flask equipped with a magnetic stirring bar and reflux condenser, and the resulting reaction mixture is refluxed for 2 hours under a nitrogen gas blanket. The reaction mixture is cooled to room temperature, and the excess thionyl chloride and dichloromethane are removed by rotary evaporation under reduced pressure with the bath temperature maintained below 20° C. Excess malononitrile (10.0 equivalents) is added to the flask, followed by 25 mL of anhydrous dichloromethane, and the reaction mixture is stirred and heated at reflux for two hours. The mixture is cooled to room temperature and then flushed through a short silica gel plug eluting with 5% methanol (v/v) in methylene chloride. Volatile components are evaporated under reduced pressure with the temperature maintained below 20° C., after which the solids are suspended in cold methanol (100 mL) and stirred for 20 minutes. The crude product is isolated by vacuum filtration, and the filter cake washed with additional cold methanol. 17-((9-(Dicyanomethylene)-9H-xanthen-3-yl)oxy)-3,6,9,12,15-pentaoxaheptadecyl methacrylate is further purified by passing through a silica gel column eluting with 5% methanol (v/v) in methylene chloride to afford a light yellow solid.

### Example 10-Synthesis of 2-(2-(2-((9,10-dioxo-9,10-dihydroanthracen-1-yl)amino) ethoxy) ethoxy)ethyl methacrylate as shown in Scheme 11

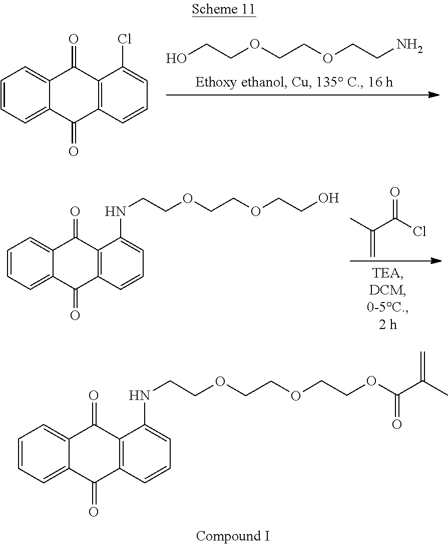

### Synthesis of 1-((2-(2-(2-hydroxyethoxy) ethoxy)ethyl)amino) anthracene-9,10-dione

2-(2-Aminoethoxy) ethoxy ethanol (153.62 grams, 1.03 mmol) was added to a stirred solution of 1-chloroanthracene-9,10-dione (100.0 grams, 0.412 mmol) in ethoxy ethanol (400 mL), followed by copper powder (2.61 grams, 0.0412 mmol) at room temperature under nitrogen. The mixture was then heated at 135° C. for 16 hours. Reaction progress was monitored by thin layer chromatography (70% ethyl acetate in n-hexanes). Upon completion, the mixture was cooled down to room temperature and solvents were removed under reduced pressure, thereby producing a red solid which was dissolved in dichloromethane (DCM) and extracted with water. The organic layer was separated, and the aqueous layer was extracted with DCM. The combined organic extracts were washed with water and brine, dried over sodium sulphate, filtered, and concentrated under reduced pressure to yield a red solid (180 grams) which was then purified by silica-gel column chromatography (5-80% ethyl acetate in n-hexanes) to produce a red solid, (85 grams, 58% yield). 1H-NMR (CDCl₃, 400 MHz): δ 9.76 (t, 1H, J=5.2 Hz), 8.17 (d, 1H, J=7.6 Hz), 8.10 (d, 1H, J=6.8 Hz), 7.81-7.90 (m, 2H), 7.62 (m, 1H), 7.41 (d, 1H, J=6.8 Hz), 7.25 (d, 1H, J=8.8 Hz), 4.57 (t, 1H, J=5.2 Hz), 3.34-3.72 (m, 12H).

### Synthesis of 2-(2-(2-((9,10-dioxo-9,10-dihydroanthracen-1-yl)amino) ethoxy) ethoxy)ethyl methacrylate (Compound I)

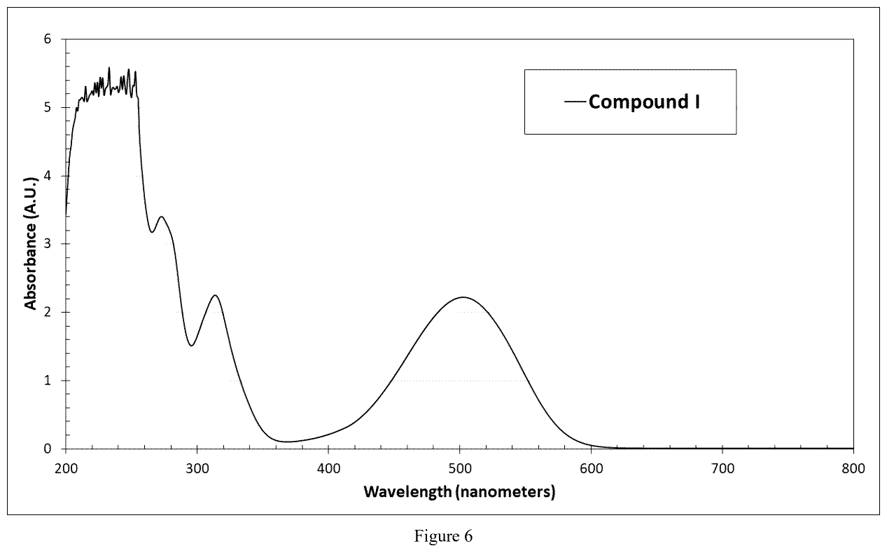

Methacryloyl chloride (30.0 grams, 0.287 mmol) was slowly added to a stirred solution of 1-((2-(2-(2-hydroxyethoxy) ethoxy)ethyl)amino) anthracene-9,10-dione (68.0 grams, 0.191 mmol) in dichloromethane (340.0 mL) and triethyl amine (48.4 grams, 0.478 mmol) at 0° C. The mixture was stirred for 30 minutes, and progress was monitored by thin layer chromatography (50% ethyl acetate in n-hexanes). Upon completion, the mixture was quenched with water, the organic layer was separated, and the aqueous layer was extracted with dichloromethane (2×100 mL). The combined organic extracts were washed with water and brine, dried over sodium sulphate, filtered, and concentrated under reduced pressure to produce red oil (94 grams) which was purified by silica-gel column chromatography and eluted with 15-21% ethyl acetate and n-hexanes to afford a red solid (45 grams, 55%). 1H-NMR (CDCl₃, 400 MHz): δ 9.78 (t, 1H, J=5.4 Hz), 8.18 (d, 1H, J=7.7 Hz), 8.11 (d, 1H, J=6.9 Hz), 7.81-7.91 (m, 2H), 7.66 (m, 1H), 7.43 (d, 1H, J=6.9 Hz), 7.27 (d, 1H, J=8.7 Hz), 5.98 (s, 1H), 5.62 (s, 1H), 4.21 (t, 1H, J=5.3 Hz), 3.50-3.74 (m, 12H), 1.83 (s, 3H). The UV-VIS absorption spectrum of 2-(2-(2-((9,10-dioxo-9,10-dihydroanthracen-1-yl)amino) ethoxy) ethoxy)ethyl methacrylate or Compound I in a 0.2 mM methanol solution is shown in FIG. 6.

### Example 11-Synthesis of 5-((9,10-dioxo-9,10-dihydroanthracen-1-yl)amino) pentyl methacrylate as shown in Scheme 12

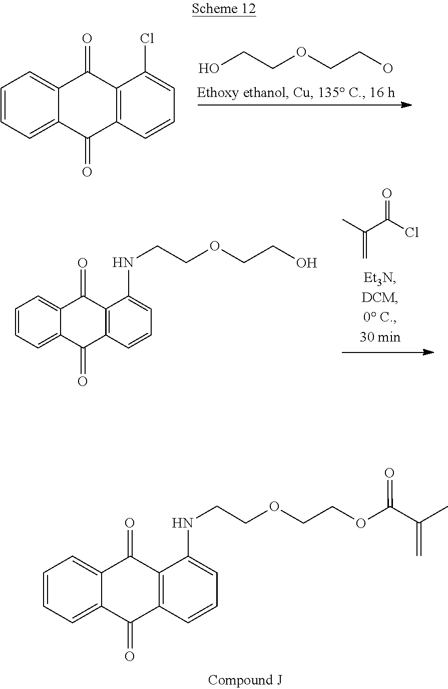

### Synthesis of 1-((5-hydroxypentyl)amino) anthracene-9,10-dione (Compound J)

5-Amino pentanol (127.5 grams, 1.23 mmol) was added to a stirred solution of 1-chloroanthracene-9,10-dione (75.0 g, 0.306 mmol) in ethoxy ethanol (375 mL) followed by copper powder (1.95 grams, 0.0306 mmol) at room temperature under nitrogen. The mixture was then heated at 135° C. for about 16 hours. Reaction was monitored by thin layer chromatography (30% ethyl acetate in n-hexanes). Upon completion, the mixture was cooled to room temperature, and solvents were removed under reduced pressure to produce a red solid which was dissolved in dichloromethane and water. The organic layer was separated, and the aqueous layer was extracted with dichloromethane (2×100 mL). The combined organic extracts were washed with water and brine, dried over sodium sulphate, filtered, and concentrated under reduced pressure to afford a crude red solid (˜240 grams), which was purified by silica-gel column chromatography and eluted with 20% ethyl acetate in n-hexanes to yield a red solid (75 grams, 59% yield). 1H-NMR (CDCl₃, 400 MHz): δ 9.62 (t, 1H, J=4.8 Hz), 8.16 (d, 1H, J=6.8 Hz), 8.13 (d, 1H, J=7.2 Hz), 7.79-7.90 (m, 2H), 7.58 (m, 1H), 7.41 (d, 1H, J=7.2 Hz), 7.18 (d, 1H, J=8.4 Hz), 4.57 (t, 1H, J=4.8 Hz), 3.27-3.46 (m, 4H), 1.45-1.69 (m, 6H).

### Synthesis of 5-((9,10-dioxo-9,10-dihydroanthracen-1-yl)amino) pentyl methacrylate

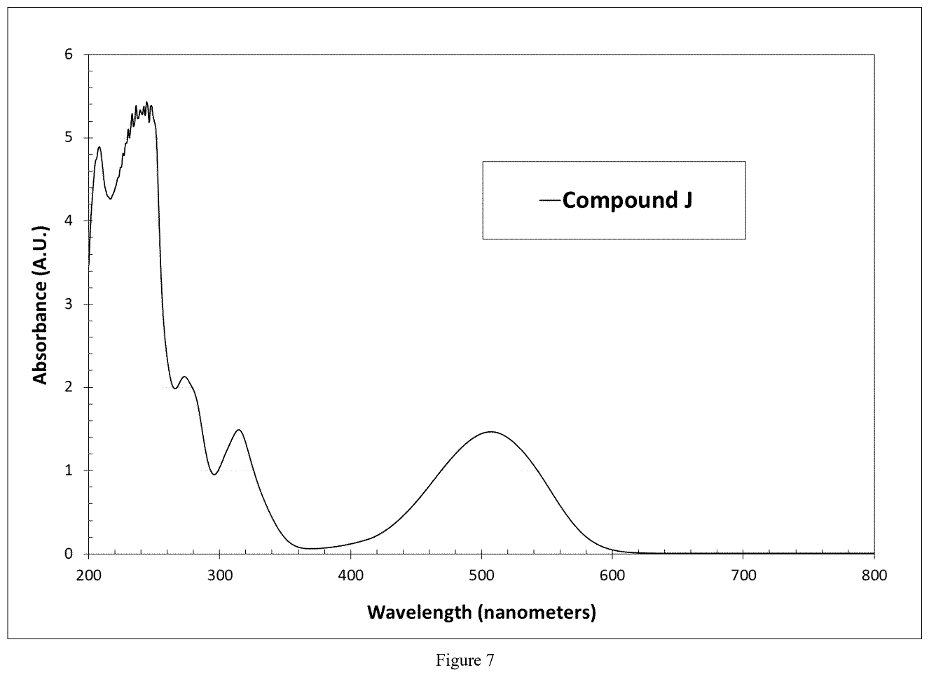

Methacryloyl chloride (30.0 mL, 0.306 mmol) was slowly added to a stirred solution of 1-((5-hydroxypentyl)amino) anthracene-9,10-dione (62.0 grams, 0.204 mmol) in dichloromethane (310.0 mL) and triethylamine (70.4 mL, 0.501 mmol) at 0° C. The mixture was stirred for 30 minutes. Upon completion (progress was monitored by thin layer chromatography monitored, 20% ethyl acetate in n-hexanes), the mixture was quenched with water. The organic layer was separated, and the aqueous layer was extracted with dichloromethane (2×100 mL). The combined organic extracts were washed with water and brine, dried over sodium sulphate, filtered, and concentrated under reduced pressure yield a red solid (˜89.0 grams) which was purified by silica-gel column chromatography, eluting with 5% ethyl acetate in n-hexanes, to afford a red solid (35.1 grams, 46% yield). 1H-NMR (CDCl₃, 400 MHz): δ 9.71 (t, 1H, J=5.2 Hz), 8.20 (d, 1H, J=7.6 Hz), 8.14 (d, 1H, J=7.2 Hz), 7.82-7.92 (m, 2H), 7.64 (m, 1H), 7.43 (d, 1H, J=7.44 Hz), 7.27 (d, 1H, J=8.7 Hz), 6.01 (s, 1H), 5.63 (s, 1H), 4.13 (t, 1H, J=6.4 Hz), 3.36-3.40 (m, 2H), 1.86 (s, 3H), 1.71 (m, 4H), 1.52 (m, 2H). The UV-VIS absorption spectrum of 5-((9,10-dioxo-9,10-dihydroanthracen-1-yl)amino) pentyl methacrylate or Compound J in a 0.2 mM methanol solution is shown in FIG. 7.

### Example 12-Synthesis of Sodium 4-((4-acrylamidophenyl)amino)-1-amino-9,10-dioxo-9,10-dihydroanthracene-2-sulfonate as shown in Scheme 13

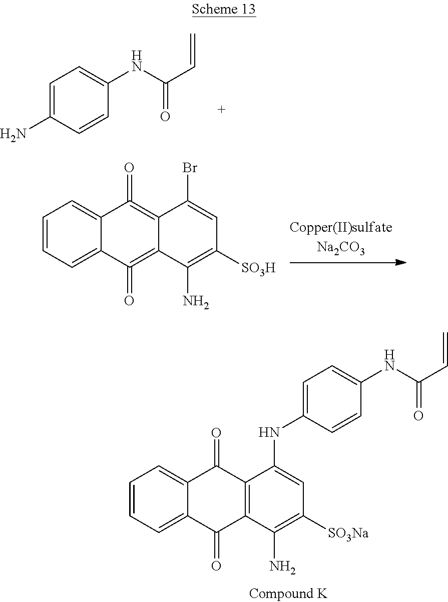

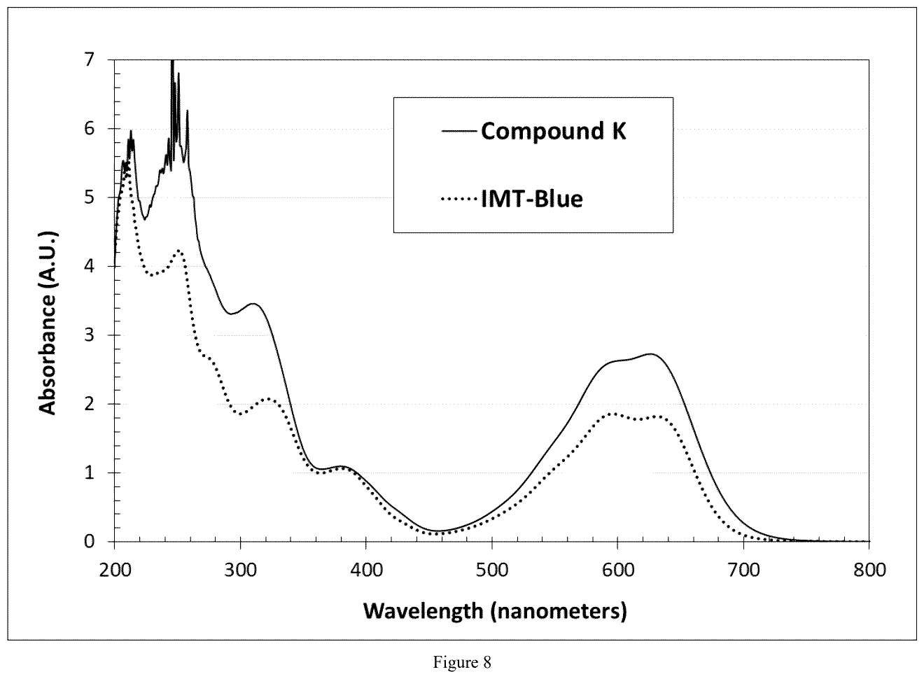

A three neck round bottom flask was charged with 1-amino-4-bromo-9,10-dioxo-9,10-dihydroanthracene-2-sulfonic acid (40.0 grams, 104.66 mmol), N-(4-aminophenyl) acrylamide (32.6 grams, 200.99 mmol), anhydrous copper sulfate (9.5 grams, 289.64 mmol), sodium carbonate (14.42 grams, 136.04 mmol), and deionized water (1.2 L) and then heated at 90° C. for 2.0 hours under a nitrogen gas atmosphere. The mixture (thick slurry) was cooled to room temperature and dissolved in 40% aqueous methanol (2.5 L) and precipitated by the addition of saturated brine (2.5 L). The precipitate was isolated by filtration through a fritted funnel packed with the layers of sand-celite-sand (˜4 inch). The filter cake was washed with 10% methanol in half saturated brine solution (36 L) at which point 1H-NMR analysis of a sample of the filter cake indicated <3% of N-(4-aminophenyl) acrylamide as an impurity. The crude project with celite and sand was suspended into methanol (6.0 L) and filtered through the fritted funnel. The filter cake was washed with additional methanol (2.0 L). The filtrate was concentrated under reduced pressure to give crude sodium 4-((4-acrylamidophenyl)amino)-1-amino-9,10-dioxo-9,10-dihydroanthracene-2-sulfonate (83 grams). The crude material was purified on an InterChim automated system (Biotage silica 350 gram column), eluting with a gradient of 0 to 10% methanol in dichloromethane followed by 0 to 10% methanol in acetone to give sodium 4-((4-acrylamidophenyl)amino)-1-amino-9,10-dioxo-9,10-dihydroanthracene-2-sulfonate (19.7 grams, 39% yield) as a dark blue solid. 1H-NMR (DMSO-d⁶, 400 MHz): δ 12.08 (s, 1H), 10.28 (s, 1H), 10.05-10.23 (m, 1H), 8.19-8.31 (m, 2H), 7.96 (s, 1H), 7.68-7.89 (m, 4H), 7.37-7.57 (m, 1H), 7.26 (d, 2H, J=8.8 Hz), 6.47 (d, 1H, J=8.8, 10.1 Hz), 6.29 (d, 1H, J=2.0, 17.0 Hz), 5.74-580 (m, 1H). The UV-VIS absorption spectra of sodium 4-((4-acrylamidophenyl)amino)-1-amino-9,10-dioxo-9,10-dihydroanthracene-2-sulfonate or Compound K and IMT Blue in a 0.2 mM methanol solution are shown in FIG. 8.

### Example 13-Contact Lenses

A reactive monomer mixture was prepared composed of 77 weight percent of the formulation listed in Table 2, and 23 weight percent of the diluent D3O. The reactive monomer mixture was filtered through a 3 μm filter using a stainless-steel syringe under pressure.

TABLE 2

| Component | | |
|---|---|---|
| (weight %) | Ex. 13A | Ex. 13B |
| mPDMS | 30.9 | 30.9 |
| SiMAA | 27.9 | 27.9 |
| DMA | 23.92 | 23.92 |
| HEMA | 5.94 | 5.94 |
| TEGDMA | 1.5 | 1.5 |
| PVP K90 | 7 | 7 |
| Omnirad 1870 | 0.34 | 0.34 |
| Norbloc | 2 | 2 |
| Compound A | 0.5 | 0 |
| Compound B | 0 | 0.5 |

The reactive monomer mixture was degassed at ambient temperature by applying vacuum (40 torr) for at least 20 minutes. Then, in a glove box with a nitrogen gas atmosphere and less than about 0.1-0.2 percent oxygen gas, about 75 μL of the reactive mixture was dosed using an Eppendorf pipet at room temperature into the FC made of 90:10 (w/w) Z/TT blend. The BC made of 90:10 (w/w) Z: TT blend was then placed onto the FC. The molds were equilibrated for a minimum of twelve hours in the glove box prior to dosing. Pallets each containing eight mold assemblies were transferred into an adjacent glove box maintained at 62° C., and the lenses are cured from the top and the bottom using 405 nm LED lights having an intensity of about 2.0 mW/cm² for 10 minutes.

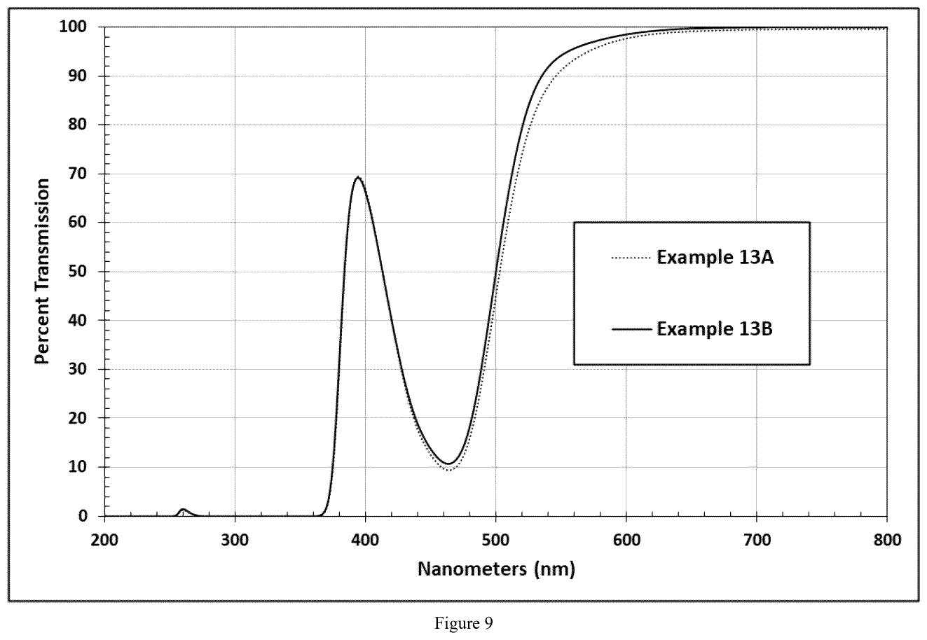

The lenses were manually de-molded and released by suspending the lenses in about one liter of 70 percent IPA for about one hour, followed by soaking two more times with fresh 70 percent IPA for 30 minutes; then overnight in DIW; followed by fresh DIW for 30 minutes; and then with packing solution for 30 minutes. Finally, the lenses were equilibrated and stored in borate buffered packaging solution. A person of ordinary skill recognizes that the exact lens release process can be varied depending on the lens formulation and mold materials, regarding the concentrations of the aqueous isopropanol solutions, the number of washings with each solvent, and the duration of each step. The purpose of the lens release process is to release all of the lenses without defects and transition from diluent swollen networks to the packaging solution swollen hydrogels. The UV-VIS transmission spectra of two different sets of lenses (Examples 13A and 13B) in borate buffered packing solution are shown in FIG. 9.

### Example 14: Thermal and Photochemical Stability Testing

A reactive monomer mixture was prepared composed of 77 weight percent of the formulation listed in Table 3, and 23 weight percent of the diluent D3O. From that reactive monomer mixture, lenses were fabricated on a pilot manufacturing line using double sided 395 nm LED cure with an intensity of 1.5 mW/cm² for 4 minutes followed by 5 mW/cm² for 4 minutes were used to cure the lenses. The lenses were packaged in standard blister packages with borate buffered packing solution containing about 50 ppm methyl ether cellulose; and the lenses (Ex. 14A) were sterilized at 121° C. for about 18 minutes.

TABLE 3

| Component | |
|---|---|
| (weight %) | Ex. 14A |
| mPDMS | 31 |
| SiMAA | 28 |
| DMA | 24.01 |
| HEMA | 6 |
| TEGDMA | 1.5 |
| PVP K90 | 7 |
| Omnirad 1870 | 0.34 |
| Norbloc | 2 |
| Visibility Tint | 0.06 |
| Compound B | 0.09 |

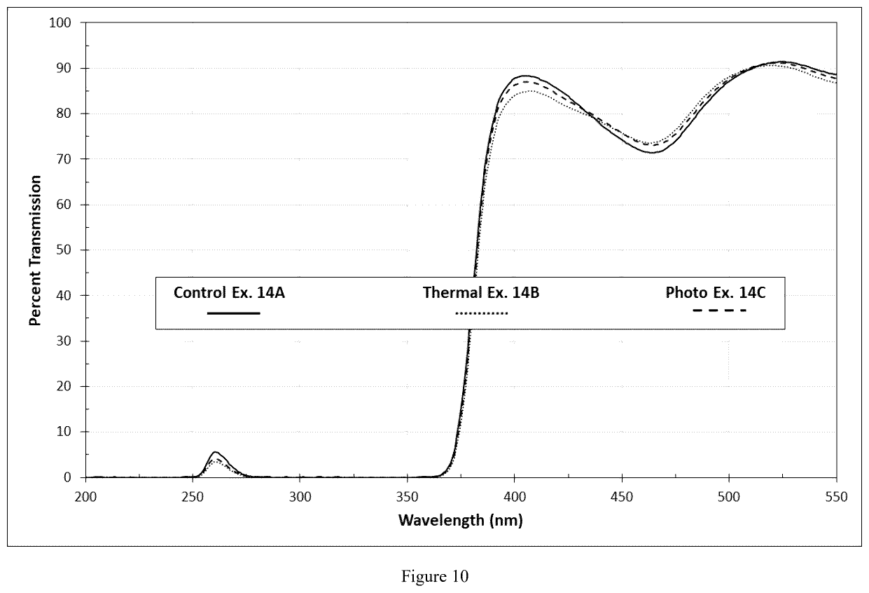

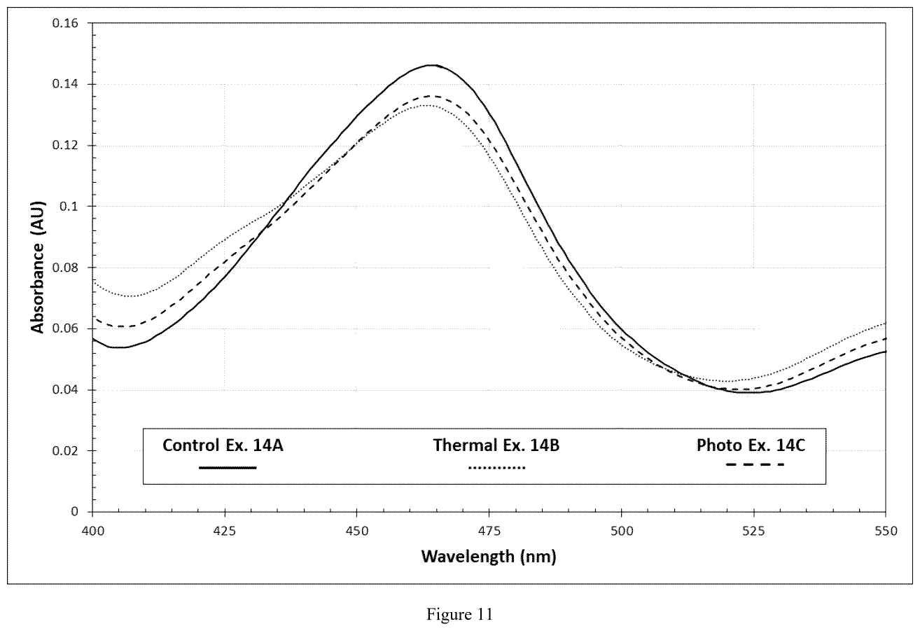

Ex. 14A lenses (Control lenses) were removed from their original blister packages and placed into individual glass vials containing 5 mL of borate buffered packing solution. The vials containing these lenses were stored in a stability chamber at 89° C. for one month. The lens parameters, mechanical properties, and UV-VIS spectral properties (average percent transmission across a range of wavelengths) of these thermally treated lenses (Ex. 14B) were subsequently measured and compared to the control lenses. These data are shown in Tables 4-6. Standard deviations are shown in parentheses. The UV-VIS transmission spectra Examples 14A and 14B are shown in FIG. 10; the corresponding absorbance spectra between 400 nanometer and 550 nanometers are shown in FIG. 11.

Blister packages containing Ex. 14A lenses were placed in a controlled photostability chamber (foil side down, bowl side up, so that the lenses in the bowls could be exposed to light). The photostability chambers were maintained at 25° C.+2° C. and ambient relative humidity. These lenses were then exposed sequentially to 1.5 million lux hours of visible light (168.8 hours of exposure) and 259.4 watt-hours/m² of ultraviolet light (16.2 hours of exposure). The lens parameters, mechanical properties, and UV-VIS spectral properties (average percent transmission across a range of wavelengths) of these photo-stressed lenses (Ex. 14C) were subsequently measured and compared to the control lenses. These data are shown in Tables 4-7. Standard deviations are shown in parentheses. The UV-VIS transmission spectrum of Ex. 14C is also shown in FIG. 10 and the corresponding absorbance spectrum in FIG. 11.

TABLE 4
Lens Parameters

| Lens Parameters | Ex. 14A | | Ex. 14B | | Ex. 14C | |
|---|---|---|---|---|---|---|
| Lens Diameter (mm) | 14.44 | (0.01) | 14.50 | (0.01) | 14.45 | (0.01) |
| Base Curve | 8.61 | (0.01) | 8.59 | (0.07) | 8.59 | (0.01) |
| Radius (mm) | | | | | | |
| Center | 0.085 | (0.002) | 0.086 | (0.001) | 0.086 | (0.001) |
| Thickness (mm) | | | | | | |

| | | | |
|---|---|---|---|
| PW2EQD (D) | −0.07 | −0.02 | −0.006 |
| RMS_65 (μm) | 0.03 | 0.06 | 0.03 |

TABLE 5
Mechanical Properties

| Mechanical | | | |
|---|---|---|---|
| Properties | Ex. 14A | Ex. 14B | Ex. 14C |
| Modulus (psi) | 99 (5) | 113 (9) | 100 (5) |
| Elongation (%) | 214 (48) | 162 (39) | 231 (57) |
| Tensile | 106 (24) | 96 (20) | 110 (26) |
| strength (psi) | | | |
| Toughness | 113 (41) | 84 (34) | 135 (48) |
| (in-lb/in³) | | | |
| Water (wt. %) | 38.2 (0) | 38.7 (0) | 39.8 (0) |

TABLE 6
Spectral Properties

Average Percent Transmission
across the Spectral Range

| Spectral Range | Ex. 14A | Ex. 14B | Ex. 14C |
|---|---|---|---|
| Visible (380-780 nm) | 86.8 | 86.4 | 87.0 |
| UVA (315-380 nm) | 2.5 | 2.5 | 2.8 |
| UVB (280-315 nm) | 0.0 | 0.0 | 0.0 |

| | | | | |
|---|---|---|---|---|
| 464 | nm | 73.08 | 73.6 | 71.43 |
| 400-500 | nm | 79.9 | 80.1 | 80.3 |

TABLE 7
Thermal Stability and Photostability
at Visible Light Absorption Maximum

| Ex. 14A | | | | |
|---|---|---|---|---|
| (control) | Ex. 14B | Ex. 14B | Ex. 14C | Ex. 14C |
| Absorbance¹ | Absorbance | % Change | Absorbance | % Change |
| 0.1461 | 0.1328 | 9.1 | 0.1361 | 6.8 |

¹at visible light absorption maximum

As shown by the small changes in the lens parameters, mechanical properties, and UV-VIS transmission spectra after the thermal treatment or light exposure, chromophores of Formula I, such as Compound B, appear to be both thermally stable and photostable in contact lenses while substantially mimicking the UV-VIS spectrum of macular pigment.

### Example 15: Edge to Edge Apodised Contact Lenses (Prophetic)

Reactive monomer mixtures are prepared composed of 77 weight percent of the formulations listed in Table 8 and 23 weight percent of the diluent D3O. The reactive monomer mixtures are individually filtered through a 3 μm filter using a stainless-steel syringe under pressure.

TABLE 8

| | Ex. 15A | Ex. 15B | Ex. 15C | Ex. 15D | Ex. 15E | Ex. 15F | Ex. 15G |
|---|---|---|---|---|---|---|---|
| Component | (wt. %) | (wt. %) | (wt. %) | (wt. %) | (wt. %) | (wt. %) | (wt. %) |
| mPDMS | 30.16 | 30.16 | 30.16 | 30.16 | 30.16 | 30.16 | 30.16 |
| SiMAA | 28 | 28 | 28 | 28 | 28 | 28 | 28 |
| DMA | 24 | 24 | 24 | 24 | 24 | 24 | 24 |
| HEMA | 6 | 6 | 6 | 6 | 6 | 6 | 6 |
| TEGDMA | 1.5 | 1.5 | 1.5 | 1.5 | 1.5 | 1.5 | 1.5 |
| PVP K90 | 7 | 7 | 6 | 7 | 7 | 6 | 7 |
| Omnirad | 0.34 | 0.34 | 0.34 | 0.34 | 0.34 | 0.34 | 0.34 |
| 1870 | | | | | | | |
| Norbloc | 2 | 1.5 | 1 | 2 | 1.5 | 1 | 1.5 |
| Compound B | 0.5 | 0.5 | 0.5 | 0.5 | 0.5 | 0.3 | 0.5 |
| Compound C | 0 | 0 | 2 | 0 | 0 | 2 | 0 |
| Compound E | 0 | 0 | 0 | 0 | 0.5 | 0 | 0 |
| Compound F | 0 | 0 | 0 | 0 | 0 | 0.2 | 0 |
| Compound I | 0.5 | 0.5 | 0.5 | 0 | 0 | 0 | 0.5 |
| Compound J | 0 | 0 | 0 | 0.5 | 0.5 | 0.5 | 0 |
| Compound K | 0 | 0 | 0 | 0 | 0 | 0 | 0.5 |
| IMT Blue | 0 | 0.5 | 0 | 0 | 0 | 0 | 0 |

These reactive monomer mixtures are degassed at ambient temperature by applying vacuum (40 torr) for at least 20 minutes. Then, in a glove box with a nitrogen gas atmosphere and less than about 0.1-0.2 percent oxygen gas, about 75 μL of the reactive mixture are dosed using an Eppendorf pipet at room temperature into the FC made of 90:10 (w/w) Zeonor/TT blend. The BC made of 90:10 (w/w) Z: TT blend is then placed onto the FC. The molds are equilibrated for a minimum of twelve hours in the glove box prior to dosing. Pallets each containing eight mold assemblies are transferred into an adjacent glove box maintained at 65° C., and the lenses are cured from the top and the bottom using 435 nm LED lights having an intensity of about 1.5 mW/cm² for 3 minutes and then of about 2.5 mW/cm² for 7 minutes.

The lenses are manually de-molded with most lenses adhering to the FC and released by suspending the lenses in about one liter of 70 percent IPA for about one hour, followed by soaking two more times with fresh 70 percent IPA for 30 minutes; then two times with fresh DIW for 15 minutes; then two time with packing solution for 30 minutes. The lenses are equilibrated and stored in borate buffered packaging solution. The lenses are then placed in vials containing borate buffered packaging solution and autoclaved for about 30 minutes at 121° C. A person of ordinary skill recognizes that the exact lens release process can be varied depending on the lens formulation and mold materials, regarding the concentrations of the aqueous isopropanol solutions, the number of washings with each solvent, and the duration of each step. The purpose of the lens release process is to release all of the lenses without defects and transition from diluent swollen networks to the packaging solution swollen hydrogels. The physical and mechanical properties of the sterile lenses Ex. 15 A-G are measured.

### Example 16: Pupil Only Apodised Contact Lenses

A reactive monomer mixture was prepared composed of 77 weight percent of the formulation listed in Table 9 and 23 weight percent of the diluent D3O. The RMM was then filtered through a 3 μm filter using a stainless-steel syringe under pressure and degassed by applying vacuum (about 40 mm Hg). Under a nitrogen gas atmosphere and about three percent oxygen gas, about 75 μL of the reactive monomer mixture were dosed into the FC made of Zeonor. The BC made of Zeonor was then placed onto the FC, thereby forming a minus one diopter lens mold assembly. Pallets, each containing eight lens mold assemblies, were conveyed through a two-stage curing tunnel during which the pallets were irradiated at 65° C. using 435 nm LED lights having intensity of about 4 mW/cm² at the pallet's surface for about 3.8 minutes and then of about 12 mW/cm² for about 2.2 minutes. The light source was located above the pallets. BC were mechanically removed under yellow lighting. Pallets holding the FC with adhered lenses were stored under a nitrogen gas atmosphere and in the dark until further use. The adhered lenses are crosslinked substrate network lenses with covalently bound monoacylphosphine oxide groups and are referred to as “MAPO substrate lenses” in the experiments described below.

TABLE 9

| Component | Weight Percent |
|---|---|
| mPDMS | 31 |
| SiMAA | 28 |
| DMA | 24 |
| HEMA | 6 |
| PVP K90 | 7 |
| TEGDMA | 1.65 |
| Norbloc | 2 |
| RB247 | 0.01 |
| Omnirad 819 | 0.34 |

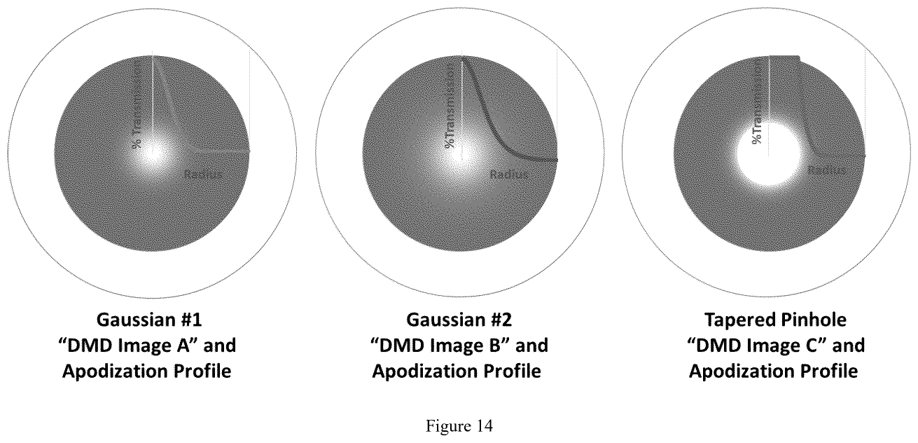

Working under yellow lights in a glove box in a nitrogen gas atmosphere, a FC with a MAPO substrate lens still attached thereon was placed on the in-mold jig shown in FIG. 12. The in-mold jig was then attached to an optical lens forming apparatus equipped with a digital light projection unit employing a micro-mirror device to modulate and direct light onto the FC and into attached MAPO substrate lens. The light source of the apparatus was a 405 nanometer LED having an intensity of 120 mW/cm². Then, about 150 microliters of the degassed grafting solutions listed in Table 10 (50:50 (v/v) 1-propanol: DIW) were dispensed into the FC for nine minutes to allow the visible light filtering compounds to absorb into the MAPO substrate lenses, thereafter the excess grafting solutions were removed. The impregnated MAPO substrate lenses were then irradiated for sixty seconds using either a 9-millimeter diameter pupil only DMD image abbreviated as “9 mm PUPO” (examples 16A, 16C-E), or a 10-millimeter diameter Gaussian apodised image abbreviated as “10 mm DMD Image A” as shown in FIGS. 13 and 14, thereby grafting the visible light filtering compounds into the MAPO substrate lenses.

TABLE 10
Grafting Solutions in 50:50 (v/v)
1-propanol:DIW and DMD Images

| | Ex. 16A | Ex. 16B | Ex. 16C | Ex. 16D | Ex. 16E |
|---|---|---|---|---|---|
| Component | (wt. %) | (wt. %) | (wt. %) | (wt. %) | (wt. %) |
| Compound B | 0.27 | 0.27 | 0.25 | 0.27 | 0.30 |
| Compound I | 0.82 | 0.82 | 0.70 | 0.90 | 1 |
| IMT Blue | 2.86 | 2.86 | 2.86 | 2.86 | 2.86 |
| DMD Image | 9 mm | 10 mm | 9 mm | 9 mm | 9 mm |
| | PUPO | DMD A | PUPO | PUPO | PUPO |

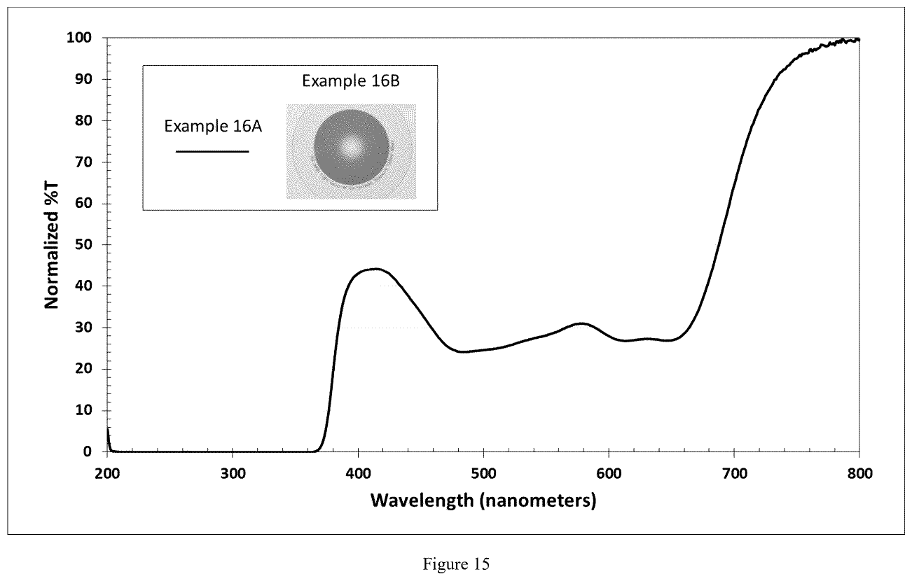

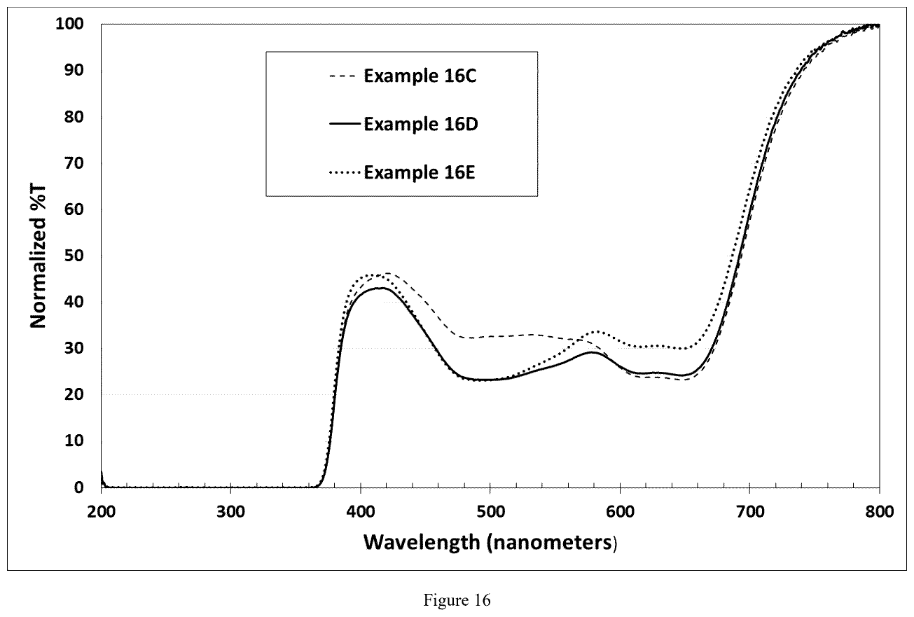

The in-mold jigs were removed from the apparatus, and the grafted lenses isolated by removing the FC mechanically. The lenses were then soaked in 70% (v/v) aqueous IPA for fifteen hours and then rinsed two times with DIW and two times with PS and then stored in vials in PS. The UV-VIS spectra of the pupil only lenses were measured and are shown in FIGS. 15 and 16. The UV-VIS spectra clearly showed that by varying the concentrations of the visible light filtering compounds in the grafting compositions, UV-VIS spectra of the final apodised lenses can be modified. Examples 16A-E showed a relatively constant transmittance between 480 nanometers to 660 nanometers.

### Example 17: Pupil Only Apodised Contact Lenses

A reactive monomer mixture was prepared composed of 77 weight percent of the formulation listed in Table 11 and 23 weight percent of the diluent D3O. The RMM was then filtered through a 3 μm filter using a stainless-steel syringe under pressure and degassed by applying vacuum (about 40 mm Hg). Under a nitrogen gas atmosphere and about three percent oxygen gas, about 75 μL of the reactive monomer mixture were dosed into the FC made of Zeonor. The BC made of Zeonor was then placed onto the FC, thereby forming a minus one diopter lens mold assembly. Pallets, each containing eight lens mold assemblies, were conveyed through a two-stage curing tunnel during which the pallets were irradiated at 65° C. using 435 nm LED lights having intensity of about 4 mW/cm² at the pallet's surface for about 3.8 minutes and then of about 12 mW/cm² for about 2.2 minutes. The light source was located above the pallets. BC were mechanically removed under yellow lighting. Pallets holding the FC with adhered lenses were stored under a nitrogen gas atmosphere and in the dark until further use. The adhered lenses are crosslinked substrate network lenses with covalently bound monoacylphosphine oxide groups and are referred to as “MAPO substrate lenses” in the experiments described below.

TABLE 11

| Component | Weight Percent |
|---|---|
| mPDMS | 31 |
| SiMAA | 28 |
| DMA | 24 |
| HEMA | 6 |
| PVP K90 | 7 |
| TEGDMA | 1.65 |
| Norbloc | 2 |
| RB247 | 0.01 |
| Omnirad 819 | 0.34 |

Working under yellow lights in a glove box in a nitrogen gas atmosphere, a FC with a MAPO substrate lens still attached thereon was placed on the in-mold jig shown in FIG. 12. The in-mold jig was then attached to an optical lens forming apparatus equipped with a digital light projection unit employing a micro-mirror device to modulate and direct light onto the FC and into attached MAPO substrate lens. The light source of the apparatus was a 405 nanometer LED having an intensity of 120 mW/cm². Then, about 150 microliters of the degassed grafting solution, composed of 0.27 weight percent of Compound B, 0.90 weight percent of Compound I, and 1.0 weight percent of Compound E in 50:50 (v/v) 1-propanol: DIW for Examples 17A-B and in 55:45 (v/v) 1-propanol: DIW for Examples 17C-F, were dispensed into the FC for nine minutes to allow the visible light filtering compounds to absorb into the MAPO substrate lenses, thereafter the excess grafting solutions were removed. The impregnated MAPO substrate lenses were then irradiated for various times using either a 9-millimeter diameter pupil only DMD image, abbreviated as “9 mm PUPO” (examples 17A-B), or 10-millimeter diameter Gaussian DMD images as shown in FIGS. 13 and 14, abbreviated as “DMD A-C”, thereby grafting the visible light filtering compounds into the MAPO substrate lenses.

TABLE 12
Irradiation Times and DMD Images

| | Ex. 17A | Ex. 17B | Ex. 17C | Ex. 17D | Ex. 17E | Ex. 17F |
|---|---|---|---|---|---|---|
| Component | (wt. %) | (wt. %) | (wt. %) | (wt. %) | (wt. %) | (wt. %) |
| DMD Image | 9 mm | 9 mm | 9 mm | 10 mm | 10 mm | 10 mm |
| | PUPO | PUPO | PUPO | DMD A | DMD B | DMD C |
| Irradiation | 60 | 15 | 22.5 | 22.5 | 22.5 | 22.5 |
| Time (sec) | | | | | | |

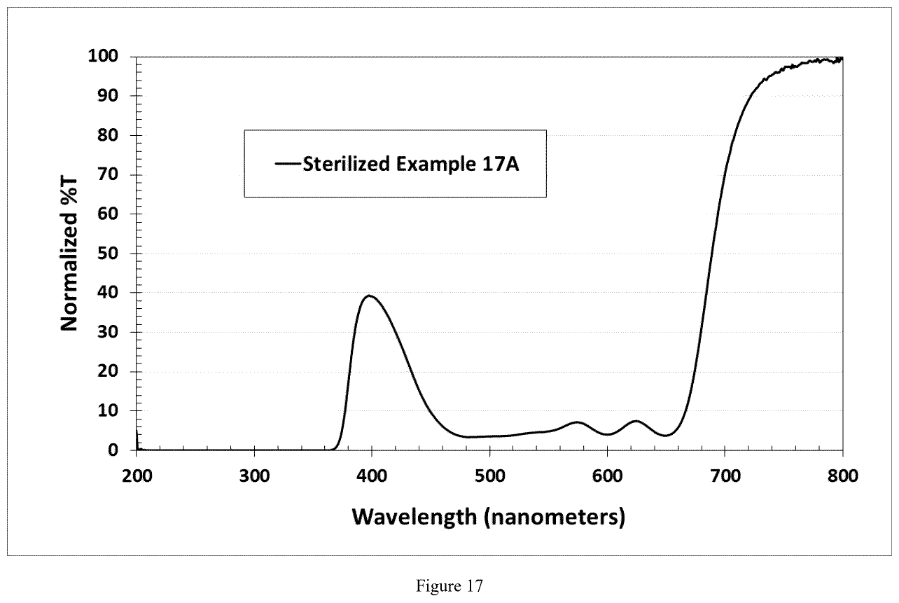

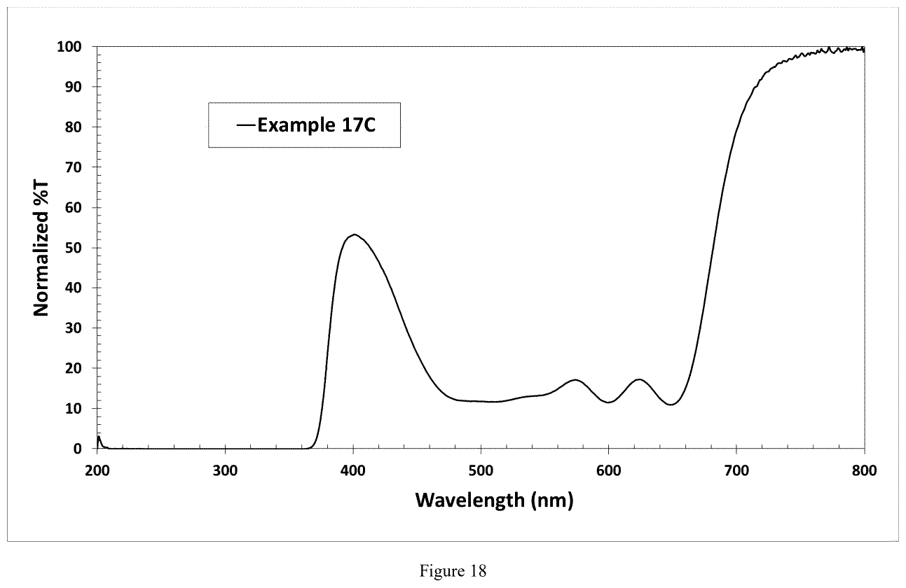

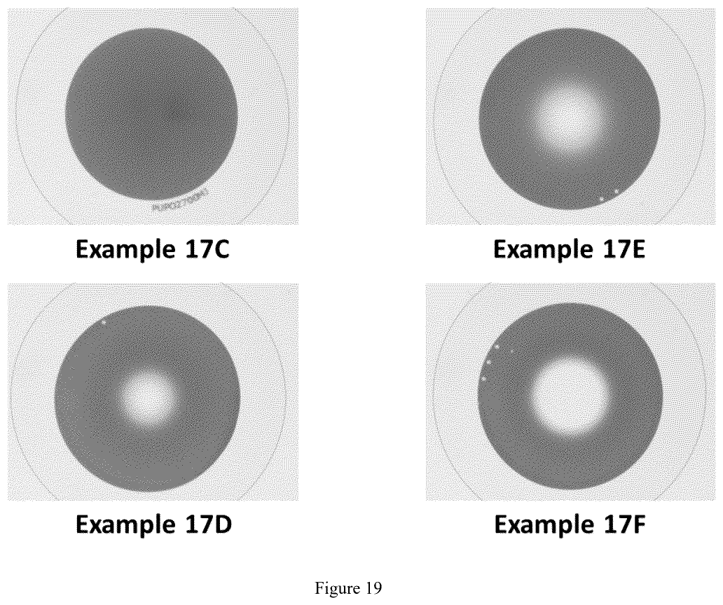

The in-mold jigs were removed from the apparatus, and the grafted lenses isolated by removing the FC mechanically. The lenses were then soaked in 70% (v/v) aqueous IPA for fifteen hours and then rinsed two times with DIW and two times with PS and then stored in vials in PS. The apodised lenses of Example 17A were subsequently sterilized by autoclaving at 121° C. for about 30 minutes. The UV-VIS spectrum of sterile Example 17A lenses is displayed in FIG. 17, showing a relatively constant transmittance between 480 nanometers to 660 nanometers of about 5 percent. The UV-VIS spectrum of Example 17C lenses is displayed in FIG. 18, showing a relatively constant transmittance between 480 nanometers to 660 nanometers of about 15 percent, and micrographs of the apodised Example 17C-E lenses are shown in FIG. 19.

### Example 18. Pupil Only Apodised Contact Lenses

A reactive monomer mixture was prepared composed of 77 weight percent of the formulation listed in Table 13 and 23 weight percent of the diluent D3O. The RMM was then filtered through a 3 μm filter using a stainless-steel syringe under pressure and degassed by applying vacuum (about 40 mm Hg). Under a nitrogen gas atmosphere and about one percent oxygen gas, about 75 μL of the reactive monomer mixture were dosed into the FC made of Zeonor. The BC made of Zeonor was then placed onto the FC, thereby forming a minus one diopter lens mold assembly. Pallets, each containing eight lens mold assemblies, were conveyed through a two-stage curing tunnel during which the pallets were irradiated at 65° C. using 435 nm LED lights having intensity of about 1.5 mW/cm² at the pallet's surface for about 4.5 minutes and then of about 5 mW/cm² for about 7.5 minutes. The light sources were located above and below the pallets (double sided curing). BC were mechanically removed under yellow lighting. Pallets holding the FC with adhered lenses were stored under a nitrogen gas atmosphere and in the dark until further use. The adhered lenses are crosslinked substrate network lenses with covalently bound monoacylphosphine oxide groups and are referred to as “MAPO substrate lenses” in the experiments described below.

TABLE 13

| Component | Weight Percent |
|---|---|
| mPDMS | 30 |
| SiMAA | 27.51 |
| DMA | 24 |
| HEMA | 5.85 |
| PVP K90 | 7 |
| TEGDMA | 1.65 |
| Norbloc | 1 |
| RB247 | 0.01 |
| Compound C | 2.41 |
| Omnirad 819 | 0.34 |

Working under yellow lights in a glove box in a nitrogen gas atmosphere, a FC with a MAPO substrate lens still attached thereon was placed on the in-mold jig shown in FIG. 12. The in-mold jig was then attached to an optical lens forming apparatus equipped with a digital light projection unit employing a micro-mirror device to modulate and direct light onto the FC and into attached MAPO substrate lens. The light source of the apparatus was a 405 nanometer LED having an intensity of 120 mW/cm². Then, about 150 microliters of a degassed grafting solution, composed of 0.27 weight percent of Compound B, 0.90 weight percent of Compound I, and 1.0 weight percent of Compound E in 50:50 (v/v) 1-propanol: DIW, were dispensed into the FC for nine minutes to allow the visible light filtering compounds to absorb into the MAPO substrate lenses, thereafter the excess grafting solutions were removed. The impregnated MAPO substrate lenses were then irradiated for sixty seconds using a 9-millimeter diameter pupil only DMD image, thereby grafting the visible light filtering compounds into the MAPO substrate lenses.

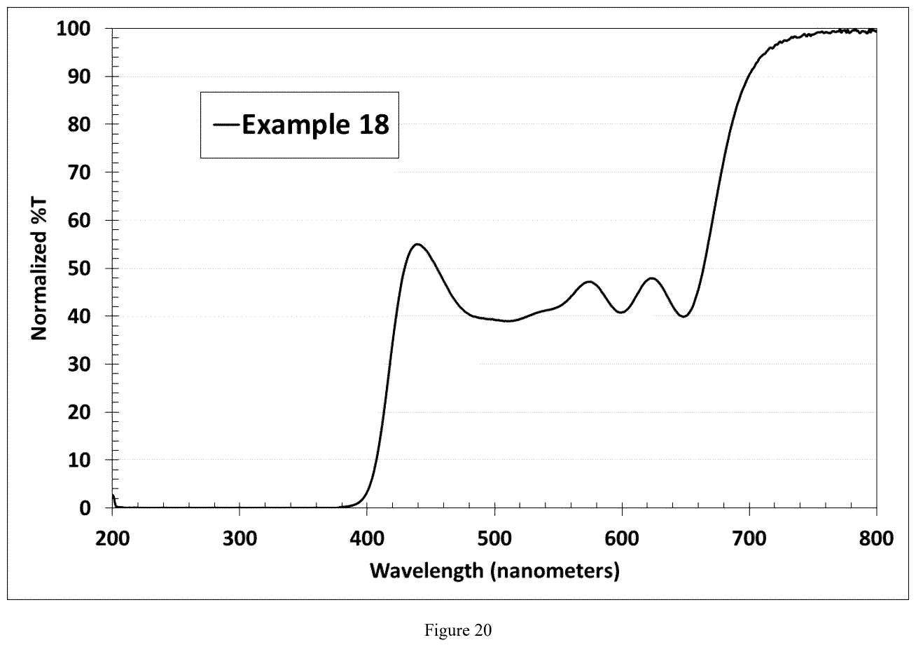

The in-mold jigs were removed from the apparatus, and the grafted lenses isolated by removing the FC mechanically. The lenses were then soaked in 70% (v/v) aqueous IPA for fifteen hours and then rinsed two times with DIW and two times with PS and then stored in vials in PS. The UV-VIS spectrum Example 18 lenses is shown in FIG. 20, showing a moderately constant transmittance between 480 nanometers to 660 nanometers of about 45 percent.

### Example 19. Apodised Contact Lenses with Different Light (Prophetic)

A reactive monomer mixture was prepared composed of 77 weight percent of the formulation listed in Table 13 and 23 weight percent of the diluent D3O. The RMM was then filtered through a 3 μm filter using a stainless-steel syringe under pressure and degassed by applying vacuum (about 40 mm Hg). Under a nitrogen gas atmosphere and about three percent oxygen gas, about 75 μL of the reactive monomer mixture were dosed into the FC made of Zeonor. The BC made of Zeonor was then placed onto the FC, thereby forming a minus one diopter lens mold assembly. Pallets, each containing eight lens mold assemblies, were conveyed through a two-stage curing tunnel during which the pallets were irradiated at 65° C. using 435 nm LED lights having intensity of about 4 mW/cm² at the pallet's surface for about 3.8 minutes and then of about 12 mW/cm² for about 2.2 minutes. The light source was located above the pallets. BC were mechanically removed under yellow lighting. Pallets holding the FC with adhered lenses were stored under a nitrogen gas atmosphere and in the dark until further use. The adhered lenses are crosslinked substrate network lenses with covalently bound monoacylphosphine oxide groups and are referred to as “MAPO substrate lenses” in the experiments described below.

TABLE 13

| Component | Weight Percent |
|---|---|
| mPDMS | 31 |
| SiMAA | 28 |
| DMA | 24 |
| HEMA | 6 |
| PVP K90 | 7 |
| TEGDMA | 1.65 |
| Norbloc | 2 |
| RB247 | 0.01 |
| Omnirad 819 | 0.34 |

Working under yellow lights in a glove box in a nitrogen gas atmosphere, a FC with a MAPO substrate lens still attached thereon is placed on the in-mold jig shown in FIG. 11. The in-mold jig is then attached to an optical lens forming apparatus equipped with a digital light projection unit employing a micro-mirror device to modulate and direct light onto the FC and into attached MAPO substrate lens. The light source of the apparatus is a 405 nanometer LED having an intensity of 120 mW/cm². Then, about 150 microliters of a degassed grafting solution composed of 0.25 weight percent of Compound B and of 0.8 weight percent of Compound I in 50:50 (v/v) 1-propanol: DIW are dispensed into the FC for nine minutes to allow the visible light filtering compounds to absorb into the MAPO substrate lenses, thereafter the excess grafting solutions are removed. The impregnated MAPO substrate lenses are then irradiated for sixty seconds using a 9-millimeter diameter pupil only DMD image.

Working under yellow lights in a glove box in a nitrogen gas atmosphere in order to preserve the covalently bound monoacylphosphine oxide groups within the grafted lenses that have not been irradiated or decomposed, the in-mold jigs are removed from the apparatus, and the grafted lenses are isolated by removing the FC mechanically. Again, working under yellow lights in a glove box in a nitrogen gas atmosphere, the lenses are then soaked in 70% (v/v) aqueous IPA for fifteen hours and then rinsed two times with 50:50 (v/v) 1-propanol: DIW. The lenses are then suspended into a degassed 0.2 weight percent solutions of Compound E in 50:50 (v/v) 1-propanol: DIW. The suspension is irradiated with 405 nanometer LED lights having an intensity between 1-5 mW/cm² for a sufficient time to substantially graft Compound D in the periphery around central apodised spot consisting of grafted Compound B and Compound I. The lenses are then soaked in 50:50 (v/v) 1-propanol: DIW for several hours, rinsed two times with DIW, rinsed two times with PS, and then stored in vials in PS. The lenses have an orange center and a blue periphery. The level of lightness or darkness of the colors can be control by varying the exposure times and/or the digital light projection intensity. This experiment can be repeated using any combination of the visible light filtering compounds having Formulae (I) to (VI), for instance, Compounds B, I, and K.

### Example 20. Pupil Only Apodised Contact Lenses (Prophetic)

Example 17 is repeated except that the grafting solution only contains Compound B and Compound I.

### Example 21. Pupil Only Apodised Contact Lenses

A reactive monomer mixture was prepared composed of 77 weight percent of the formulation listed in Table 14 and 23 weight percent of the diluent D3O. The RMM was then filtered through a 3 μm filter using a stainless-steel syringe under pressure and degassed by applying vacuum (about 40 mm Hg). Under a nitrogen gas atmosphere and about three percent oxygen gas, about 75 μL of the reactive monomer mixture were dosed into the FC made of Zeonor. The BC made of Zeonor was then placed onto the FC, thereby forming a minus one diopter lens mold assembly. Pallets, each containing eight lens mold assemblies, were conveyed through a two-stage curing tunnel during which the pallets were irradiated at 65° C. using 435 nm LED lights having intensity of about 4 mW/cm² at the pallet's surface for about 3.8 minutes and then of about 12 mW/cm² for about 2.2 minutes. The light source was located above the pallets. BC were mechanically removed under yellow lighting. Pallets holding the FC with adhered lenses were stored under a nitrogen gas atmosphere and in the dark until further use. The adhered lenses are crosslinked substrate network lenses with covalently bound monoacylphosphine oxide groups and are referred to as “MAPO substrate lenses” in the experiments described below.

TABLE 14

| Component | Weight Percent |
|---|---|
| mPDMS | 31 |
| SiMAA | 28 |
| DMA | 24 |
| HEMA | 6 |
| PVP K90 | 7 |
| TEGDMA | 1.65 |
| Norbloc | 2 |
| RB247 | 0.01 |
| Omnirad 819 | 0.34 |

Working under yellow lights in a glove box in a nitrogen gas atmosphere, a FC with a MAPO substrate lens still attached thereon was placed on the in-mold jig shown in FIG. 12. The in-mold jig was then attached to an optical lens forming apparatus equipped with a digital light projection unit employing a micro-mirror device to modulate and direct light onto the FC and into attached MAPO substrate lens. The light source of the apparatus was a 405 nanometer LED.

Then, about 110 microliters of the degassed grafting solutions listed in Table 15 were dispensed into the FC for nine minutes to allow the ultraviolet-visible light filtering compounds to absorb into the MAPO substrate lenses, thereafter the excess grafting solutions were removed. The impregnated MAPO substrate lenses were then irradiated under the conditions listed in Table 15 using either a 9-millimeter diameter pupil only DMD image abbreviated as “9 mm PUPO” (examples 21A, 21C, and 21E), or a 10-millimeter diameter Gaussian apodised image abbreviated as “10 mm DMD Image A” (examples 21B, 21D, and 21F) as shown in FIGS. 13 and 14, thereby grafting the ultraviolet-visible light filtering compounds into the MAPO substrate lenses.

TABLE 15
Grafting Solutions, Irradiation Conditions, and DMD Images

| | Ex. 21A | Ex. 21B | Ex. 21C | Ex. 21D | Ex. 21E | Ex. 21F |
|---|---|---|---|---|---|---|
| Component | (wt. %) | (wt. %) | (wt. %) | (wt. %) | (wt. %) | (wt. %) |
| Compound B | 0.5 | 0.5 | 0.5 | 0.5 | 0.5 | 0.5 |
| Compound I | 0.5 | 0.5 | 0 | 0 | 0.5 | 0.5 |
| Compound J | 0 | 0 | 0.5 | 0.5 | 0 | 0 |
| Compound C | 0 | 0 | 0 | 0 | 2.5 | 2.5 |
| Solvent | 55:45 (v/v) | 55:45 (v/v) | DMF | DMF | 1:1 (v/v) | 1:1 (v/v) |
| System | NPA:DIW | NPA:DIW | | | NPA:PG | NPA:PG |
| Irradiation | 80 | 80 | 80 | 80 | 30 | 30 |
| Intensity | | | | | | |
| (mW/cm²) | | | | | | |
| Irradiation | 90 | 90 | 90 | 90 | 240 | 240 |
| Time (sec) | | | | | | |
| DMD Image | 9 mm | 10 mm | 9 mm | 10 mm | 9 mm | 10 mm |
| | PUPO | DMD A | PUPO | DMD A | PUPO | DMD A |

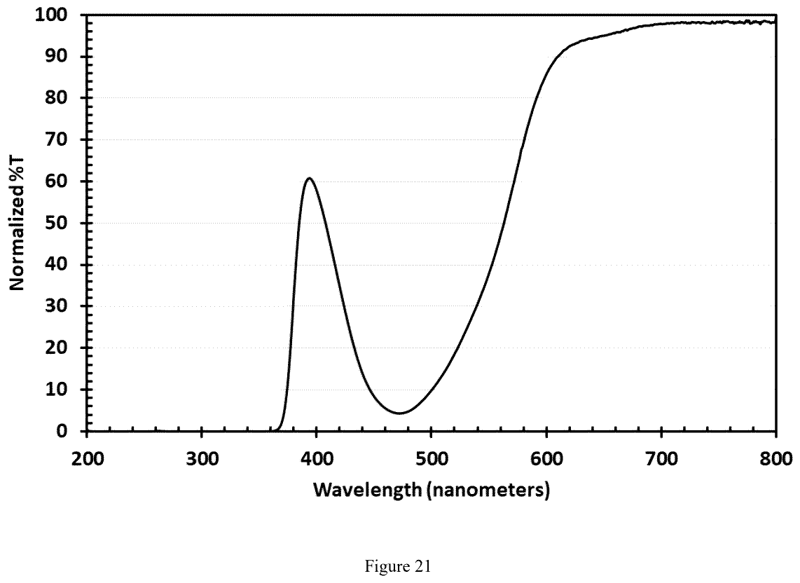

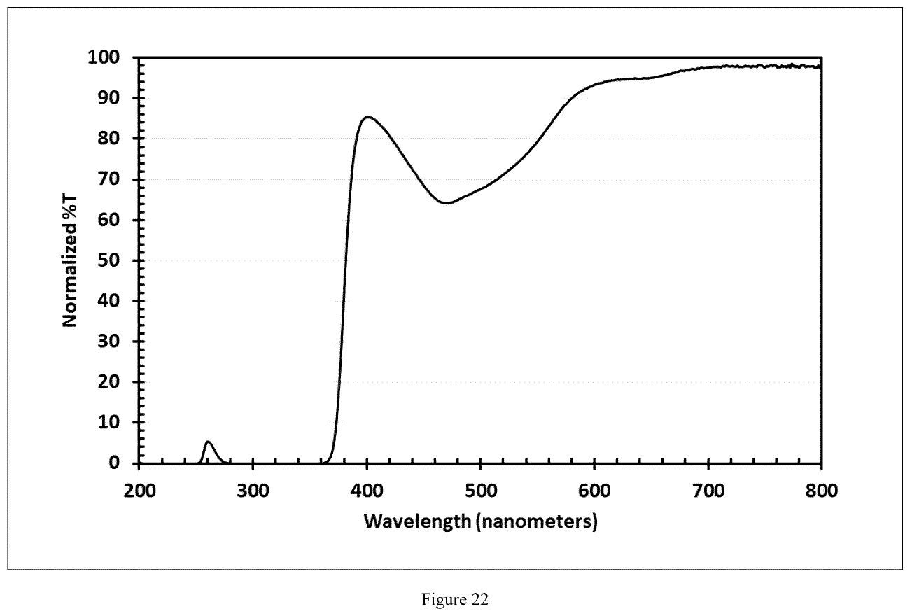

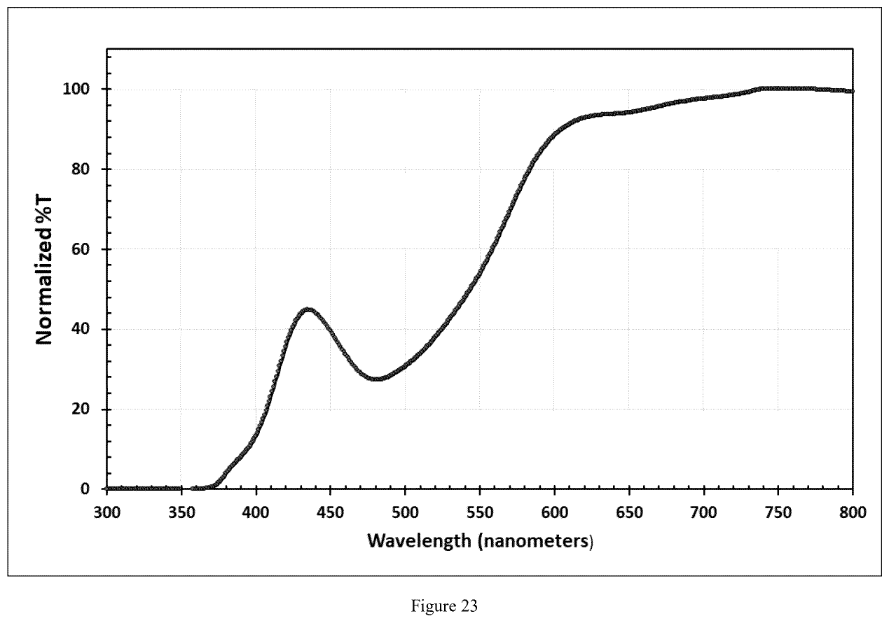

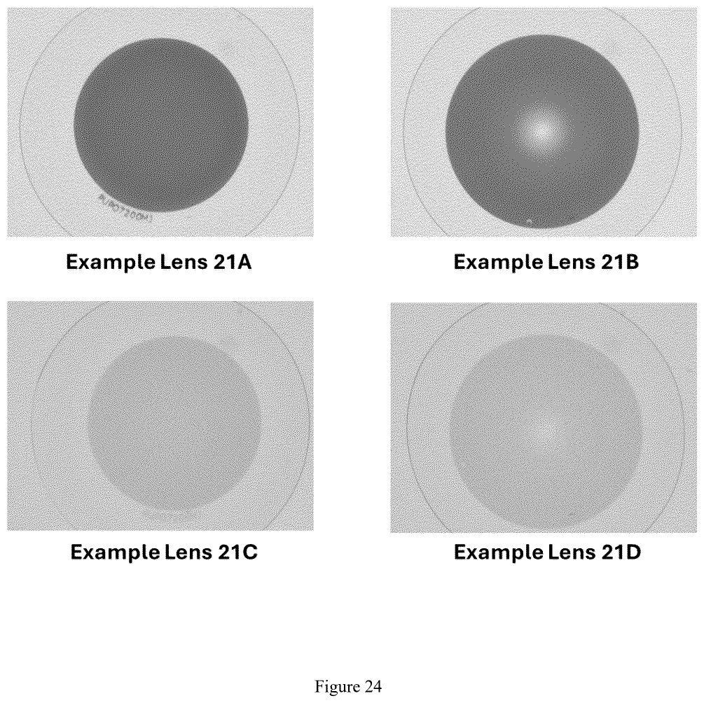

The in-mold jigs were removed from the apparatus, and the grafted lenses isolated by removing the FC mechanically. The lenses were then soaked in 70% (v/v) aqueous IPA for fifteen hours and then rinsed two times with DIW and two times with PS and then stored in vials in PS. The grafted portions of Example 21A and 21B lenses were light pur brownish orange in color. The UV-VIS spectrum of Example 21A lenses is displayed in FIG. 21, showing zero transmission between 200 and 360 nanometers and a strong absorption band centered at 470 nanometers. The grafted portions of Example 21C and 21D lenses were light purple in color. The UV-VIS spectrum of Example 21C lenses is displayed in FIG. 22, showing almost zero transmission between 200 and 370 nanometers and a moderately strong absorption band centered at 460 nanometers. The grafted portions of Example 21E and 21F lenses were blue in color. The UV-VIS spectrum of Example 21E lenses is displayed in FIG. 23, showing zero transmission up to about 375 nanometers and a strong absorption band centered at 480 nanometers. Micrographs of the apodised Example 21A-21D lenses are shown in FIG. 24.

1. An ophthalmic device that is a free radical reaction product of a reactive monomer mixture comprising:
(a) one or more monomers suitable for making the ophthalmic device;
(b) a first visible light filtering compound, the first visible light filtering compound having a visible light absorption maximum between 430 nanometers and 480 nanometers and a full width half maximum at the visible light absorption maximum of at least 35 nanometers and up to 150 nanometers, wherein the first visible light filtering compound is photostable, and wherein the first visible light filtering compound has a molar extinction coefficient of at least 7740 L·mol-1·cm⁻¹; and
(c) a second visible light filtering compound having a visible light absorption maximum between 480 nanometers and 530 nanometers and a full width half maximum of at least 50 nanometers and up to 150 nanometers.

2. The ophthalmic device of claim 1 wherein the visible light absorption maximum of the first visible light filtering compound is between 440 nanometers and 470 nanometers.

3. The ophthalmic device of claim 1 wherein the visible light absorption maximum of the second visible light filtering compound is between 490 nanometers and 520 nanometers.

4. The ophthalmic device of claim 1 wherein the full width half maximum at the visible light absorption maximum of the first visible light filtering compound is at least 40 nanometers and up to 95 nanometers.

5. The ophthalmic device of claim 1 wherein the full width half maximum at the visible light absorption maximum of the second visible light filtering compound is at least 70 nanometers and up to 130 nanometers.

6-23. (canceled)

24. The ophthalmic device of claim 1 wherein the ophthalmic device further comprises a third light filtering compound.

25. The ophthalmic device of claim 24 wherein the third visible light filtering compound exhibits one or more visible light absorption maxima between 550 nanometers and 660 nanometers.

26-63. (canceled)

64. The ophthalmic device of claim 1 that is a contact lens, the contact lens having a central zone and a peripheral zone.

65. The ophthalmic device of claim 64 wherein the molar concentrations of the first, second, and third visible light filtering compounds are independently distributed in the central zone and in the peripheral zone.

66. The ophthalmic device of claim 64 wherein the molar concentrations of the first, second, and third visible light filtering compounds are independently greater in the central zone than in the peripheral zone.

67. The ophthalmic device of claim 64 wherein the molar concentrations of the first, second, and third visible light filtering compounds are independently distributed in the central zone only.

68. The ophthalmic device of claim 64 wherein the molar concentrations of the first, second, and third visible light filtering compounds independently vary spatially to form an apodization profile.

69. The ophthalmic device of claim 68 wherein the molar concentrations of the first, second, and third visible light filtering compounds independently vary radially, circumferentially, or combinations thereof to form the apodization profile.

70. The ophthalmic device of claim 68 wherein the apodization profile varies according to a mathematical function.

71. The ophthalmic device of claim 70 wherein the mathematical function is linear, polynomial, Gaussian, Lorentzian, logarithmic, exponential, numeric, or combinations thereof.

72. The ophthalmic device of claim 68 wherein the apodization profile further comprises a transparent region in the center of the contact lens.

73. The ophthalmic device of claim 72 wherein the transparent region is circular in shape having a diameter between 0.1 millimeters and 5 millimeters.

74. (canceled)

75. The ophthalmic device of claim 68 wherein the central zone comprises an optical zone for the correction of refractive errors selected from the group consisting of myopia, hyperopia, presbyopia, and astigmatism.

76. The ophthalmic device of claim 1 wherein the reactive monomer mixture comprises a hydrophilic component, a silicone-containing component, or mixtures thereof.

77. The ophthalmic device of claim 1 wherein the device is a silicone hydrogel contact lens, the lens having a contact angle of about 100° or less, a water content of at least 25 weight percent, and an oxygen permeability (edge corrected) of at least 60 barrers.
